(19) United States
(12) Patent Application Publication
(10) Pub. No.: US 2025/0389671 A1
(43) Pub. Date: Dec. 25, 2025

(54) SYSTEM, APPARATUS, AND METHOD FOR IMPROVED LOCATION IDENTIFICATION

(71) Applicant: Gecko Robotics, Inc., Pittsburgh, PA (US)

(72) Inventors: Jennifer Padgett, Baden, PA (US); Hannah Loy, Oakmont, PA (US); Ryan Dickerhoff, Pittsburgh, PA (US); Michael Lin, Pittsburgh, PA (US); Aakash Rohra, Pittsburgh, PA (US)

(21) Appl. No.: 18/753,090

(22) Filed: Jun. 25, 2024

Related U.S. Application Data
(63) Continuation-in-part of application No. PCT/US24/35076, filed on Jun. 21, 2024.
Application No. PCT/US24/35076 is a continuation-in-part of application No. 18/545,640, filed on Dec. 19, 2023.
(60) Provisional application No. 63/476,114, filed on Dec. 19, 2022.

(51) Int. Cl. G01N 21/88; B25J 9/16

(52) U.S. Cl. CPC G01N 21/8851; B25J 9/1697; G01N 2021/8867

(57) ABSTRACT

A system for inspecting an inspection surface, the system including an inspection robot and one or more processors. The inspection robot includes: a body; an arm coupled to the body; a payload coupled to the arm; and an inspection surface sensor disposed in the payload for inspecting an inspection surface and structured to generate inspection surface data. The one or more processors are structured to: interpret a position value; interpret the inspection surface data; interpret a feature description corresponding to a feature related to the inspection surface; and generate a high-fidelity region of the inspection surface based at least in part on the position value, the inspection surface data, and the feature description.

### CROSS-REFERENCE TO RELATED APPLICATIONS

This application claims priority to and is a continuation of International Patent Application Serial No. PCT/US2024/035076, (Attorney Docket No. GROB-0025-WO), filed Jun. 21, 2024, and entitled “SYSTEM, APPARATUS, AND METHOD FOR IMPROVED LOCATION IDENTIFICATION”.

International Patent Application Serial No. PCT/US2024/035076 claims priority to and is a continuation-in-part of U.S. patent application Ser. No. 18/545,640 (Attorney Docket No. GROB-0024-U01), filed Dec. 19, 2023, and entitled “SYSTEM, APPARATUS, AND METHOD FOR IMPROVED LOCATION IDENTIFICATION”.

U.S. patent application Ser. No. 18/545,640 claims the benefit of and priority to U.S. Provisional Patent Application Ser. No. 63/476,114 (Attorney Docket No. GROB-0024-P01), filed Dec. 19, 2022, and entitled “SYSTEM, APPARATUS AND METHOD FOR IMPROVED LOCATION IDENTIFICATION”.

Each of the foregoing patents and/or applications is incorporated herein by reference in its entirety for all purposes.

Certain aspects of the present disclosure include one or more features of the following patents and/or applications, which are incorporated herein by reference in their entirety for all purposes:

PCT Patent Application Serial No. PCT/US2023/075691 (Attorney Docket No. GROB-0017-WO), filed on Oct. 2, 2023, and entitled “SYSTEM, APPARATUS, AND METHOD FOR IMPROVED LOCATION IDENTIFICATION”;

U.S. patent application Ser. No. 16/863,594 (Attorney Docket No. GROB-0007-U02), filed Apr. 30, 2020, entitled “SYSTEM, METHOD AND APPARATUS FOR RAPID DEVELOPMENT OF AN INSPECTION SCHEME FOR AN INSPECTION ROBOT”, now U.S. Pat. No. 11,511,426 issued on Nov. 29, 2022;

PCT Patent Application Serial No. PCT/US20/21779 (Attorney Docket No. GROB-0007-WO), filed Mar. 9, 2020, entitled “INSPECTION ROBOT”, now published as WO 2020/185719;

U.S. Provisional Patent Application Ser. No. 62/815,724 (Attorney Docket No. GROB-0005-P01), filed Mar. 8, 2019, entitled “INSPECTION ROBOT”;

U.S. patent application Ser. No. 15/853,391 (Attorney Docket No. GROB-0003-U01), filed Dec. 22, 2017, entitled “INSPECTION ROBOT WITH COUPLANT CHAMBER DISPOSED WITHIN SLED FOR ACOUSTIC COUPLING,” now U.S. Pat. No. 10,698,412 issued on Jun. 30, 2020;

U.S. Provisional Patent Application Ser. No. 62/596,737 (Attorney Docket No. GROB-0003-P01), filed Dec. 8, 2017, entitled “METHOD AND APPARATUS TO INSPECT A SURFACE UTILIZING REAL-TIME POSITION INFORMATION”; and

U.S. Provisional Patent Application Ser. No. 62/438,788 (Attorney Docket No. GROB-0001-P01), filed Dec. 23, 2016, entitled “STRUCTURE TRAVERSING ROBOT WITH INSPECTION FUNCTIONALITY”.

### BACKGROUND

The present disclosure relates to robotic inspection and treatment of industrial surfaces.

### SUMMARY

Previously known inspection and treatment systems for industrial surfaces suffer from a number of drawbacks. Industrial surfaces are often required to be inspected to determine whether a pipe wall, tank surface, or other industrial surface feature has suffered from corrosion, degradation, loss of a coating, damage, wall thinning or wear, or other undesirable aspects. Industrial surfaces are often present within a hazardous location—for example in an environment with heavy operating equipment, operating at high temperatures, in a confined environment, at a high elevation, in the presence of high voltage electricity, in the presence of toxic or noxious gases, in the presence of corrosive liquids, and/or in the presence of operating equipment that is dangerous to personnel. Accordingly, presently known systems require that a system be shutdown, that a system be operated at a reduced capacity, that stringent safety procedures be followed (e.g., lockout/tagout, confined space entry procedures, harnessing, etc.), and/or that personnel are exposed to hazards even if proper procedures are followed. Additionally, the inconvenience, hazards, and/or confined spaces of personnel entry into inspection areas can result in inspections that are incomplete, of low resolution, that lack systematic coverage of the inspected area, and/or that are prone to human error and judgement in determining whether an area has been properly inspected.

As an inspection robot pitches, for example, due to crossing a weld line, traversing an obstacle, or traversing a curved and/or irregular inspection surface, the beam of an inspection laser and/or distancing laser (e.g., to determine the position of an inspection robot) can pitch into and away from the tank shell surface. This may be particularly problematic when the inspection robot is far from the point being measured. At large distances, even small angular changes can cause the measurement point to travel several feet from the inspection surface or even intersect with the inspection surface giving erroneous measurements.

Embodiments of the present disclosure provide for systems and methods that improve localization of an inspection robot. Example embodiments include sensor fusion and mixing.

Embodiments of the present disclosure may provide for an inspection robot, and/or an inspection system including an inspection robot, having improved distance information, range finding, and/or position-based information.

Embodiments of the current disclosure provide for a system for generating high-fidelity regions of an inspection surface. Embodiments of the current disclosure provide for an apparatus for localizing inspection surface data values using observation data values. Embodiments of the current disclosure provide for an apparatus for conditioning trajectory data using feature loop closure detection. Embodiments of the current disclosure provide for a system for inspection surface feature recognition/identification that includes an inspection robot and one or more processors. Embodiments of the current disclosure provide for an apparatus for conditioning and/or modifying inspection surface data based at least in part on surface condition data. Embodiments of the current disclosure provide for an apparatus for registering inspection surface data using external data. Embodiments of the current disclosure provide for an apparatus for adjusting a position value of an inspection robot. Embodiments of the current disclosure provide for a method for generating an inspection path for an inspection robot to inspect an inspection surface. Embodiments of the current disclosure provide for an apparatus for determining a type of inspection for an inspection surface. Embodiments of the current disclosure provide for a method for registering inspection surface data to an inspection surface. Embodiments of the current disclosure provide for an apparatus for displaying inspection surface data.

### BRIEF DESCRIPTION OF THE FIGURES

FIG. 1 depicts an inspection map with features of the inspection surface and corresponding locations on the inspection surface consistent with certain embodiments of the present disclosure.

FIG. 2 is a schematic diagram of an inspection robot positioning system consistent with certain embodiments of the present disclosure.

FIG. 3 is a schematic diagram of an inspection robot, including the inspection robot positioning system of FIG. 26, on an inspection surface consistent with certain embodiments of the present disclosure.

FIG. 4 is a schematic diagram depicting certain further aspects of an inspection robot positioning system consistent with certain embodiments of the present disclosure.

FIG. 5 is a schematic diagram depicting certain further aspects of an inspection robot positioning system consistent with certain embodiments of the present disclosure.

FIG. 6 is a schematic diagram depicting certain further aspects of an inspection robot positioning system consistent with certain embodiments of the present disclosure.

FIG. 7 is a schematic diagram depicting certain further aspects of an inspection robot positioning system consistent with certain embodiments of the present disclosure.

FIG. 8 is a schematic diagram depicting certain further aspects of an inspection robot positioning system consistent with certain embodiments of the present disclosure.

FIGS. 9, 9A, and 9B depict a schematic diagram of an inspection robot positioning system consistent with certain embodiments of the present disclosure.

FIG. 10 is a schematic flow diagram of a sensor fusion consistent with certain embodiments of the present disclosure.

FIG. 11 is a schematic diagram of a gimbal platform consistent with certain embodiments of the present disclosure.

FIGS. 12, 12A, and 12B depict a schematic diagram of a system architecture consistent with certain embodiments of the present disclosure.

FIG. 13 is a schematic flow diagram of a method for sensor fusion consistent with certain embodiments of the present disclosure.

FIG. 14 depicts an aspect of a method of sensor fusion in an inspection robot positioning system consistent with certain embodiments of the present disclosure.

FIG. 15 depicts an aspect of a method of sensor fusion in an inspection robot positioning system consistent with certain embodiments of the present disclosure.

FIG. 16 depicts an aspect of a method of sensor fusion in an inspection robot positioning system consistent with certain embodiments of the present disclosure.

FIG. 17 depicts an aspect of a method of sensor fusion in an inspection robot positioning system consistent with certain embodiments of the present disclosure.

FIG. 18 depicts an aspect of a method of sensor fusion in an inspection robot positioning system consistent with certain embodiments of the present disclosure.

FIG. 19 is a schematical diagram of a system for inspecting an inspection surface, in accordance with embodiments of the current disclosure.

FIG. 20 is a schematic diagram of an inspection surface, in accordance with embodiments of the current disclosure.

FIG. 21 is a schematic diagram depicting the stitching together of two regions of inspection surface data, in accordance with embodiments of the current disclosure.

FIG. 22 is a schematic diagram of an apparatus for generating a high-fidelity region of an inspection surface, in accordance with embodiments of the current disclosure.

FIG. 23 is a schematic diagram of additional embodiments of the apparatus of FIG. 22, in accordance with the current disclosure.

FIG. 24 is a flowchart depicting a method for generating a high-fidelity region of an inspection surface, in accordance with embodiments of the current disclosure.

FIG. 25 is flowchart depicting additional embodiments of the method of FIG. 25, in accordance with the current disclosure.

FIG. 26 is a schematic diagram of an inspection robot inspecting an inspection surface, in accordance with embodiments of the current disclosure.

FIG. 27 is a schematic diagram of a mapping of inspection surface data, in accordance with embodiments of the current disclosure.

FIG. 28 is a schematic diagram of an apparatus for localizing inspection surface data values using observation data values, in accordance with embodiments of the current disclosure.

FIG. 29 is a schematic diagram of additional embodiments of the apparatus of FIG. 28, in accordance with the current disclosure.

FIG. 30 is a flowchart depicting a method for localizing inspection surface data values using observation data values, in accordance with embodiments of the current disclosure.

FIG. 31 is a flowchart of additional embodiments of the method of FIG. 30, in accordance with the current disclosure.

FIG. 32 is a flowchart of a method for conditioning trajectory data using feature loop closure detection, in accordance with embodiments of the current disclosure.

FIG. 33 is a schematic diagram of an apparatus for conditioning trajectory data using feature loop closure detection, in accordance with embodiments of the current disclosure.

FIG. 34 is a schematic diagram of additional embodiments of the apparatus of FIG. 33, in accordance with the current disclosure.

FIG. 35 is a schematic diagram of another apparatus for conditioning trajectory data using feature loop closure detection, in accordance with embodiments of the current disclosure.

FIG. 36 is a schematic diagram of additional embodiments of the apparatus of FIG. 35, in accordance with the current disclosure.

FIG. 37 is a flowchart depicting another method for conditioning trajectory data using feature loop closure detection, in accordance with embodiments of the current disclosure.

FIG. 38 is a flowchart depicting additional embodiments of the method of FIG. 37, in accordance with the current disclosure.

FIG. 39 is a flowchart depicting another method for conditioning trajectory data using feature loop closure detection, in accordance with embodiments of the current disclosure.

FIG. 40 is a flowchart depicting additional embodiments of the method of FIG. 39, in accordance with the current disclosure.

FIG. 41 is a schematic diagram of an apparatus for inspection surface feature recognition/identification, in accordance with embodiments of the current disclosure.

FIG. 42 is a schematic diagram of additional embodiments of the apparatus of FIG. 41, in accordance with the current disclosure.

FIG. 43 is a schematic diagram of an apparatus for conditioning and/or modifying inspection surface data based at least in part on surface condition data, in accordance with embodiments of the current disclosure.

FIG. 44 is a schematic diagram of additional embodiments of the apparatus of FIG. 43, in accordance with the current disclosure.

FIG. 45 is a flowchart depicting a method for inspection surface feature recognition/identification, in accordance with embodiments of the current disclosure.

FIG. 46 is a flowchart depicting additional embodiments of the method of FIG. 45, in accordance with the current disclosure.

FIG. 47 is a flowchart depicting a method for conditioning and/or modifying inspection surface data based at least in part on surface condition data, in accordance with embodiments of the current disclosure.

FIG. 48 is a flowchart depicting additional embodiments of the method of FIG. 47, in accordance with the current disclosure.

FIG. 49 depicts an inspection robot inspecting an inspection surface, in accordance with embodiments of the current disclosure;

FIG. 50 is a schematic diagram of an apparatus for registering inspection surface data using external data, in accordance with embodiments of the current disclosure.

FIG. 51 is a flowchart depicting a method for registering inspection surface data using external data, in accordance with embodiments of the current disclosure.

FIG. 52 is a schematic diagram of an apparatus for adjusting a position value of an inspection robot, in accordance with embodiments of the current disclosure.

FIG. 53 is a flowchart depicting a method for adjusting a position value of an inspection robot, in accordance with embodiments of the current disclosure.

FIG. 54 is a schematic diagram of an inspection robot following an inspection path, in accordance with embodiments of the current disclosure.

FIG. 55 is schematic diagram of an apparatus for generating an inspection path for an inspection robot, in accordance with embodiments of the current disclosure.

FIG. 56 is a schematic diagram of additional embodiments of the apparatus of FIG. 55, in accordance with the current disclosure.

FIG. 57 is a flowchart for a method of generating an inspection path for an inspection robot, in accordance with embodiments of the current disclosure.

FIG. 58 is flowchart depicting additional embodiments of the method of FIG. 57, in accordance with the current disclosure.

FIG. 59 is a schematic diagram of an apparatus for determining a type of inspection for an inspection surface, in accordance with embodiments of the current disclosure.

FIG. 60 is a schematic diagram depicting additional embodiments of the apparatus of FIG. 59, in accordance with the current disclosure.

FIG. 61 is a flowchart depicting a method for determining a type of inspection for an inspection surface, in accordance with embodiments of the current disclosure.

FIG. 62 is a flowchart depicting additional embodiments of the method of FIG. 61, in accordance with the current disclosure.

FIG. 63 is a schematic diagram of an apparatus for registering and/or mapping inspection surface data to an inspection surface, in accordance with embodiments of the current disclosure.

FIG. 64 is a schematic diagram of additional embodiments of the apparatus of FIG. 63, in accordance with the current disclosure.

FIG. 65 is a flow chart depicting a method for registering and/or mapping inspection surface data to an inspection surface, in accordance with embodiments of the current disclosure.

FIG. 66 is a flow chart depicting additional embodiments of the method of FIG. 65, in accordance with the current disclosure.

FIGS. 67A, 67B, and 67C depict a graphical user interface (GUI) for displaying inspection surface data, in accordance with embodiments of the current disclosure.

FIG. 68 is a schematic diagram of an apparatus for displaying inspection surface data, in accordance with embodiments of the current disclosure.

FIG. 69 is a schematic diagram of additional embodiments of the apparatus of FIG. 68, in accordance with the current disclosure.

FIG. 70 is a flowchart depicting a method for displaying inspection surface data, in accordance with embodiments of the current disclosure.

FIG. 71 is a flowchart depicting additional embodiments of the method of FIG. 70, in accordance with the current disclosure.

### DETAILED DESCRIPTION

The present disclosure relates to a system developed for traversing, climbing, or otherwise traveling over walls (curved or flat), or other industrial surfaces. Industrial surfaces, as described herein, include any tank, pipe, housing, or other surface utilized in an industrial environment, including at least heating and cooling pipes, conveyance pipes or conduits, and tanks, reactors, mixers, or containers. In certain embodiments, an industrial surface is ferromagnetic, for example including iron, steel, nickel, cobalt, and alloys thereof. In certain embodiments, an industrial surface is not ferromagnetic.

Certain descriptions herein include operations to inspect a surface, an inspection robot or inspection device, or other descriptions in the context of performing an inspection. Inspections, as utilized herein, should be understood broadly. Without limiting any other disclosures or embodiments herein, inspection operations herein include operating one or more sensors in relation to an inspected surface, electromagnetic radiation inspection of a surface (e.g., operating a camera) whether in the visible spectrum or otherwise (e.g., infrared, UV, X-Ray, gamma ray, etc.), high-resolution inspection of the surface itself (e.g., a laser profiler, caliper, etc.), performing a repair operation on a surface, performing a cleaning operation on a surface, and/or marking a surface for a later operation (e.g., for further inspection, for repair, and/or for later analysis). Inspection operations include operations for a payload carrying a sensor or an array of sensors (e.g. on sensor sleds) for measuring characteristics of a surface being traversed such as thickness of the surface, curvature of the surface, ultrasound (or ultra-sonic) measurements to test the integrity of the surface and/or the thickness of the material forming the surface, heat transfer, heat profile/mapping, profiles or mapping any other parameters, the presence of rust or other corrosion, surface defects or pitting, the presence of organic matter or mineral deposits on the surface, weld quality and the like. Sensors may include magnetic induction sensors, acoustic sensors, laser sensors, LIDAR, a variety of image sensors, and the like. The inspection sled may carry a sensor for measuring characteristics near the surface being traversed such as emission sensors to test for gas leaks, air quality monitoring, radioactivity, the presence of liquids, electromagnetic interference, visual data of the surface being traversed such as uniformity, reflectance, status of coatings such as epoxy coatings, wall thickness values or patterns, wear patterns, and the like. The term inspection sled may indicate one or more tools for repairing, welding, cleaning, applying a treatment or coating the surface being treated. Treatments and coatings may include rust proofing, sealing, painting, application of a coating, and the like. Cleaning and repairing may include removing debris, scaling leaks, patching cracks, and the like. The term inspection sled, sensor sled, and sled may be used interchangeably throughout the present disclosure.

In certain embodiments, for clarity of description, a sensor is described in certain contexts throughout the present disclosure, but it is understood explicitly that one or more tools for repairing, cleaning, and/or applying a treatment or coating to the surface being treated are likewise contemplated herein wherever a sensor is referenced. In certain embodiments, where a sensor provides a detected value (e.g., inspection data or the like), a sensor rather than a tool may be contemplated, and/or a tool providing a feedback value (e.g., application pressure, application amount, nozzle open time, orientation, etc.) may be contemplated as a sensor in such contexts.

A trajectory, as used herein, indicates a progression, sequence, and/or scheduled development of a related parameter over time, operating conditions, spatial positions, or the like. A trajectory may be a defined function (e.g., corresponding values of parameter A that are to be utilized for corresponding values of parameter B), an indicated direction (e.g., pursuing a target value, minimizing, maximizing, increasing, decreasing, etc.), and/or a state of an operating system (e.g., lifted, on or off, enabled or disabled, etc.). In certain embodiments, a trajectory indicates activation or actuation of a value over time, activation or actuation of a value over a prescribed group of operating conditions, activation or actuation of a value over a prescribed spatial region (e.g., a number of inspection surfaces, positions and/or regions of a specific inspection surface, and/or a number of facilities), and/or activation or actuation of a value over a number of events (e.g., scheduled by event type, event occurrence frequency, over a number of inspection operations, etc.). In certain embodiments, a trajectory indicates sensing a parameter, operating a sensor, displaying inspection data and/or visualization based on inspection data, over any of the related parameters (operating conditions, spatial regions, etc.) listed foregoing. The examples of a trajectory set forth with regard to the presently described embodiments are applicable to any embodiments of the present disclosure, and any other descriptions of a trajectory set forth elsewhere in the present disclosure are applicable to the presently described embodiments.

A response, as used herein, and without limitation to any other aspect of the present disclosure, includes an adjustment to at least one of: an inspection configuration for the inspection robot while on the surface (e.g., a change to sensor operations; couplant operations; robot traversal commands and/or pathing; payload configurations; and/or down force configuration for a payload, sled, sensor, etc.); a change to display operations of the inspection data; a change to inspection data processing operations, including determining raw sensor data, minimal processing operations, and/or processed data values (e.g., wall thickness, coating thickness, categorical descriptions, etc.); an inspection configuration for the inspection robot performed with the inspection robot removed from the inspection surface (e.g., changed wheel configurations, changed drive module configurations; adjusted and/or swapped payloads; changes to sensor configurations (e.g., switching out sensors and/or sensor positions); changes to hardware controllers (e.g., switching a hardware controller, changing firmware and/or calibrations for a hardware controller, etc.); and/or changing a tether coupled to the inspection robot. The described responses are non-limiting examples, and any other adjustments, changes, updates, or responses set forth throughout the present disclosure are contemplated herein for potential rapid response operations. Certain responses are described as performed while the inspection robot is on the inspection surface and other responses are described as performed with the inspection robot removed from the inspection surface, although any given response may be performed in the other condition, and the availability of a given response as on-surface or off-surface may further depend upon the features and configuration of a particular inspection robot, as set forth in the multiple embodiments described throughout the present disclosure.

Additionally, or alternatively, certain responses may be available only during certain operating conditions while the inspection robot is on the inspection surface, for example when the inspection robot is in a location physically accessible to an operator, and/or when the inspection robot can pause physical movement and/or inspection operations such as data collection. One of skill in the art, having the benefit of the present disclosure and information ordinarily available when contemplating a particular system and/or inspection robot, can readily determine response operations available for the particular system and/or inspection robot.

A response that is rapid, as used herein, and without limitation to any other aspect of the present disclosure, includes a response capable of being performed in a time relevant to the considered downstream utilization of the response. For example, a response that can be performed during the inspection operation, and/or before the completion of the inspection operation, may be considered a rapid response in certain embodiments, allowing for the completion of the inspection operation utilizing the benefit of the rapid response. Certain further example rapid response times include: a response that can be performed at the location of the inspection surface (e.g., without requiring the inspection robot be returned to a service or dispatching facility for reconfiguration); a response that can be performed during a period of time wherein a downstream customer (e.g., an owner or operator of a facility including the inspection surface; an operator of the inspection robot performing the inspection operations; and/or a user related to the operator of the inspection robot, such as a supporting operator, supervisor, data verifier, etc.) of the inspection data is reviewing the inspection data and/or a visualization corresponding to the inspection data; and/or a response that can be performed within a specified period of time (e.g., before a second inspection operation of a second inspection surface at a same facility including both the inspection surface and the second inspection surface; within a specified calendar period such as a day, three days, a week, etc.). An example rapid response includes a response that can be performed within a specified time related to interactions between an entity related to the operator of the inspection robot and an entity related to a downstream customer. For example, the specified time may be a time related to an invoicing period for the inspection operation, a warranty period for the inspection operation, a review period for the inspection operation, and or a correction period for the inspection operation. Any one or more of the specified times related to interactions between the entities may be defined by contractual terms related to the inspection operation, industry standard practices related to the inspection operation, an understanding developed between the entities related to the inspection operation, and/or the ongoing conduct of the entities for a number inspection operations related to the inspection operation, where the number of inspection operations may be inspection operations for related facilities, related inspection surfaces, and/or previous inspection operations for the inspection surface. One of skill in the art, having the benefit of the disclosure herein and information ordinarily available when contemplating a particular system and/or inspection robot, can readily determine response operations and response time periods that are rapid responses for the purposes of the particular system.

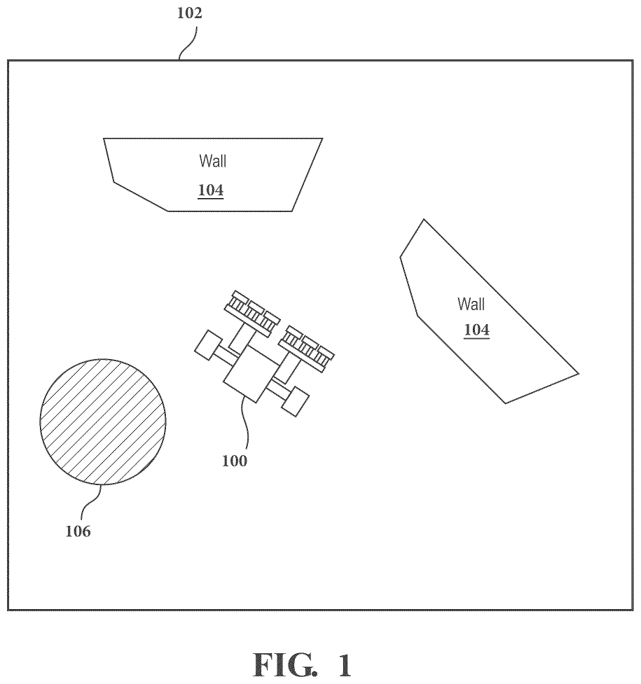

Illustrated in FIG. 1 is a non-limiting example of an inspection robot 100 inspecting an inspection surface 102 having one or more features, e.g., walls 104, surface buildup 106, etc.

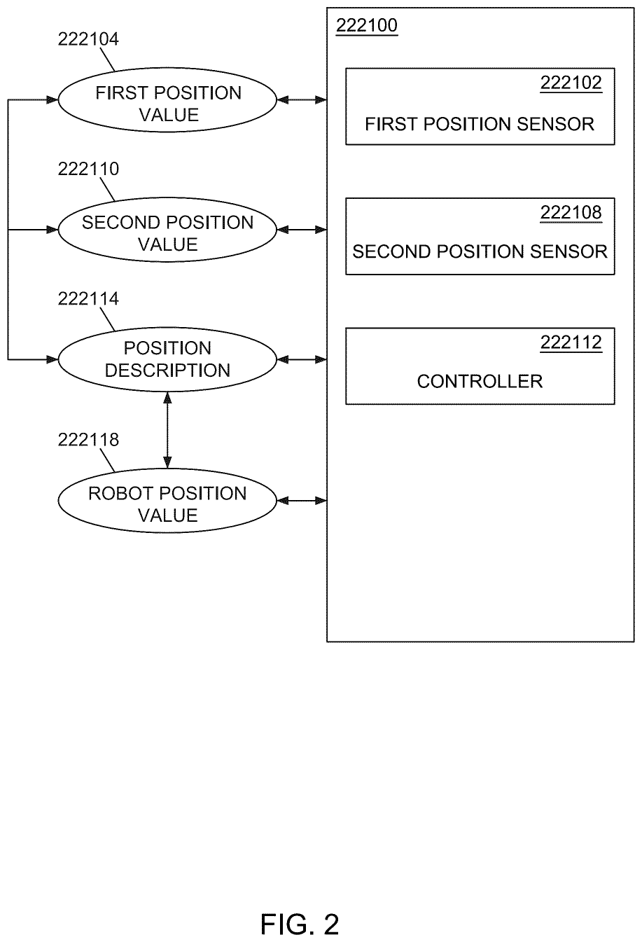

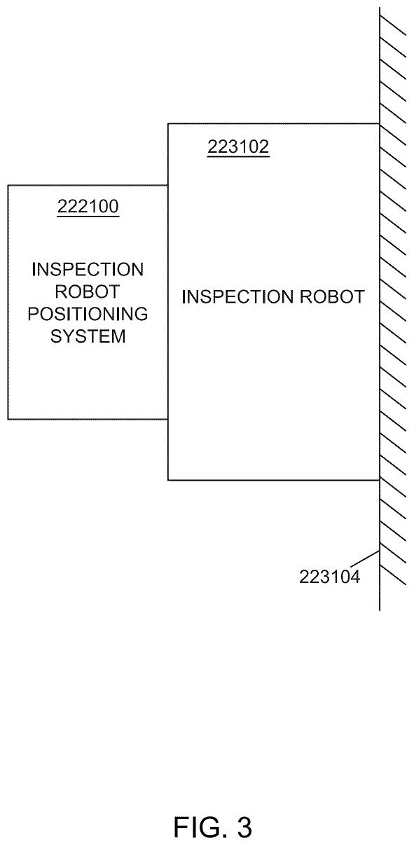

Referring to FIGS. 2 and 3, an example inspection robot positioning system 222100 is depicted. The inspection robot positioning system 222100 may be located on and/or in an inspection robot 223102 (FIG. 3), and/or may be configured in association and/or in communication with the inspection robot 223102. For example, the inspection robot positioning system 222100 may be included, in whole or part, on a base station, a cloud server, a computer at the inspection site at least intermittently communicatively coupled to the inspection robot, or the like. In certain embodiments, the inspection robot positioning system 222100 may be distributed across two or more of these locations, or at any other location within the inspection system and at least intermittently communicatively coupled to the inspection robot. The inspection robot positioning system 222100 may include a first position sensor 222102 configured to provide a first position value 222104; a second position sensor 222108 configured to provide a second position value 222110; and a controller 222112 configured to determine a position description 222114 for the inspection robot 223102 in response to the first position value 222104 and the second position value 222110. In embodiments, the position description 222114 includes a robot position value 222118 of the inspection robot 223102 on an inspection surface 223104 (FIG. 3). The first position sensor 222102 and the second position sensor 222108 may be onboard the inspection robot 223102 and/or may be offboard, e.g., in the environment of the inspection robot 223102 or the inspection surface 223104 or, in embodiments, may be provided externally to the inspection robot 223102.

Without limitation to any other aspect of the present disclosure, a position sensor onboard the inspection robot 223102 may include one or more of an encoder, an inertial measurement unit (IMU), a rangefinding device (e.g., a laser, Lidar, radar, etc.), actuator feedback values (e.g., motor commands and/or direct feedback values), a transceiver (e.g., configured to provide position information via range and/or direction information to an external device such as a wireless router, dedicated signal device, or the like), a global positioning system (GPS) device, a local positioning device, a camera and/or imaging device, and/or a direct rangefinder such as a laser, light beam source, reflecting prism, or the like. Without limitation to any other aspect of the present disclosure, a position sensor offboard the inspection robot 223102 may include a camera and/or imaging device, a tether encoder (e.g., measuring a position and/or extension of a tether coupled to the inspection robot), a transceiver, a wireless router and/or dedicated signal device, or the like. In certain embodiments, a sensor may be combined onboard/offboard, such as a reflective prism positioned on the inspection robot (and/or at a selected location), with a laser and/or light beam source positioned at a selected location (and/or on the inspection robot)—for example providing a range and/or direction between the selected location and the inspection robot; and/or a transceiver positioned on the inspection robot (and/or at one or more selected locations) and one or more wireless router(s), dedicated signal device(s), and/or other wireless rangefinding device(s) positioned at one or more selected locations (and/or on the inspection robot). It can be seen that a given device may be a sensor in certain embodiments (e.g., a reflective prism mounted on the inspection robot) and/or a part of a sensor in other embodiments (e.g., the reflective prism forming a portion of a sensor, with the laser and/or light source forming the remainder of the sensor).

A position value for the inspection robot, as utilized herein, should be understood broadly. A position value is any value tending to indicate the position of the inspection robot, including values that are precursors for, and/or inputs to, a procedure to make a determination of the position of the inspection robot. In certain embodiments, the position value provides an indication of coordinate position, in any coordinate units, and which may include a relative or absolute position. For example, a position value may provide X-Y-Z coordinates, an indication relative to a selected reference location (e.g., a tagged position on the inspection surface, a position of the base station, and/or any other selected reference location). The coordinate system utilized for position descriptions may be any selected coordinate system, including for example Cartesian coordinates, cylindrical coordinates, and/or spherical coordinates. Additionally, or alternatively, a coordinate system may be utilized for a specific operation using any selected coordinate logic, for example “13.3 meters high on pipe six (6)”. In certain embodiments, a position value may include any positional information relevant to the inspection robot, for example a derivative of the position (e.g., time derivative, such as speed, and/or another derivative such as δP/δS, where S can be inspection time, inspection stage progression, inspection surface location, etc.), and/or a second derivative of the position (e.g., time second derivative, such as acceleration, and/or another derivative). In another example, the position value may include orientation information (e.g., yaw, pitch, and/or roll) and/or derivatives thereof.

The capability to provide high accuracy and low latency position information for an inspection robot is challenging for a number of environments where inspection robots operate. For example, inspection surfaces may be irregular or curved, include hidden portions where line-of-sight is lost, be in confined spaces where access to the inspection robot is limited and/or unsafe, and/or be in spaces where operating equipment precludes or reduces the opportunity for an operator to remain in proximity to the inspection robot (e.g., high voltage areas, high temperature areas, near tanks include corrosive fluids, etc.). These challenges make it difficult to achieve continuous position data for the inspection robot, and further make it difficult for any single position determination procedure to be continuously available. For example, the presence of large metal surfaces, loss of line-of-sight, slippage of wheels of the inspection robot, intermittent availability of WiFi communications, or the like, can cause the loss or degradation of a given position determination procedure, including in an unpredictable manner, to occur during inspection operations.

As will be understood, the availability of high accuracy and low latency position information for an inspection robot provides numerous benefits. For example, and without limitation to any other aspect of the present disclosure, the availability of high accuracy and low latency position information allows for one or more benefits such as: confirmation that inspection operations are complete; mapping of inspection data to the inspection surface for review, planning, and/or long term iterative improvement of inspection operations; detection, mitigation, and repair for anomalous conditions such as obstacles, damaged areas of the inspection surface, or the like; a rapid indication that something in the inspection operation is not correct (e.g., separation of the inspection robot from the inspection surface and/or incorrect traversal of the inspection path); comparison between similar locations of offset inspection facilities, which can enhance detection of anomalies and/or outliers, and/or increase the capability of iterative improvement operations such as machine learning and/or artificial intelligence operations to enhance inspections, plan repair or maintenance cycles, improve confidence in certifications or risk management operations, or the like.

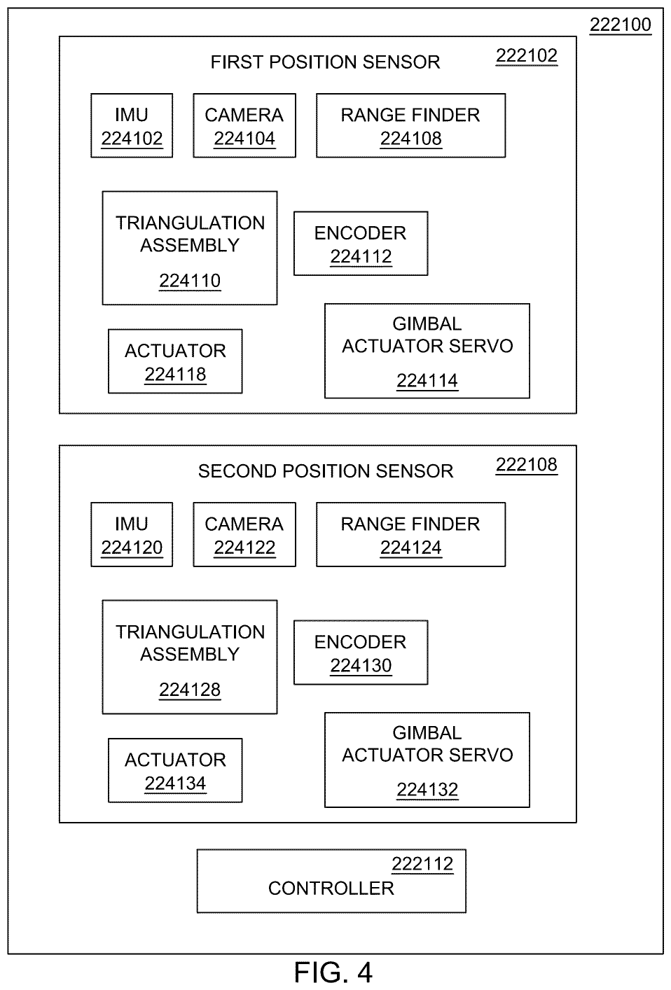

Referring to FIGS. 4-8, certain further aspects of the inspection robot positioning system 222100 are described in the following, any one or more of which may be present in certain embodiments. With reference to FIG. 4, in certain embodiments, in the inspection robot positioning system 222100, each one of the first position sensor 222102 and the second position sensor 222108 may include at least one of: an inertial measurement unit (IMU) 224102, 224120, a camera 224104, 224122, a range finder 224108, 224124, a triangulation assembly 224110, 224128, an encoder 224112, 224130 for at least one of a wheel or a motor of the inspection robot 223102 (FIG. 3), a gimbal actuator servo 224114, 224132, or an actuator 224118, 224134 of the inspection robot 223102 (FIG. 3).

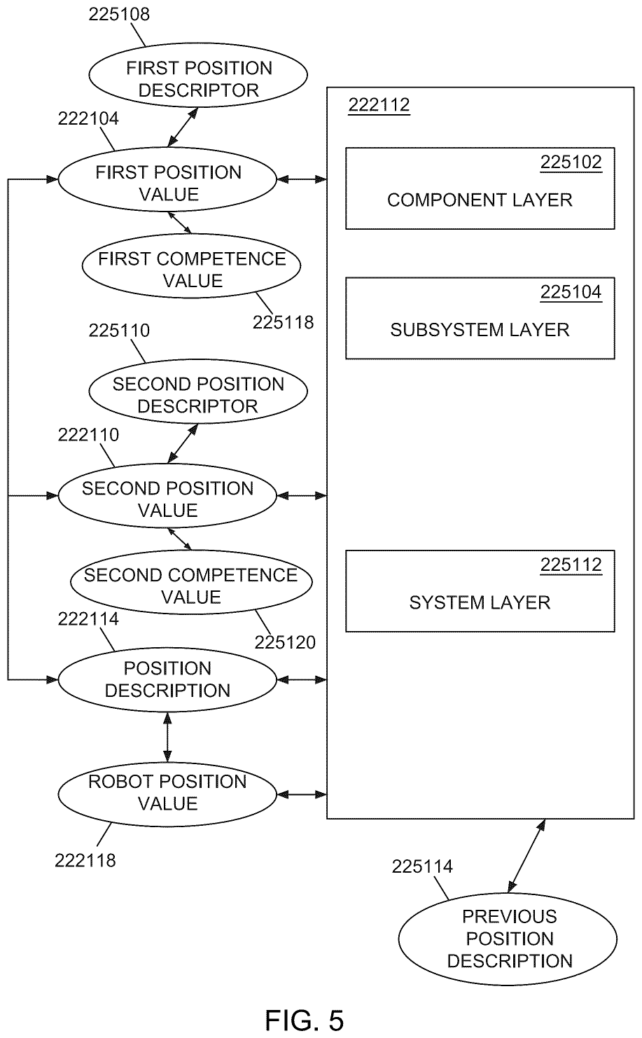

Referring to FIG. 5, in certain embodiments, in the inspection robot positioning system 222100 (FIG. 4), the controller 222112 may further include: a component layer 225102 configured to interpret the first position value 222104 and the second position value 222110, a subsystem layer 225104 configured to: process the first position value 222104 into a first position descriptor 225108, and process the second position value 222110 into a second position descriptor 225110, and a system layer 225112 configured to determine the position description 222114 in response to the first position value 222104 and the second position value 222110. In certain embodiments, in the inspection robot positioning system 222100, the system layer 225112 may be further configured to determine the position description 222114 in response to a previous position description 225114.

In certain embodiments, in the inspection robot positioning system 222100, the system layer 225112 may be further configured to determine the position description 222114 in response to: a first competence value 225118 associated with the first position value 222104, and a second competence value 225120 associated with the second position value 222110.

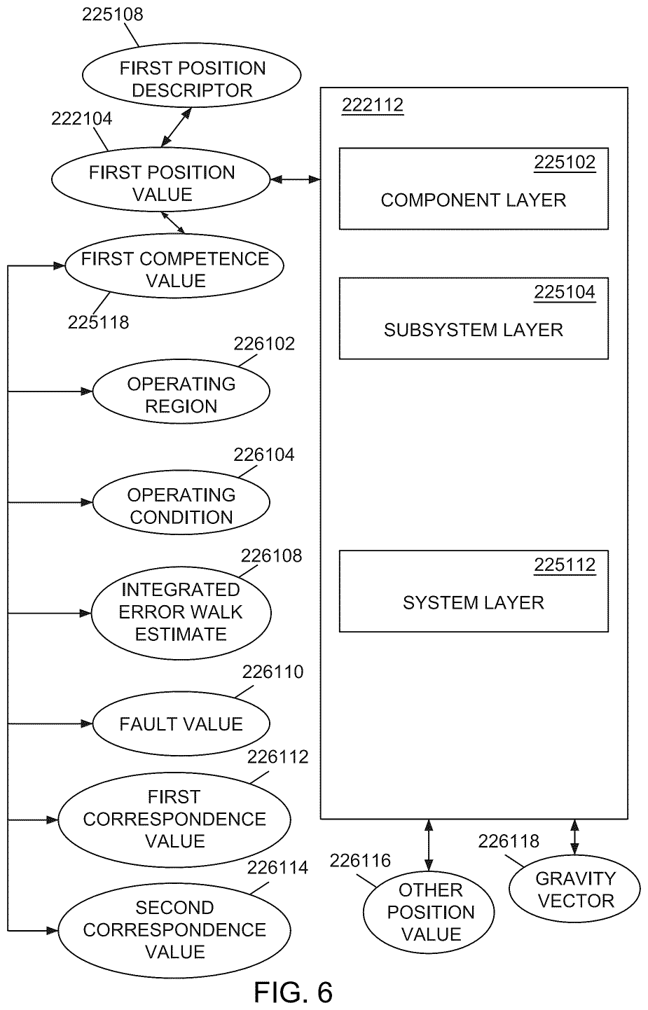

Referring to FIG. 6, in certain embodiments, in the inspection robot positioning system 222100, the subsystem layer may be further configured to determine the first competence value 225118 in response to at least one of: an operating region 226102 of the first position sensor 222102, an operating condition 226104 of the inspection robot 223102, an integrated error walk estimate 226108 corresponding to the first position sensor 222102, a fault value 226110 associated with the first position sensor 222102 (FIG. 4), a first correspondence value 226112 for a correspondence of the first position value 222104 with a previous position description, e.g., the previous position description 225114 of FIG. 5, or a second correspondence value 226114 for a correspondence of the first position value 222104 with at least one other position value 226116.

Certain embodiments herein reference a competence value. A competence value, as utilized herein, includes any indication that a given position source (e.g., a position sensor and/or positioning algorithm that provides a position value) is providing a proper position value, and/or that the position source is not providing a proper position value. The competence value may be applied quantitatively (e.g., weighting the particular position value in a Kalman filter or other combining methodology between various sensors) and/or qualitatively (e.g., the related position value is ignored, mode switched between weightings, the real position estimate is reset to a position indicated by the position value, the real position estimate is reset to a value based on the position value, for example exponentially decaying toward a position indicated by the position value, etc.). In certain embodiments, the competence value may be based on one or more determinations such as: an operating region of the position sensor (e.g., determining the competence value based on the position sensor operating within a competent range, and/or having a competence determined according to the range, for example to account for ranges of the sensor that are of reduced precision, accuracy, linearity, etc); an operating condition of the inspection robot (e.g., some sensors may be more or less capable depending upon the operating condition of the robot, such as current operating temperature, velocity, acceleration, elevation, orientation, etc.); an integrated error walk estimate corresponding to the position sensor (e.g., estimating a drift of an integrated value over time, based on a time since a high confidence reset for the integrator, and/or based on an accumulated value since a high confidence reset for the integrator); a fault value associated with the position sensor (e.g., reducing a competence value for the position sensor based on a fault condition, for example removing the sensor from consideration for a failed value, reducing the contribution of the sensor for a suspect value or during a fault value increment condition, etc.); a first correspondence value for correspondence of the first position value with a previous position description (e.g., adjusting the contribution of the sensor based on whether the sensor is providing a value that is within an expected range based on the current estimated real position and operating conditions); and/or a second correspondence value for correspondence of the first position value with at least one other position value (e.g., adjusting the contribution of sensors based on consistency with other position sensors and/or position algorithms within the system). In certain embodiments, one or more elements of the competence value may be referenced herein as a competence factor. In certain embodiments, a competence factor may form a part of the competence value, may be utilized to determine the competence value, and/or may constitute the competence value (e.g., during an operating period where a single one of the position sensors is being utilized to determine the current estimated real position, for example during a reset where the single position sensor is known to be correct, and/or when other position sensors are deprecated—for example due to operating out of range, a fault condition, etc.).

One of skill in the art, having the benefit of the present disclosure and information ordinarily available when contemplating a particular system, can readily determine competence values for the sensors and/or positioning algorithms of the system, and how to apply them to determine the current estimated real position. Certain considerations to determine and/or apply competence values for sensors and/or positioning algorithms herein include one or more aspects such as: the operating range of the sensor; the performance of the sensor (e.g., precision, accuracy, responsiveness, linearity, etc.) within the operating range of the sensor; the fault detection scheme for the sensor; an error or uncertainty accumulation rate for the sensor; and/or the performance of the sensor based on various operating conditions for the system including the sensor.

Referring to FIGS. 5 and 6, In certain embodiments, in the inspection robot positioning system 222100 (FIG. 4), the system layer 225112 may be further configured to determine the position description 222114 by blending the previous position description 225114, the first position value 222104, and the second position value 222110. In certain embodiments, in the inspection robot positioning system 222100, the system layer 225112 may be further configured to determine the position description 222114 by weighting application of each of the first position value 222104 and the second position value 222110 in response to the corresponding first competence value 225118 and second competence value 225120. In certain embodiments, in the inspection robot positioning system 222100, the system layer 225112 may be further configured to determine the position description 222114 by at least partially resetting the position description 222114 in response to one of the first competence value 225118 or the second competence value 225120 and the corresponding first position value 222104 or second position value 222110. In certain embodiments, in the inspection robot positioning system 222100, the first position sensor 222102 may include an inertial measurement unit (IMU), e.g., the IMU 224102 of FIG. 4; an inspection surface, e.g., the inspection surface 223104 of FIG. 3, may include a substantially vertical surface; and the controller 222112 may be further configured to determine the first position value 222104 in response to a gravity vector 226118.

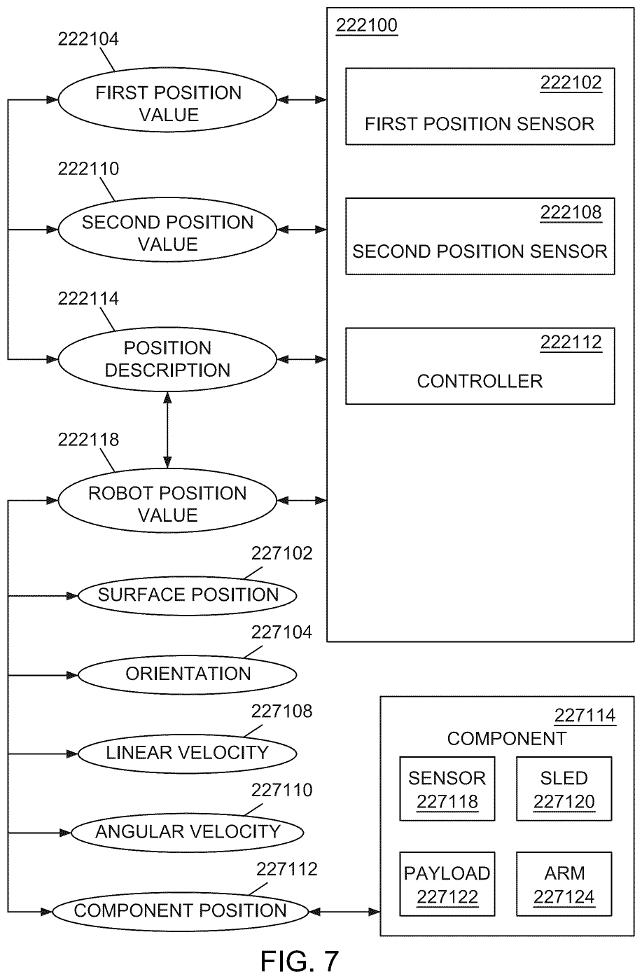

Referring to FIG. 7, in certain embodiments, in the inspection robot positioning system 222100, the robot position value 222118 may include a position 227102 of the inspection robot 223102 (FIG. 3) on the inspection surface 223104 (FIG. 3). In certain embodiments, in the inspection robot positioning system 222100, the robot position value 222118 may include an orientation 227104 of the inspection robot 223102 on the inspection surface 223104. In certain embodiments, in the inspection robot positioning system 222100, the robot position value 222118 may include at least one of a linear velocity 227108 of the inspection robot 223102 or an angular velocity 227110 of the inspection robot 223102. In certain embodiments, in the inspection robot positioning system 222100, the robot position value 222118 may include a position 227112 of a component 227114 of the inspection robot 223102. In certain embodiments, in the inspection robot positioning system 222100, the component 227114 may include at least one of: a sensor 227118, a sensor sled 227120, a payload 227122, or a payload arm 227124.

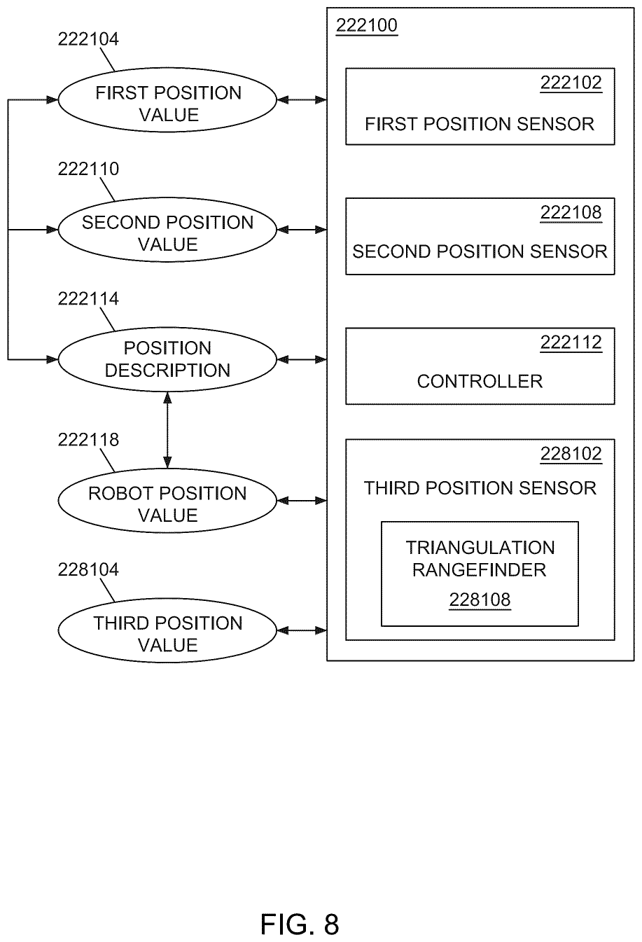

Referring to FIG. 8, in certain embodiments, in the inspection robot positioning system 222100, the first position sensor 222102 may include an internal measurement unit, e.g., the IMU 224102 of FIG. 4; and the second position sensor 222108 may include an encoder for at least one of a wheel or a motor of the inspection robot, e.g., the encoder 224130 of FIG. 4. In certain embodiments, the inspection robot positioning system 222100 may further include a third position sensor 228102 providing a third position value 228104, wherein the controller 222112 may be further configured to determine the position description 222114 in response to the third position value 228104, and wherein the third position sensor 228102 may include a triangulation rangefinder 228108.

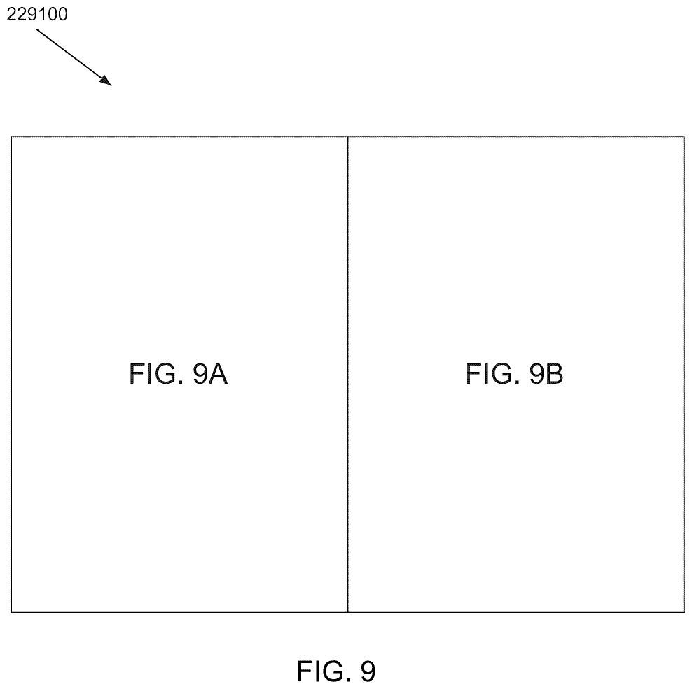

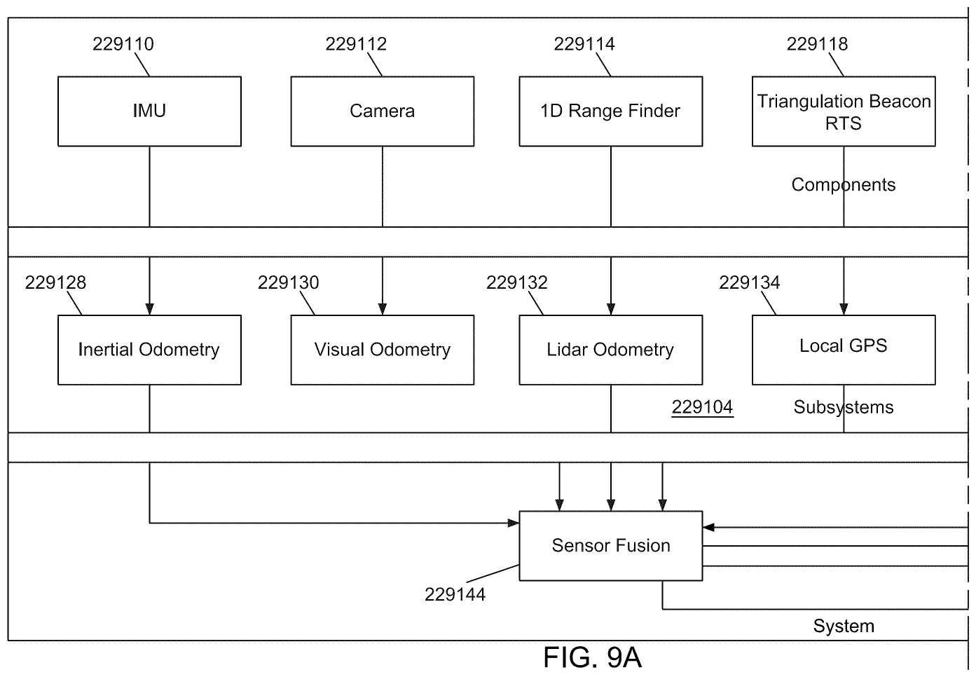

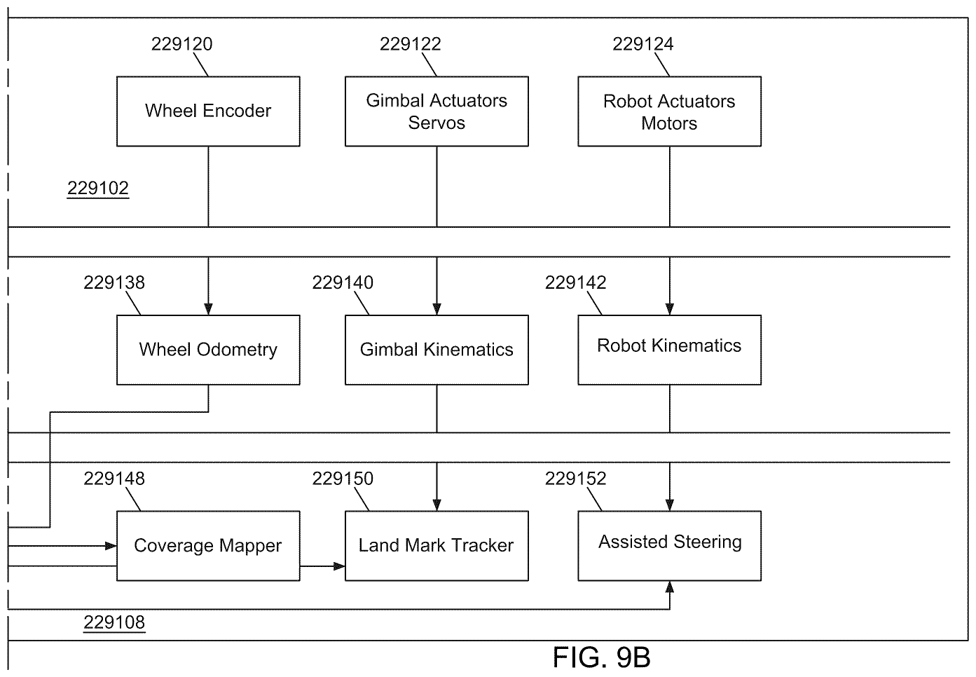

Referring to FIGS. 9, 9A, and 9B, embodiments of an inspection robot positioning system 229100 may include, for example, three layers: a component layer 229102, a subsystem layer 229104, and a system layer 229108. The component layer 229102 may include hardware or sensor modules that may be independently controllable or may provide meaningful data about the environment and state of the robot, for example, various sensors. The sensors may be onboard the inspection robot and/or may be offboard. Components in the component layer 229102 may also include software, which may include the firmware or hardware interface, with appropriate drivers and communications. The subsystem layer 229104 may be primarily software-based modules that may utilize the data or controllability of a component, and may build intelligent behavior on top of it, which may include filtering, localization, and/or other algorithms. The system layer 229108 may include system-level modules that may bring together multiple subsystems to perform a robot-level function, e.g., find the position, assist the driver in steering etc. The modules may do so by techniques such as sensor fusion. System-level modules may also act as an interface, e.g., to remote control (RC) and other software components down the pipeline. The correspondence between the components and the subsystem may not be 1-to-1. The diagram of FIGS. 9, 9A, and 9B is provided as a non-limiting example.

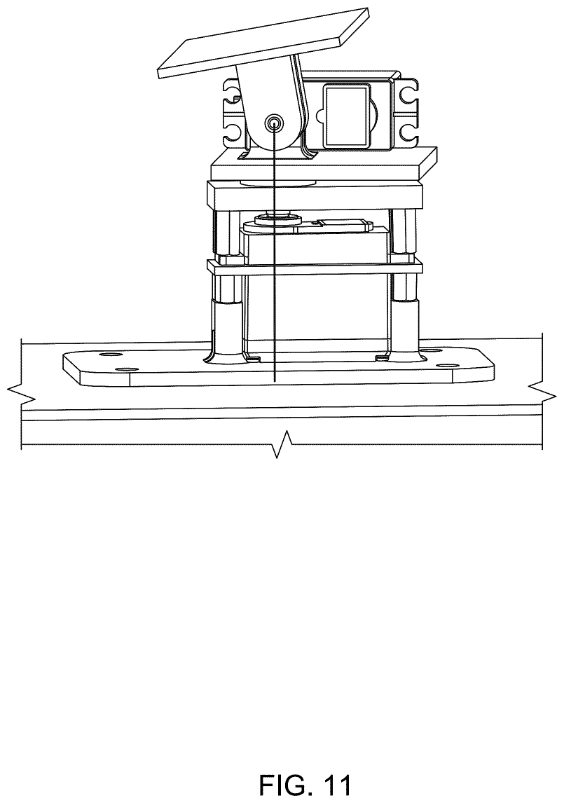

The component layer 229102 may include, for example, an inertial measurement unit (IMU) 229110, a camera 229112, at least one one-dimensional range finder 229114, a triangulation beacon 229118 (e.g., for a robotic total station (RTS)), a wheel encoder 229120, gimbal actuator servos 229122, and robot actuator motors 229124. The IMU 229110 may include, for example, an accelerometer and/or a gyroscope. The triangulation beacon 229118 may also include GPS components. The gimbal actuator servos 229122 may provide light detection and ranging (LiDAR), a triangulation beacon, and/or a camera, and may keep the inspection robot and/or a part of the inspection robot level with the ground or with the inspection surface. An example of a gimbal platform is illustrated in FIG. 11, in which a center line may be determined to find a pitch or yaw of a payload on the platform. The robot actuator motors 229124 may drive a wheel motor. The system 229100 may track how many times the wheel has turned, which may be used, for example, to derive a speed and/or velocity of the inspection robot. It may then determine whether the wheel speed matches the direction the robot is supposedly travelling. The position of the inspection sensors on the inspection robot may be based on the position of the robot. The sensors may be located, for example, on the payload, on an arm on the payload, or on a sled on the arm. As used herein, finding the position of the inspection robot may include, as a non-limiting list, determining the position, velocity, speed, acceleration, angular acceleration, a derivative of the position, and/or, a second derivative of the position.

The subsystem layer 229104 may include inertial odometry 229128, visual odometry 229130, LiDAR odometry 229132, local GPS 229134, wheel odometry 229138, gimbal kinematics 229140, and robot kinematics 229142. The inertial odometry 229128 may include a complementary filter. A computer model of the inspection robot may be included. Computing by the subsystem layer 229104 may be performed onboard the inspection robot and/or offboard.

The system layer 229108 may include sensor fusion 229144, a coverage mapper 229148, a landmark tracker 229150, and assisted steering 229152. The sensor fusion 229144 may include at least two inputs to be fused or mixed. The inputs to the sensor fusion 229144 may be directly from sensors in the component layer 229102, may be derived from processing or computing in the subsystem layer 229104, or may be a combination of sensing and computing.

A script may be provided to run the software data nodes. For example, a complementary filter node, robot model, RTS node, and sensor fusion node may be provided. A visualization may be provided. Data handling may be provided, for example, the coverage mapper 229148. A driver assist node may be provided, for example to specify yaw offset and display it to an operator. A data plotting tool may also be provided.

Mixing (or fusion) of the inputs may be performed by any operators known in the art. Mixing may include inputs from sensor values and/or computed values, and may change, for example, based on the reliability of the data. Inputs may switch from low accuracy values to high accuracy values, and vice versa. Values of the inputs may be weighted, for example, based on reliability of the data. Sensor values may include, for example, instant sensor values and/or sensor values integrated over time. Sensor values may be provided, for example, from the IMU 229110, which may include an accelerometer and a gyroscope. Individual sensor values may be processed for the position units utilized—for example the output of an accelerometer may be integrated to provide velocity information. Weighting may be utilized to provide a greater contribution in the position determination for a sensor having a greater confidence at the moment—for example a sensor that is operating within an expected range and with operating conditions consistent with the sensor providing high confidence position information. The mixing may be performed as a contribution by each sensor, by filtering the final position information toward one or more of the sensed values according to the weight given to each sensor, and/or as an override (e.g., an absolute position sensor providing a high confidence value may be utilized to reset the position value to the value indicated by the sensor). In certain embodiments, for example where a sensor has a fault, is out of range, is saturated, and/or is otherwise suspect, the sensor may be ignored, turned off, given a low (or zero) weighting, or the like. In certain embodiments, statistical normalization, rate limiting, or the like may be applied to the final determined position value, and/or to individual sensor values, for example with expected position values utilized until the sensor is confirmed to be providing reliable data, and/or until the final determined position value can be confirmed—for example with other reliable sensor data. In certain embodiments, noise and/or inaccuracies in individual sensor values and/or the final determined position value, may be smoothed out and/or managed with various techniques, such as low pass filtering, applying a Kalman filter, or the like. In certain embodiments, resets may be applied to the final determined position value (e.g., resetting when a high confidence sensor value is present as set forth preceding) and/or to individual sensor values (e.g., resetting an integrator for an individual sensor, such as an integrator from an acceleration sensor when a high confidence velocity value is available).

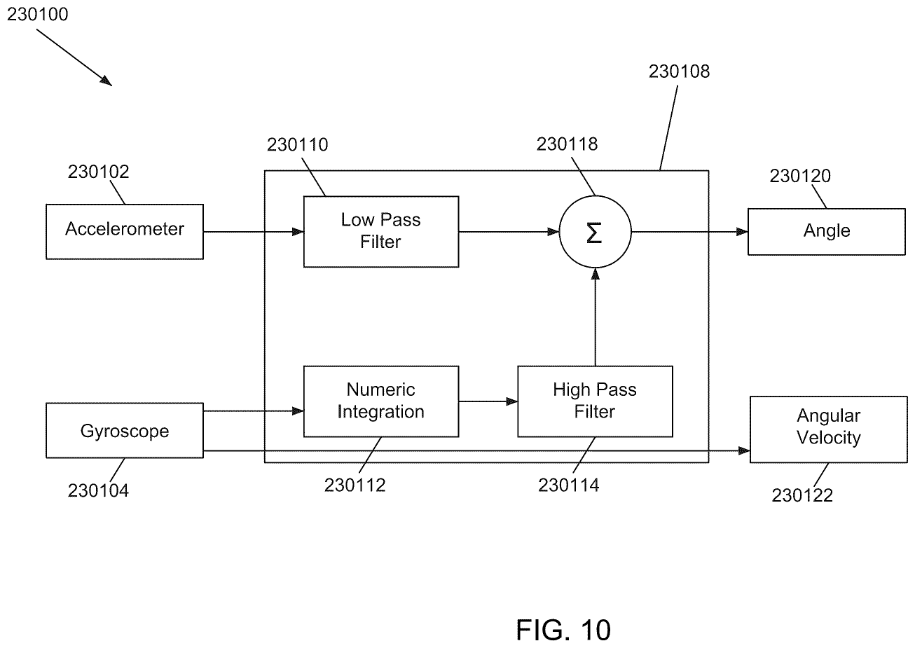

Referring to FIG. 10, an example of a sensor fusion 230100 may include mixing outputs from an accelerometer 230102 and a gyroscope 230104. A processor 230108 may receive the outputs 230102, 230104. The accelerometer output 230102 may be processed by a low pass filter 230110. The gyroscope output 230104 may be processed through a numerical integration 230112, which may output to a high pass filter 230114. The outputs of the low pass filter 230110 and the high pass filter 230114 may be combined, for example, in a summation unit 230118. The output from the summation unit 230118 may be used to determine the angle 230120 of motion of the inspection robot. The gyroscope output 230104 may be used separately to determine the angular velocity 230122 of the inspection robot.

Location accuracy improvement may include an accelerometer gravity vector. However, data from an accelerometer may be noisy, and may contain motion components, but will not drift. The motion components can be subtracted via measurement from other sources. A complementary filter may be used. In addition, motion of the inspection robot may be slow enough that gyroscope information can be omitted entirely. In one dimension, robot acceleration as measured by the encoders and/or drive commands may be subtracted before summation with integrated gyroscope data.

The sensors and other options for inputs to the sensor fusion may be based on the sensor output itself, may be a processed version of the sensor output, may be a weighted average of one or more sensor outputs and/or processed versions, or may be used as a reset, for example, if a sensor gives occasional data that is considered to be reliable. For example, if a GPS signal is considered to be accurate, then the GPS value may be used directly to determine a location. However, if the GPS data is intermittent, then in between GPS readings, location information may be derived from an accelerometer, a gyroscope, dead reckoning, etc.

Additional or alternative processing/computing by the sensor fusion 230100 may include applying a Kalman filter, which may be applied before or after mixing. In addition, the high pass filter and low pass filter may be switched, duplicated, omitted, or replaced by the Kalman filter as appropriate for the sensor fusion processing.

The system may also recognize a bad or improper sensor value and may ignore or turn off the sensor, e.g., temporarily. For example, if a line-of-sight to a beacon is lost, a sensor may suddenly report a position several feet away from the location of the inspection surface. The system may determine a position and/or a yaw of the inspection or a part of the inspection robot. The inputs to the sensor fusion may include external data, for example, known inspection surface geometry. Localization may also include information on location of Wi-Fi routers or other Wi-Fi or data transmission devices.

The gravity vector from the IMU may be used to calculate the angle from vertical and compensate for this using trigonometry. There may be limitations to this method, however. For example, it assumes that the inspection laser hits a flat plane at ground level. In reality, the surfaces at the ground level of a tank are rarely flat, and the inspection laser may hit large slopes or adjacent objects. While such a system may compensate for headings ±90°, because the ground may only be flat for a relatively small area, the heading range that is accurately compensated for may be much smaller, e.g., less than ±5° in most cases. As such, and expecting similar issues for sensors not yet integrated, a pointing mechanism that can hold the absolute angle in one or both of these axes has been developed. Force of gravity, e.g., determined using the accelerometer, may be used to determine the direction of the ground, and therefore the direction of the inspection robot. In one example, in 10-20 minutes of run time of the inspection robot, the noise of the force of gravity determination should be less than ±2°.

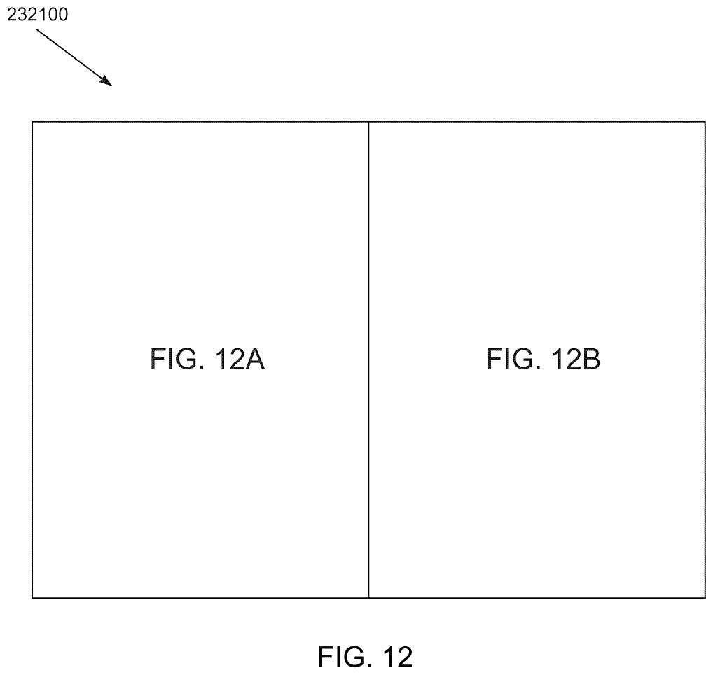

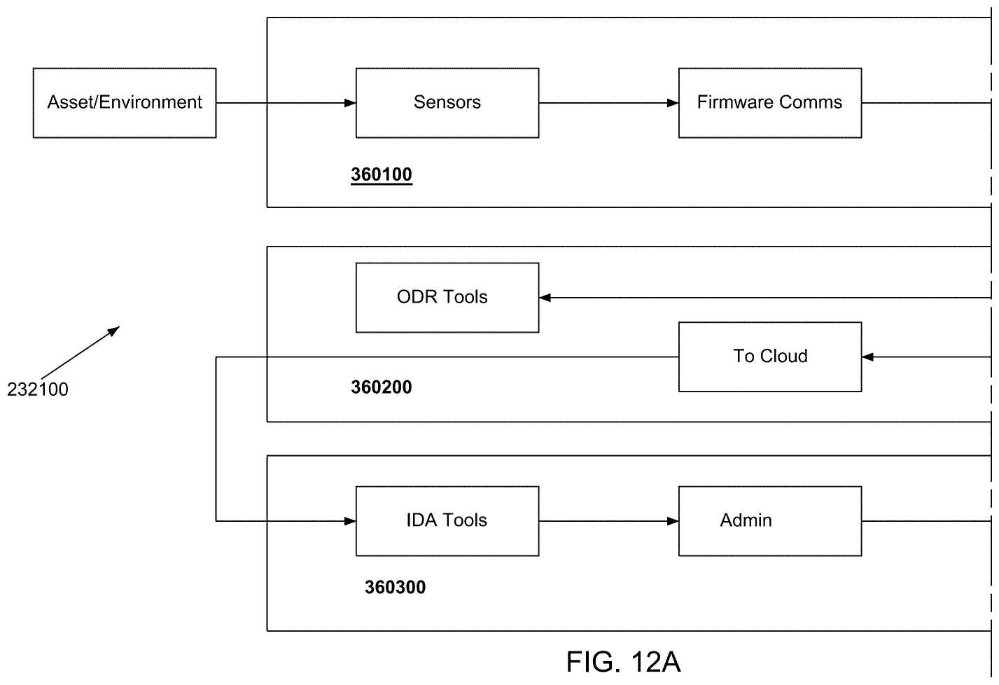

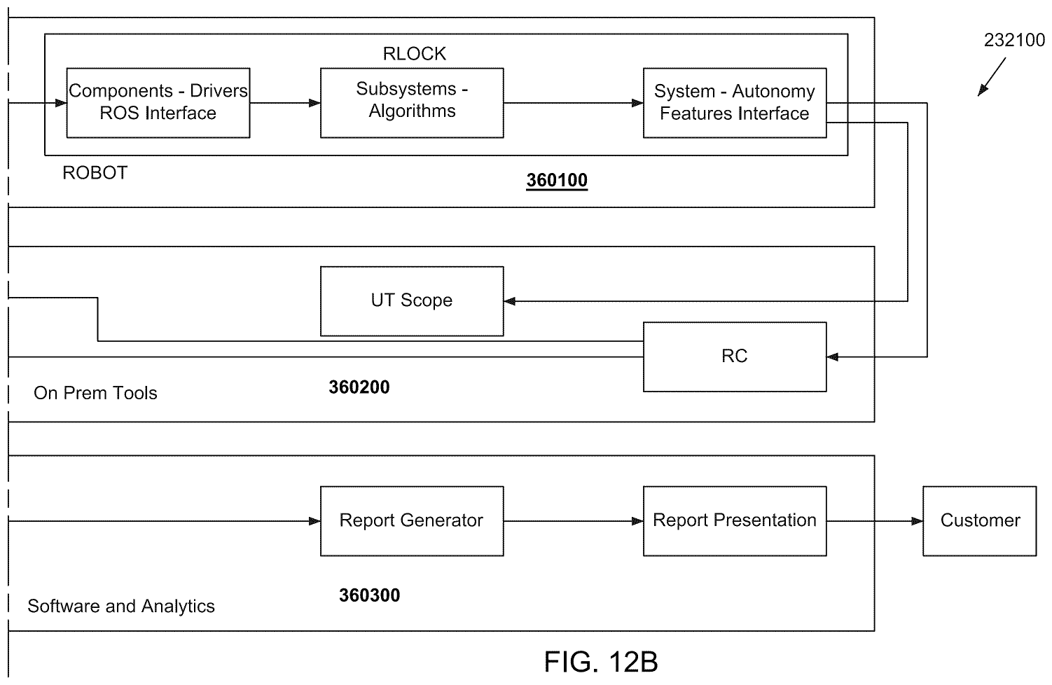

An example of a system architecture 232100 is shown in FIGS. 12, 12A, and 12B. The system architecture 232100 includes the component layer 229102, the subsystem layer 229104, and the system layer 229108 of FIG. 9. In embodiments, the system architecture 232100 may include a robot hardware layer 360100, a robot software layer 360200, and/or a cloud layer 360300. The robot hardware layer 360100 may include various onboard hardware components, such as those shown in FIGS. 12A and 12B which are disposed onboard the robot 100 (FIG. 1). The robot software component 360200 may include various applications and/or software tools that may be stored onboard the robot 100 (FIG. 1) in RAM, ROM, PROM and/or any other suitable type of electronic storage medium. The cloud layer 360300 may include one or more remote servers and/or other computers disposed offboard the robot 100 (FIG. 1).

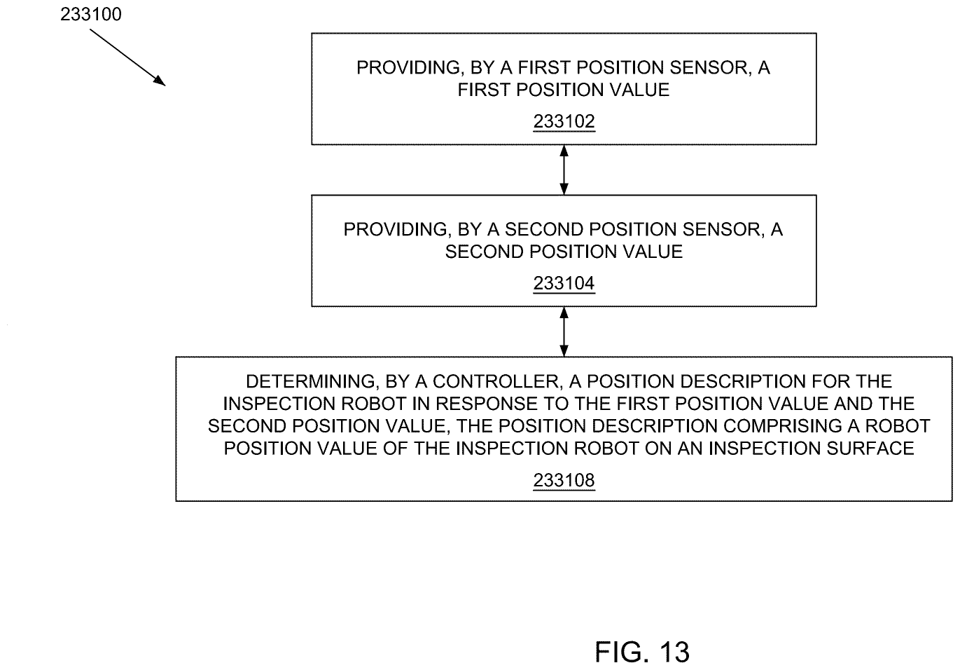

Referring to FIG. 13, a method 233100 for sensor fusion in an inspection robot positioning system may be provided. The inspection robot positioning system may be located on and/or in an inspection robot, and/or may be configured in association and/or in communication with the inspection robot. The method 233100 may include providing, by a first position sensor, a first position value 233102; providing, by a second position sensor, a second position value 233104; and determining, by a controller, a position description for the inspection robot in response to the first position value and the second position value, the position description comprising a robot position value of the inspection robot on an inspection surface 233108. The first position sensor and the second position sensor may be onboard the inspection robot and/or may be offboard, e.g., in the environment of the inspection robot or the inspection surface, or may be externally provided.

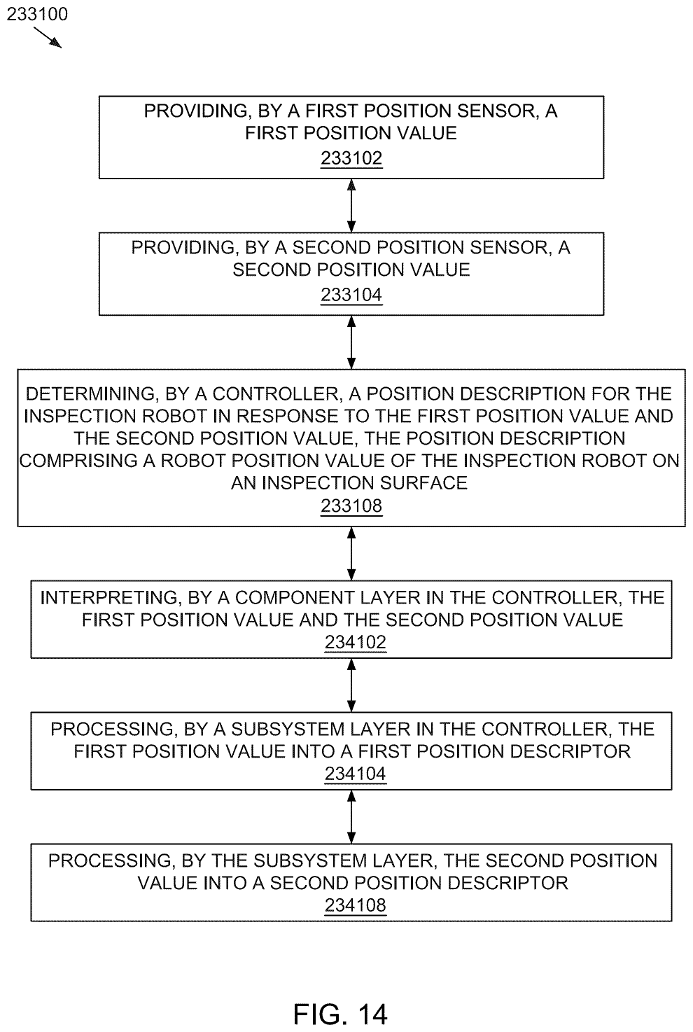

Referring to FIGS. 14-17, certain further aspects of the method 233100 are described in the following, any one or more of which may be present in certain embodiments.

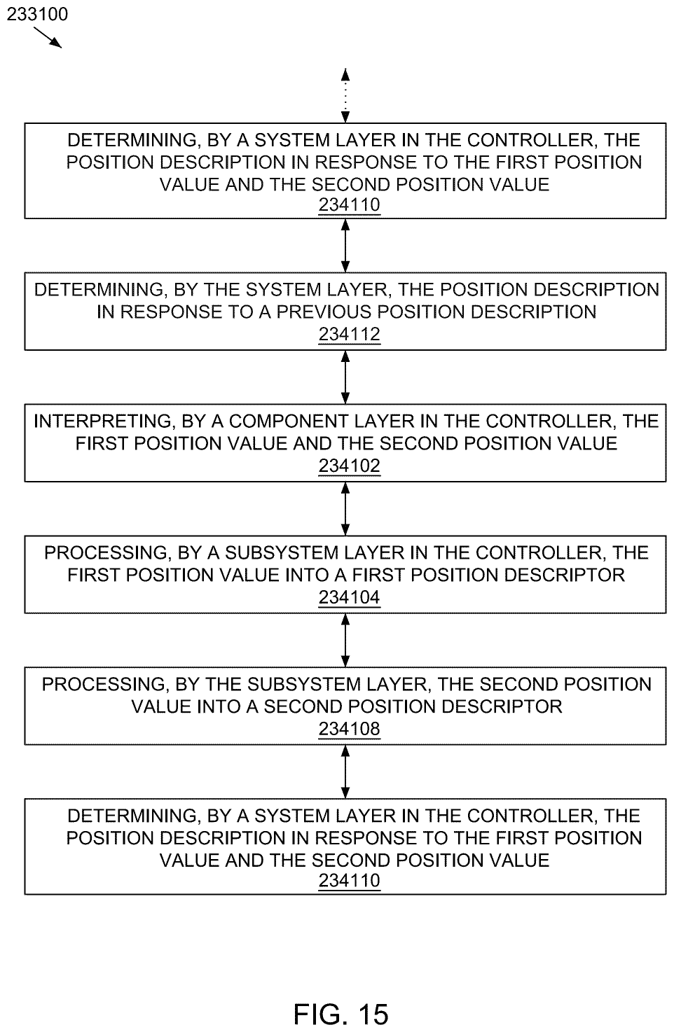

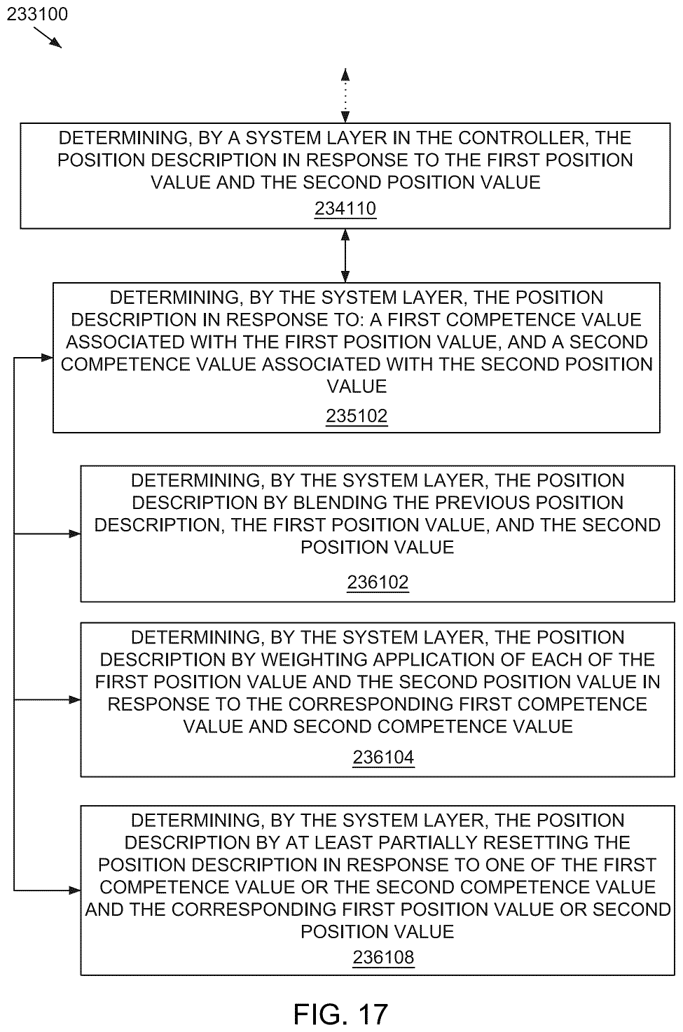

In certain embodiments, each one of the first position sensor and the second position sensor may include at least one of: an inertial measurement unit (IMU), a camera, a range finder, a triangulation assembly, an encoder for at least one of a wheel or a motor of the inspection robot, a gimbal actuator servo, or an actuator of the inspection robot. In certain embodiments, the method 233100 may further include: interpreting, by a component layer in the controller, the first position value and the second position value 234102 (FIG. 14), processing, by a subsystem layer in the controller, the first position value into a first position descriptor 234104 (FIG. 14), processing, by the subsystem layer, the second position value into a second position descriptor 234108 (FIG. 14), and determining, by a system layer in the controller, the position description in response to the first position value and the second position value 234110 (FIGS. 15 and 17). In certain embodiments, the method 233100 may further include determining, by the system layer, the position description in response to a previous position description 234112 (FIG. 15).

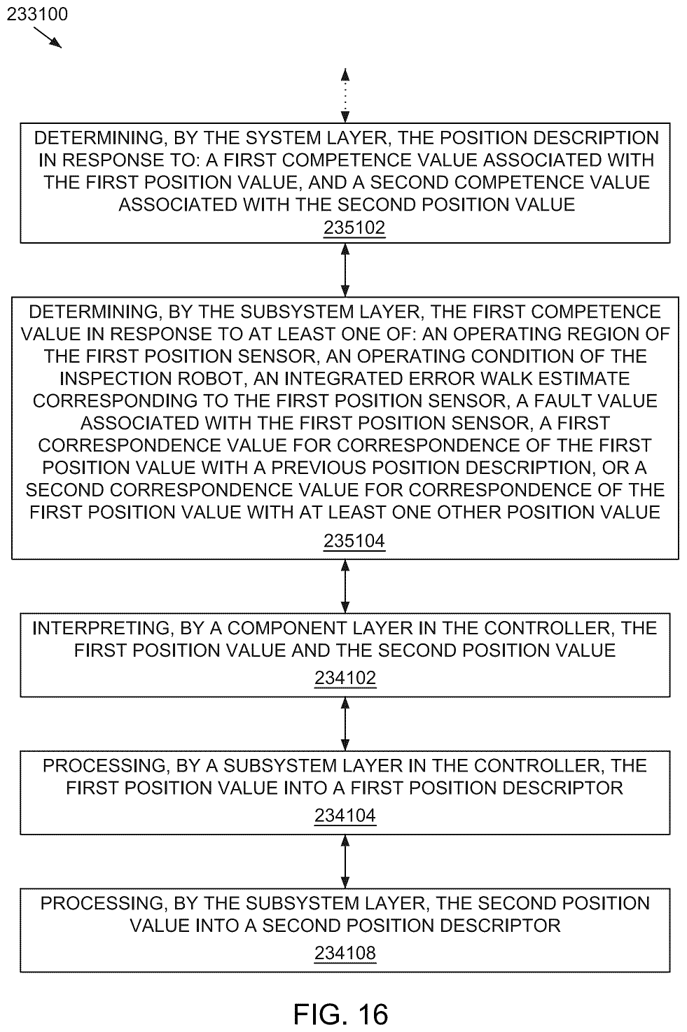

In certain embodiments, the method 233100 may further include determining, by the system layer, the position description in response to: a first competence value associated with the first position value, and a second competence value associated with the second position value 235102 (FIGS. 16 and 17). In certain embodiments, the method 233100 may further include: determining, by the subsystem layer, the first competence value in response to at least one of: an operating region of the first position sensor, an operating condition of the inspection robot, an integrated error walk estimate corresponding to the first position sensor, a fault value associated with the first position sensor, a first correspondence value for correspondence of the first position value with a previous position description, or a second correspondence value for correspondence of the first position value with at least one other position value 235104 (FIG. 16).

In certain embodiments, the method 233100 may further include determining, by the system layer, the position description by blending the previous position description, the first position value, and the second position value 236102 (FIG. 17). In certain embodiments, the method 233100 may further include determining, by the system layer, the position description by weighting application of each of the first position value and the second position value in response to the corresponding first competence value and second competence value 236104 (FIG. 17). In certain embodiments, the method 233100 may further include determining, by the system layer, the position description by at least partially resetting the position description in response to one of the first competence value or the second competence value and the corresponding first position value or second position value 236108 (FIG. 17).

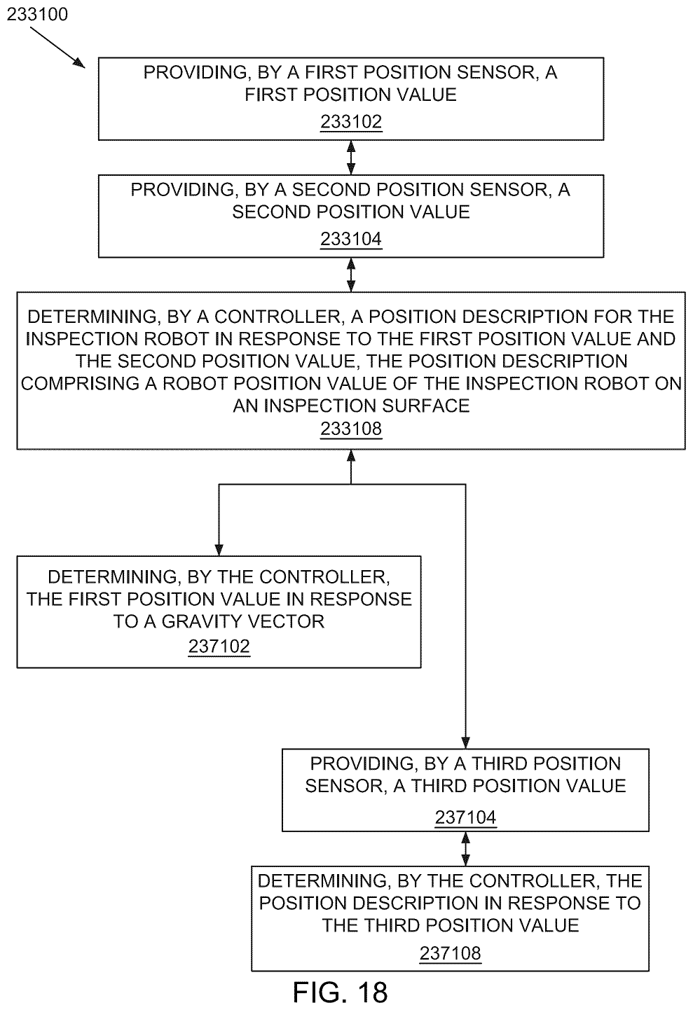

In certain embodiments, the first position sensor may include an inertial measurement unit (IMU), an inspection surface may include a substantially vertical surface, and the method 233100 may further include determining, by the controller, the first position value in response to a gravity vector 237102 (FIG. 18). In certain embodiments, the robot position value may include a position of the inspection robot on the inspection surface. In certain embodiments, the robot position value may include an orientation of the inspection robot on the inspection surface. In certain embodiments, the robot position value may include at least one of a linear velocity of the inspection robot or an angular velocity of the inspection robot. In certain embodiments, the robot position value may include a position of a component of the inspection robot. In certain embodiments, the component may include at least one of: a sensor, a sensor sled, a payload, or a payload arm.

In certain embodiments, the first position sensor may include an internal measurement unit, and the second position sensor may include an encoder for at least one of a wheel or a motor of the inspection robot. In certain embodiments, the method 233100 may further include providing, by a third position sensor, a third position value 237104 (FIG. 18), and determining, by the controller, the position description in response to the third position value 237108 (FIG. 18), wherein the third position sensor may include a triangulation rangefinder.

It can be seen that various embodiments herein provide for an inspection robot capable to inspect a surface such as an interior of a pipe and/or an interior of a tank. Additionally, embodiments of an inspection robot herein are operable at elevated temperatures relative to acceptable temperatures for personnel, and operable in composition environments (e.g., presence of CO₂, low oxygen, etc.) that are not acceptable to personnel. Additionally, in certain embodiments, entrance of an inspection robot into certain spaces may be a trivial operation, where entrance of a person into the space may require exposure to risk, and/or require extensive preparation and verification (e.g., lock-out/tag-out procedures, confined space procedures, exposure to height procedures, etc.). Accordingly, embodiments throughout the present disclosure provide for improved cost, safety, capability, and/or completion time of inspections relative to previously known systems or procedures.

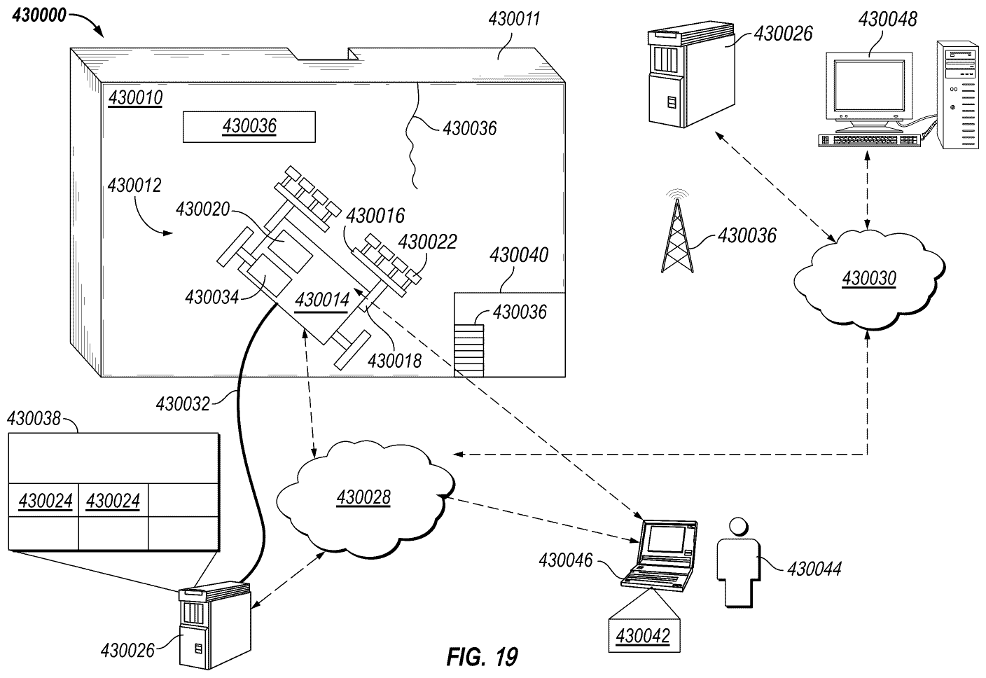

Referring to FIG. 19, a system 430000 for inspecting and inspection surface 430010, in accordance with embodiments of the current disclosure, is shown. The inspection surface 430010 may form part of a structure 430011, e.g., a storage tank, ship hull, etc., having multiple inspection surfaces. The system 430000 includes an inspection robot 430012 having a body 430014, one or more payloads 430016 coupled to the body 430014 via arms 430018, one or more controllers 430020, and/or one or more inspection surface sensors 430022 disposed in the payloads and structured to generate inspection surface data 430024 from and/or corresponding to the inspection surface 430010. The system 430000 may include one or more servers 430026 which may be in electronic communication with the inspection robot 430012 via one or more networks, e.g., a local network 430028, a wide area network 430030 (such as the internet), and/or a localized communication channel 430032, e.g., a Wi-Fi, Bluetooth, infrared, physical communication cable, etc. The inspection robot 430012 may further include one or more positioning sensors 430034 structured to determine the position of the inspection robot 430012 with respect to the inspection surface 430010 and/or in relation to one or more features 430036. Non-limiting examples of positioning sensors include: optical cameras, lasers, sonars, radars, lidars, inertial navigation systems (IMUs), global positioning system (GPS) and/or other radio based location systems, and/or any other type of positioning device and/or system.

As will be explained in greater detail herein, embodiments of the current disclosure provide for generating mappings 430038 that map the inspection surface data 430024 to the inspection surface 430010. The mappings 430038 may be high-fidelity, e.g., highly accurate, and/or based on anchor points, e.g., selective features 430036. Embodiments of the current disclosure may provide for the combined registration/mapping of inspection surface data 430024 from multiple inspection surfaces and/or multiple structures 430011.

Embodiments of the current disclosure also provide for bulk data optimization for the inspection surface data 430024, e.g., the generation of a “position fit score” and/or a quality score for the mapping 430038 for a particular objective, e.g., selecting appropriate portions of the inspection surface data 430024 for a given region 430040 of the inspection surface 430010. As will be understood, in embodiments, the “position fit score” and/or the quality score may be based in part on multiple inspection runs.

The controller(s) 430020 and/or server 430026 may detect patterns within the inspection surface data 430024 that can be used to localize/map the inspection data 430024 to the inspection surface 430010 and/or to localize the position of the inspection robot 430012 with respect to the inspection surface 430010. Certain embodiments may also provide improved localization via loop closing and/or visual odometry, as further disclosed herein. Embodiments of the controllers 430020 and/or servers 430026 may provide for consistency in feature 430036 recognition and/or inspection surface data 430024 (with respect to the actual conditions of the inspection surface 430010) under variable circumstances, e.g., a dry inspection surface, a wet inspection surface, a freshly painted inspection surface, etc. The controllers 430020 and/or servers 430026 may utilize external data 430042 to register and/or map, e.g., mapping 430038, the inspection surface data 430024 to the inspection surface 430010. As described in more detail herein, non-limiting examples of external data 430042 include data not collected and/or generated by the inspection robot's 430012 sensors 430022 and/or 430034 during the same inspection run that generated the inspection surface data 430024 that the controllers 430020 and/or servers 430026 use the external data 430042 to register and/or map to the inspection surface 430010. For example, in embodiments, an operator 430044 may input starting positioning data into the inspection robot 430012, controllers 430020, and/or servers 430026.

In embodiments, the positioning sensors 430034 in combination with the controllers 430020 and/or servers 430026 may work together to ensure that the inspection robot 430012 travels along a desired and/or intended path that traverses the inspection surface 430010. For example, in embodiments, the operator 430044 may utilize a control unit/console/device 430046 that communicated with the servers 430026 and/or the inspection robot 430012, where the servers 430026 and/or the inspection robot 430012 provide guidance data to the operator 430044 via the control console 430046.

The controllers 430020 and/or servers 430026 may also determine one or more follow-up operations, e.g., re-inspection of an area at a higher resolution, based on previously collected/generated inspection surface data 430024 and/or other criteria, e.g., operator 430044 input.

Embodiments of the current disclosure may provide for a graphical user interface (GUI) for display on the control device 430046 and/or a remote computer 430048, where the GUI depicts a representation of the structure 430011 where one or more inspection surfaces and/or regions of the inspection surfaces may be selectable displayed and/or shown at various resolutions, scaling's, rotations, and/or other display options, as disclosed herein.

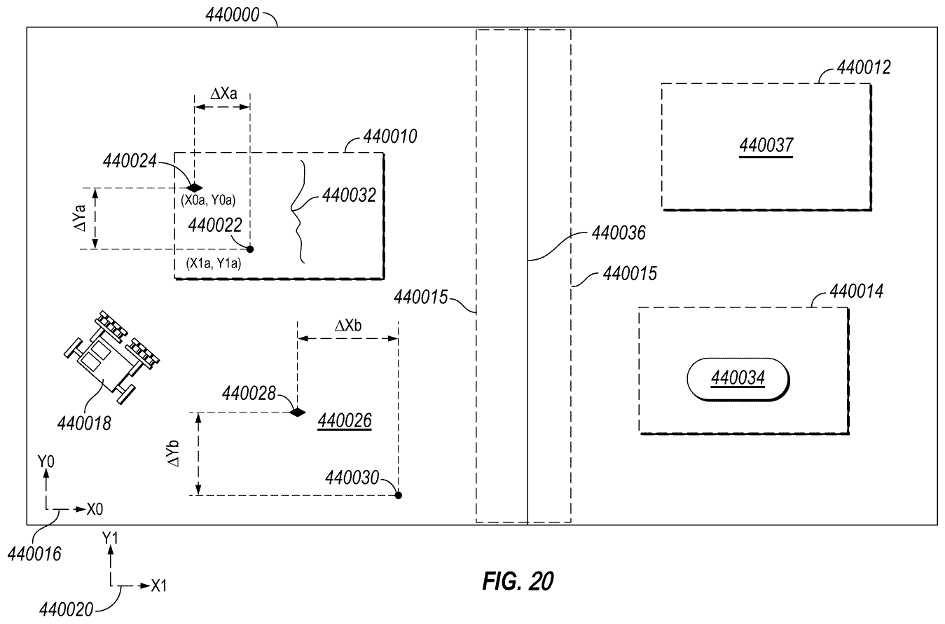

Referring now to FIG. 20 an inspection surface 440000 is shown. As stated herein, embodiments of the current disclosure provide for the generation of high-fidelity regions, e.g., 440010, 440012, 440014, 440015. The high-fidelity regions 440010, 440012, 440014, 440015, may be regions of inspection surface data mapped with a high level of accuracy (e.g., low positional error) to the inspection surface 440000 and/or at a selected level of resolution, e.g., +/−3 inches, +/−1 inch, +/−1 cm, +/−5 mm, +/−1 mm, etc. For example, the locations of the inspection surface 440000 may have a true set of positional coordinates (e.g., coordinates that define a plane, curve, and/or space that define true locations on the inspection surface) defined by true origin 440016, and an inspection robot 440018 may have set of determined positional coordinates (e.g., coordinates determined by the inspection robot based on position values that may be provided to the inspection robot or determined based at least in part on positioning sensors 430034 (FIG. 19)) and are with respect to determined origin 440020 (the origin that defines the inspection robot's sensed/determined position with respect to the true origin 440016).

The true origin 440016 may correspond to a corner of the inspection surface 440000, the center of the inspection surface 440000, a feature of the inspection surface 440000, and/or a selected position on the inspection surface 440000. For example, it may be advantageous for the true origin 440016 to be in a corner of the inspection surface 440000 when the inspection surface 440000 has a shape that corresponds to non-circular basic geometric shape, e.g., a square, a rectangle, a triangle, a rhombus, etc. For instances where the inspection surface 440000 has a circular and/or non-basic geometric shape, it may be advantageous for the true origin 440016 to correspond to a venter of the inspection surface. Where an inspection surface has an irregular shape, it may be advantageous for the position/location of the true origin 440016 on the inspection surface 440000 to be manually selected. As will be understood, in circumstances where the inspection surface has a discernable feature, e.g., a large pipe sticking out of the inspection surface, it may be advantageous to define the true origin 4400016 as the center of the feature or otherwise in relation to the feature. In embodiments, the true origin 440016 and/or the determined origin 440020 may define their respective planes, curves, and/or spaces in cartesian, spherical, and/or polar coordinates.

As a non-limiting example of positional error and a high-fidelity region with respect to the mapping of inspection surface data to the inspection surface 440000, the inspection robot 440018 may generate a set G of inspection surface data for a position (shown as point 440022) determined by the inspection robot 440018 as having coordinates X1a and Y1a as defined by determined origin 440020. In reality, however, G may actually correspond to true position 440024 having coordinates X0a and Y0a with respect to the true origin 440016, resulting in a positional error of ΔXa and ΔYa, where ΔXa is the difference between X1a and X0a and ΔYa is the difference between Y1a and Y0a. As region 440010 is a high-fidelity region, the positional error between the true and determined coordinates falling within region 4400100 is less than the positional error of points falling within a non-high-fidelity region, e.g., region 440026. That is, the ΔXa and ΔYa for coordinates 440022 and 440024 should are less than the ΔXa and ΔYa for coordinates 440028 and 440030.

In embodiments, the high-fidelity regions 440010, 440012, 440014, and/or 440015 may be generated around and/or otherwise based on features such as cracks 440032 (visible on the inspection surface 440000 and/or internal to the inspection surface 440000), stairs, pipes, openings, doorways, obstacles 440034, seem lines 440036, physical markers and/or markings put on the surface such as painted ‘Xs’ and/or beacons indicting repair cites, and/or any other object suitable for defining a location. As will be understood, markings/features, whether physical or virtual, may be generated/put in place by either a human, an inspection robot, or another machine. In embodiments, the features may be: structural features, e.g., walls, openings, doors, pipes, nozzles, repair patches, stairs, railings, edges, tanks, hulls, antennas, conduits, and/or any other part of a structure that may have one or more inspection surfaces; surface features, e.g., cracks, curvature, seem lines, obstacles, joints, hatches, panels, damage, and/or any other type of object or characteristic commonly found on and/or in inspection surfaces; and/or virtual features 440037, e.g., digital objects defined in virtual and/or augmented reality such as markers, beacons, lines, rings, boxes, cubes, etc. In embodiments, the feature may be a structural feature of the same structure that includes the inspection surface inspected by the inspection robot, e.g., a set of stairs that climb a tank inspected by the inspection robot. In embodiments, the feature may be a structural feature of a structure apart from the structure that includes the inspection surface inspected by the inspection robot, e.g., a radio tower next to a tank being inspected by the inspection robot. In embodiments, the structure including the inspection surface and/or the structure not including the inspection surface may be a tank, stairs, a drain, a pipe, a window, an antenna, a tower, a building, and/or any other type of structure.

Embodiments of the current disclosure may also provide for virtual markers and/or markings, e.g., positions on the inspection surface 440000 viewable via augmented reality and/or otherwise non-physical digital object viewable to the inspection robot 440018 and/or an operator of the inspection robot.

As illustrated in FIG. 21, embodiments of the current disclosure may provide for the stitching together of regions 450010 and 450012 of inspection surface data. For example, region 450010 may have been gathered during a first inspection run by an inspection robot, where the first inspection run was cut short due to inclement weather, and region 450012 may have been gathered by the inspection robot during a second inspection run after the inclement weather cleared. Controllers 430020, servers 430026, 430026 (FIG. 19), and/or any other computing device described herein may take the inspection surface data for both regions 450010 and 450012, which may have been separately generated/gathered, e.g., as shown by arrow 450014, and generate a data object, e.g., mapping 430038 (FIG. 19) that logically relates the portions of region 450012 to the bordering portions of region 450010 so that the inspection surface data of both regions 450010 and 450012 can be viewed as a continuous, or near continuous, whole, e.g., as shown by arrow 450016.

For example, in embodiments, elements of the inspection surface data may be paired with corresponding determined positional data in an array-like structure, where elements in the inspection data of different regions having determined positions that exceed a threshold, e.g., within a min-distance, can be aligned when displayed so as to give the appearance of the different regions being cohesive. In embodiments, elements of the inspection data of different regions may be stored in an array-like structure where elements of the data of the different regions that exceed the threshold are stored in proximity to each other, which may provide for a condensed manner in which to store the inspection surface data from multiple regions in a single data structure along with their relational aspects.

As will be understood, embodiments of the current disclosure may stitch regions together that were generated by the same inspection robots, different inspection robots, at the same time, and/or at different times. Embodiments of the current disclosure may also provide for the stitching together of regions of different inspection surfaces of the same or different structures. For example, embodiments may stitch together a first region with a second region, where the first region was generated by a first inspection robot inspecting a storage tank sidewall, and where the second region was generated a year later by a second inspection robot inspecting a top wall of the storge tank.

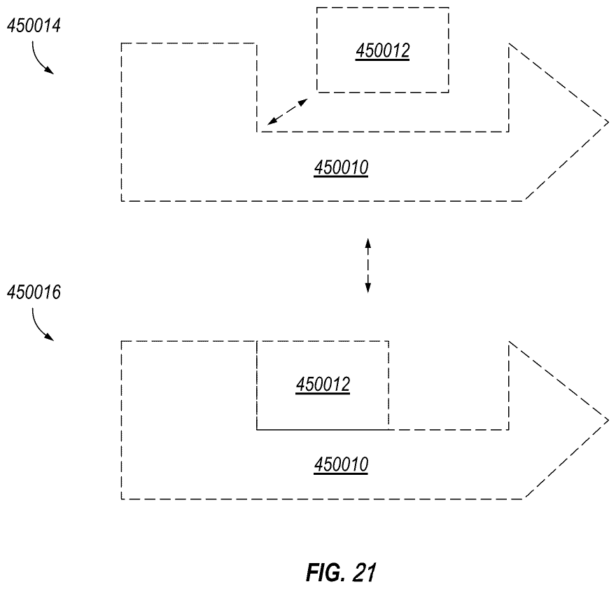

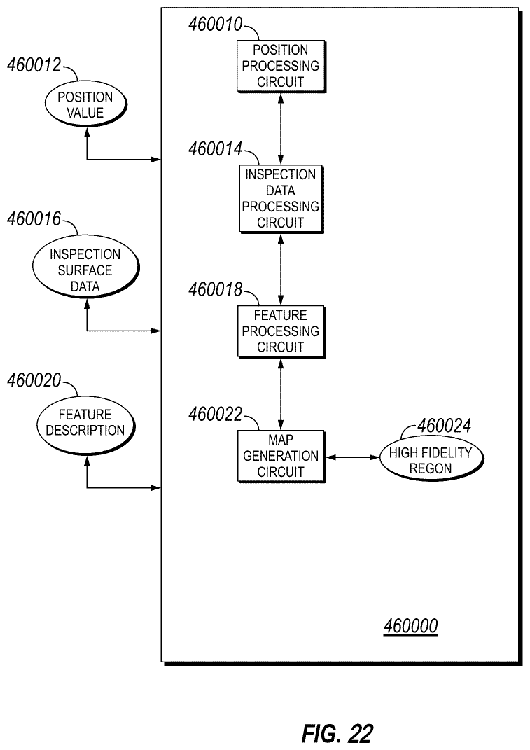

Illustrated in FIG. 22 is an apparatus 460000 for generating high-fidelity regions for an inspection surface, in accordance with embodiments of the current disclosure. The apparatus 460000 may form part of the controller 430020 (FIG. 19), the servers 430026 (FIG. 19), device 430046 (FIG. 19), workstation 430048 (FIG. 19), and/or any other computing device disclosed herein. The apparatus 460000 includes a position processing circuit 460010 structured to interpret a position value 460012, and/or an inspection data processing circuit 460014 structured to interpret inspection surface data 460016. The position value 460012 may be raw position sensor data, a coordinate calculated from raw position sensor data, and/or any other type of data that conveys where the inspection surface data 460016 is believed to have been collected from on the inspection surface.

The apparatus 460000 further includes a feature processing circuit 460018 structured to interpret a feature description 460020 corresponding to a feature, e.g., seem line 440036 (FIG. 20), related to an inspection surface, e.g., 440000 (FIG. 20). Non-limiting examples of features related to an inspection surface include features that are part of and/or near the inspection surface, e.g., features of the surface and/or object being inspected and/or an object adjacent to the surface and/or object being inspected that can be used to localize the inspection robot. Non-limiting examples of feature descriptions include data indicating a type, size, location, and/or other characteristics of a feature, e.g., a crack, pipe, hatch, door, antenna, building, wall, etc. In embodiments, a feature description may use XML, and/or other similar markup-languages, to label the data defining a feature. In embodiments, the feature description 460020 may be generated from data gathered from sensors on the inspection robot and/or from data entered by an operator of the inspection robot and/or an entity or individual otherwise associated with the inspection surface, e.g., the operator of a ship having its hull inspected.

The apparatus 460000 further includes a map generation circuit 460022 structured to generate a high-fidelity region 460024 of the inspection surface based at least in part on the position value 460012, the inspection surface data 460016, and the feature description 460020. In embodiments, the map generation circuit 460022 may generate instructions structured to cause the inspection robot to slow down while it inspects the high-fidelity region and/or to make multiple passes over the high-fidelity region so as to provide the position sensors and/or inspection surface sensors more time and/or additional “looks” to gather position data and/or inspection surface data to improve localization and/or resolution of the inspection surface data.

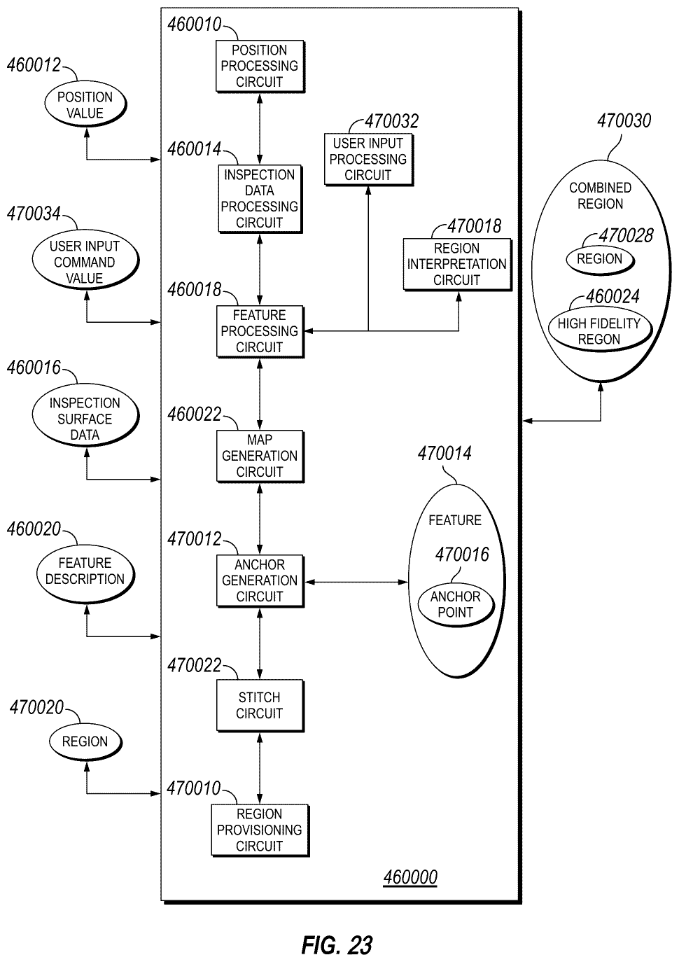

Moving to FIG. 23, in embodiments, the apparatus 460000 may further include a region provisioning circuit 470010 structured to transmit the high-fidelity region 460024. For example, in embodiments, the inspection robot 430012 (FIG. 19) may detect a crack 430036 (FIG. 19) and generate a high-fidelity region around the crack. The inspection robot 430012 (FIG. 19) may then transmit the high-fidelity region to the control device 430046 (FIG. 19) for confirmation of the high-fidelity region by an operator 430044 (FIG. 19). Upon confirmation, the inspection robot 430012 may then proceed to increase the accuracy of its determined positioning by proceeding more slowly as it inspects the crack 430036 to increase the amount of time the positioning sensors 430034 have to generate position values 460012. In embodiments, the inspection robot 430012 (FIG. 19) may also improve its positioning by make additional passes though the high-fidelity region, which may provide for the positioning sensors 430034 (FIG. 19) to gather additional data and make more accurate positioning determinations.

In embodiments, the apparatus 460000 may include an anchor circuit 470012 structured to analyze the feature description 460020 to identify the feature 470014, and responsive to identifying the feature 470014, determine that the feature 470014 is as an anchor point 470016, e.g., a feature that is readily identifiable/discernable with a high level of confidence with respect to its spatial relationship with the inspection surface, the high-fidelity region, a region to be stitched with the high-fidelity region, the structure that includes the inspection surface, etc. In such embodiments, the map generation circuit 460022 is further structured to generate the high-fidelity region 460024 based at least in part on the anchor point 470016. In embodiments, an anchor point 470016 may be a feature that is discernable with a high level of confidence, e.g., a flange that marks an upper boundary of a side wall of a storage tank or a hawsehole on the bow of a ship's hull.

In embodiments, the apparatus 460000 may include a region interpretation circuit 470018 structured to interpret a region 470020 of inspection surface data corresponding to a structure that comprises the inspection surface; and/or a stich circuit 470022 structured to stitch, based at least in part on the anchor point 470016, the high-fidelity region 460024 to the region 470020. The region provisioning circuit 470010 may be structured to transmit a combined region 470030 that includes the high-fidelity region 460024 stitched with the region 470020.

In embodiments, the apparatus 460000 may include a position sensor, e.g., 430034 (FIG. 19) that generates the position value 460012. Embodiments, the position sensor 430034 may be an inertial measurement unit (IMU). For example, in certain embodiments, the apparatus 460000 may form part of the inspection robot, which may have the advantage of reducing the amount of time it takes to generate the high-fidelity regions and complete the inspection run by keeping the processing localized to the inspection robot, as opposed to having to transmit the inspection surface data and the positioning data off the inspection robot to a server for processing. It should be understood, however, that in certain instances, e.g., using a small inspection robot with limited processing capabilities to inspect small/cramped structures, it may be advantageous to transmit the inspection surface data and positioning data off the inspection robot to a server to identify the high-fidelity regions and generate instructions for the inspection robot to obtain the required data.

In embodiments, the apparatus 460000 may be structured to generate a plurality of high-fidelity regions and include a user input processing circuit 470032 structured to interpret a user input command value 470034 and select one of the plurality of high-fidelity regions for transmission via the region provisioning circuit 470010. In embodiments, the user input command value may correspond to a type of analysis of a structure that comprises the inspection surface. For example, an operator 430044 (FIG. 19) may be viewing past inspection data via the control device 430046 (or any other computing device disclosed herein) for a structure, e.g., a ship hull, where the past inspection data indicates possible structural damage to a particular area of the ship hull. The user may then draw a region around the possible damage to indicate that drawn region should be reinspected with a high-fidelity process. In embodiments, the operator 430044 (FIG. 19) may indicate that the region should be scanned with a particular resolution, depth, etc., and/or with a particular methodology, e.g., horizontal passes, vertical passes, diagonal passes, etc.

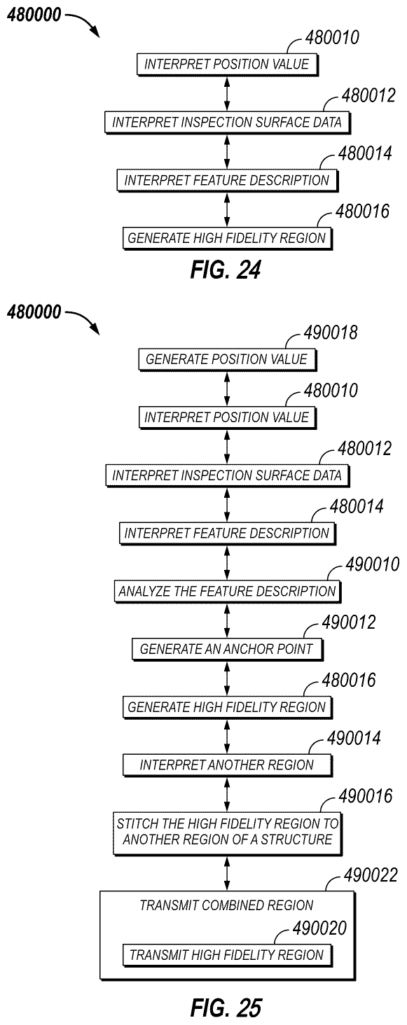

Turning to FIG. 24, a method 480000 for generating high-fidelity regions for an inspection surface is shown, in accordance with embodiments of the current disclosure. The method 480000 may be performed by the apparatus 460000 (FIG. 22) and/or any other computing device disclosed herein. The method 480000 includes interpreting 480010 a position value 460012 (FIG. 22), interpreting 480012 inspection surface data 460016 (FIG. 22); and interpreting 480014 a feature description 460020 (FIG. 22) corresponding to a feature related to the inspection surface; and generating 480016 a high-fidelity region 460024 (FIG. 22) of the inspection surface based at least in part on the position value 460012, the inspection surface data 460016, and the feature description 460020.

Referring to FIG. 25, in embodiments, the method 480000 may further include analyzing 490010 the feature description 460020 (FIG. 22), and responsive to analyzing 490010 the feature description, generating 490012 an anchor point 470016 (FIG. 23). In such embodiments, generating 480016 the high-fidelity region 460024 may be based at least in part on the anchor point 470016 (FIG. 23).

In embodiments, the method 480000 may include interpreting 490014 another region 470020 (FIG. 23) and/or stitching 490016, based at least in part on the anchor point 470016, the high-fidelity region 460024 to the region 470020 of a structure that comprises the inspection surface.

The method 480000 may include generating 490018 the position value 460012.

The method 480000 may include transmitting 490020 the high-fidelity region 460024 and/or transmitting 490022 the combined region 470030 (FIG. 23) of the high-fidelity region 460024 stitched to the region 470028.

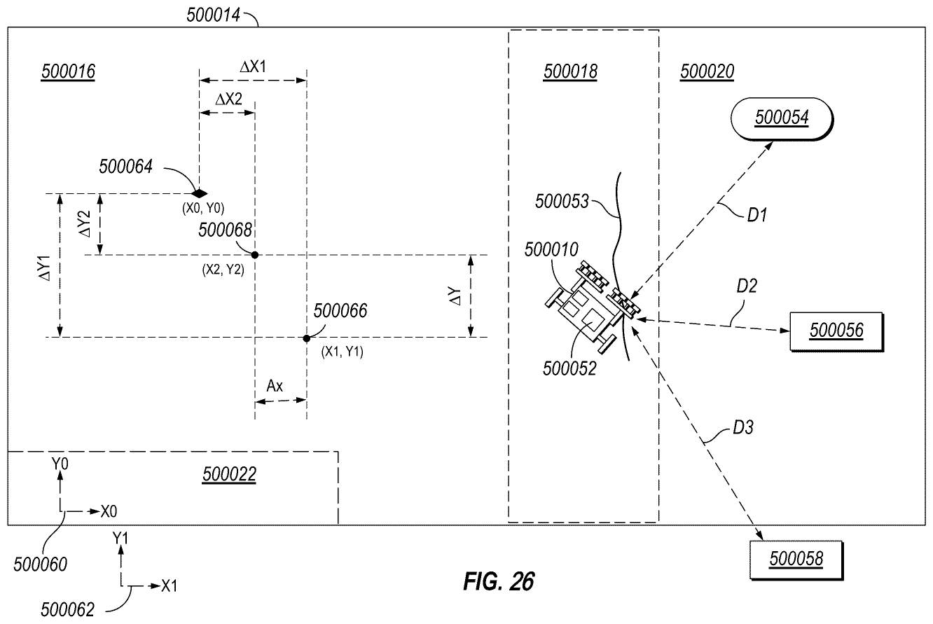

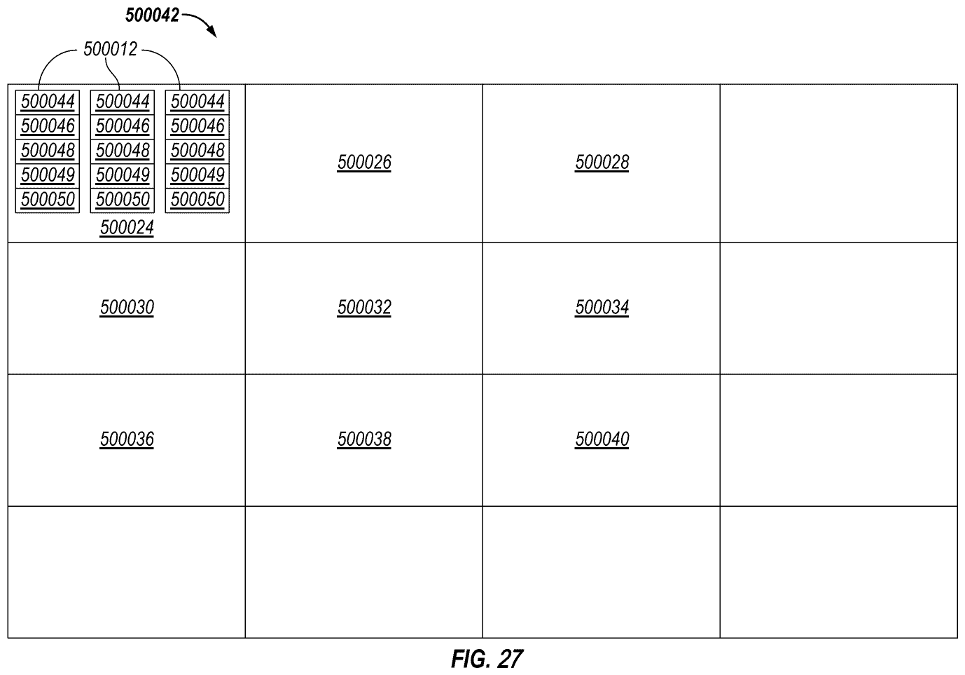

Referring to FIGS. 26 and 27, as stated herein, embodiments of the current disclosure provide for bulk data optimization for inspection surface data. For example, an inspection robot 500010 may generate inspection surface data 500012 for an inspection surface 500014 having multiple regions 500016, 500018, 500020, 500022 where the inspection surface data 500012 may be arranged in data blocks/data structures 500024, 500026, 500028, 500030, 500032, 500034, 500036, 500038, 500040 (and/or other similar storge structure) corresponding to inspection surface regions. Data blocks 5000024, 500028, 500032, and 500036 may correspond to regions 500016, 500018, 500020, and 500022, respectively.

As will be understood, the data blocks 5000024, 500026, 500028, 500030, 500032, 500034, 500036, 500038, 500040 may form part of one or more mappings 500042 (see also 430038 in FIG. 19) which may contain data blocks for regions of different inspection surfaces and/or different structures. For example, data blocks 5000024, 500028, 500032, and 500036 may correspond to four (4) discernable regions of the floor of a rectangular store tank where data blocks 5000030, 500034 may correspond to the top and bottom, respectively, of the same storage tank, while data blocks 5000038 and 500040 may correspond to sidewalls of a different storge tank associated with the rectangular storage tank.

As described in greater detail herein, embodiments of the current disclosure may provide for an operator 430044 (FIG. 19) to select, via a graphical user interface provided on the control device 430046 (FIG. 19), workstation 430048 (FIG. 19) and/or any other computing device disclosed herein, one or more structures and/or regions for display, evaluation, adjustment, and/or any other type of manipulation and/or transfer of the inspection surface data 5000012, where embodiments of the current disclosure utilize the data blocks within a mapping to retrieve and/or otherwise provide for interaction with the underlying inspection surface data 500012. In embodiments, the graphical user interface may also provide for the operator 430044 to specify which portions/data blocks of the inspection surface data 5000012 should be associated with a particular structure, inspection surface, and/or region. For example, the GUI may present the operator 430044 with a map of a facility having multiple structures, where a high level/abstracted view of the inspection surface data may be shown in association with the structures, e.g., storage tanks having recent and complete scans of their inspection surfaces may be shown in green, storge tanks with slightly stale and/or small portions of missing inspection surface data may be shown in orange, and/or storage tanks having significant structural issues, very stale and/or high portions of missing inspection surface data may be shown in red. The operator 430044 may then click on a particular storge tank to view the tank in more detail, e.g., individual inspection surfaces may be shown with a similar color scheme as the structures. The operator 430044 may then click a particular inspection surface to view individual regions of the inspection surface which may be shown in a similar color scheme as the structures. Clicking on a particular region within the inspection surface may provide for the operator 430044 to view the underlying inspection surface data at a high level, e.g., a raw data view.

Embodiments of the GUI may also provide for the operator 430044 to define regions, inspection surfaces, and/or structures and/or assign data blocks in the mappings 5000042 to the defined regions, inspection surfaces, and/or structures. For example, an operator 430044, prior to performing an inspection of a facility having multiple structures, may use the GUI to define known structures of the facility and their corresponding inspection surfaces and/or regions, where inspection surface data is placed into the corresponding data blocks during and/or after the inspection.

In embodiments, the inspection surface data 500012 may include raw and/processed sensor values 500044 paired and/or otherwise associated with inspection surface position values 500046, observation data 500048, and/or other types of localized data 500050, e.g., time stamps, temperatures, surface condition descriptions, etc. In embodiments, the data stored/paired to the inspection surface data values 500044 may be used to improve the accuracy of localizing/mapping the inspection surface data 500012 to the inspection surface 500014.

An inspection robot 500010 inspecting the inspection surface 500014 may include one or more observation sensors 500052 structured to obtain observation data 500048 by sensing one or more features 500054, 500056, 500058. Non-limiting examples of observation sensors 500052 include optical cameras, infrared cameras, UV cameras, laser range finders (including LIDARs), SONARs, ultrasound sensors, pressure sensors, temperature sensors, RADARs, GPS sensors, and/or any other type of environmental condition and/or position sensor. The observation data 500048 may be used to correct and/or adjust the inspection surface position values 500046 so that they more closely align with the true positions of where the inspection surface data 500044 was generated/collected from the inspection surface 500014.

For example, the origin 500060 represents the true origin of the inspection surface 500014 and the origin 500062 represents the determined origin, e.g., what the inspection robot 500010 believe to be the true origin 500060 at any given moment during an inspection run. The inspection robot may obtain a set of inspection surface data G for true point 500064 having true coordinates (X0, Y0) with respect to the true origin 500060. Due to a variety of reasons, the inspection robot 500010 may believe that the inspection surface data G was generated/collected at determined point 500066 having coordinates (X1, Y1) with respect to the determined origin 500062. The inspection robot 500010 may have collected observation data 500048 while inspecting the inspection surface 500014, where the observation data 500048 can be used to determine the exact and/or approximate position of the inspection robot 500010 to the true origin 500060. For example, the inspection robot 500010 may observe that it is at distances D1, D2, and D3 from a hill 500054, a raised wall 500056, and a building 500058, respectively, where the relationship between these distances and true positions may be known and/or discernable.

Embodiments of the current disclosure may use the observation data 500048 to generate an adjustment A (which may include separate dimensions, e.g., Ax, Ay, and/or Az) to the determined point 500066, resulting in adjusted determined point 500068 having coordinates (X2, Y2) with respect to the determined origin 500062, where adjusted determined point 500068 more closely aligns with the true point 500064 as compared to determined point 500066. In other words, ΔX2 (the difference between X0 and X2) and/or ΔY2 (the difference between Y0 and Y2) are respectively less than (in absolute terms) ΔX1 (the difference between X0 and X1) and ΔY1 (the difference between Y0 and Y1).

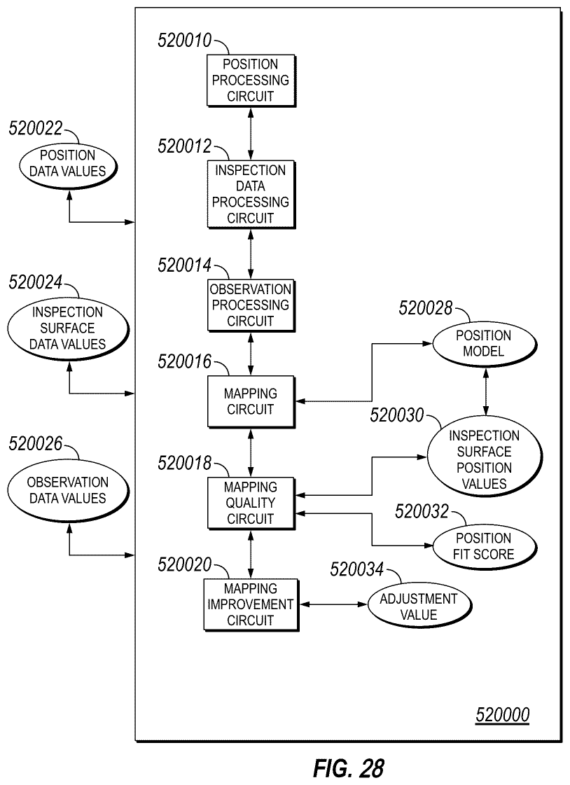

FIG. 28 depicts an apparatus 520000 for localizing inspection surface data values using observation data values, in accordance with embodiments of the current disclosure. The apparatus 520000 may form part of the one or more inspection robot controllers 430020 (FIG. 19), the servers 430026, the control unit 430046 (FIG. 19), the workstation 430048 (FIG. 19) and/or any other computing device disclosed herein. The apparatus 520000 includes a position processing circuit 520010, an inspection data processing circuit 520012, an observation data processing circuit 520014, a mapping circuit 520016, a mapping quality circuit 520018, and/or a mapping improvement circuit 520020. The position processing circuit 520010 is structured to interpret a plurality of position data values 520022, which may have been determined by the inspection robot via one or more position sensors, e.g., inertial measurement units (IMUs), encoders, laser range finders, GPS, and/or any other type of position sensor. The inspection data processing circuit 520012 is structured to interpret inspection surface data values 520024 corresponding to an inspection surface, e.g., 500014 (FIG. 26). The observation processing circuit 520014 is structured to interpret observation data values 520026. Non-limiting examples of observation data values 520026 include data corresponding and/or otherwise describing the locations and/or other characteristics (size, type, composition, distance from inspection robot, distance from another feature, etc.) of: inspection surface features, e.g., cracks, flanges, stairwells, openings, hatches, doors, corners, gradients, texture, temperature, etc.; and external features, e.g., buildings, trees, antennas, towers, tanks, the sun, moon, stars, etc. The mapping circuit 520016 is structured to operate a position model 520028 to determine, in response to the plurality of position data values 520022, an inspection surface position value 520030 for each of the inspection surface data values 520022.

In embodiments, the position model 520028 may be based on weighting one or more factors, e.g., IMU data, encoder data, determined locations of features, that are applicable to determining the inspection robot's position at a particular time and/or at a particular inspection surface data reading. For example, IMU data corresponding to a given inspection surface reading/data R may indicate the inspection robot was at location X1 when it generated the inspection surface data R, but triangulation based on the distances of the inspection robot to three features may indicate the inspection robot was at location X2 when it generated inspection data R and that the IMU may be drifting. The position model 520028 may weigh the triangulation determined position stronger/higher than the IMU's determined position if the observation sensors that generated the observation data are known to be accurate, e.g., the setting of the weights in the position model 520028 may be a configuration option set by the operator 430044 (FIG. 19) based on the known configuration of the inspection robot's sensors. In embodiments, the position model 520028 may have access to the inspection robot's sensor configuration and set the weights accordingly. In embodiments, the position model 520028 may use a weighted average of one or more determined positions, e.g., a weighted position determined from IMU data, averaged with a weighted position determined from one or more features.

The mapping quality circuit 520018 is structured to determine a position fit score 520032 based at least in part on the observation data values 520026 and the inspection surface position values 520030. In embodiments, the position fit score 520032 may indicate a degree/level/measure of how much the position of one or more features drift within a mapping, e.g., how much variance there is in the determined position of a feature within the data contained in a mapping. The mapping improvement circuit 520020 is structured to generate an adjustment value 520034 configured to adjust the position model 520028 in response to the position fit score 520032. In embodiments, the adjustment value 520034 may be a constant offset, a variable offset (to include a parameterized value), a series of offsets, etc. The position fit score 520032 may be a numerical value, an alphanumeric value, an enumerated type, e.g., “good”, “OK”, “Bad”, a percentage, and/or any other type of data value that conveys a degree of how accurately the determined positions align with known true positions and/or other benchmark position values.

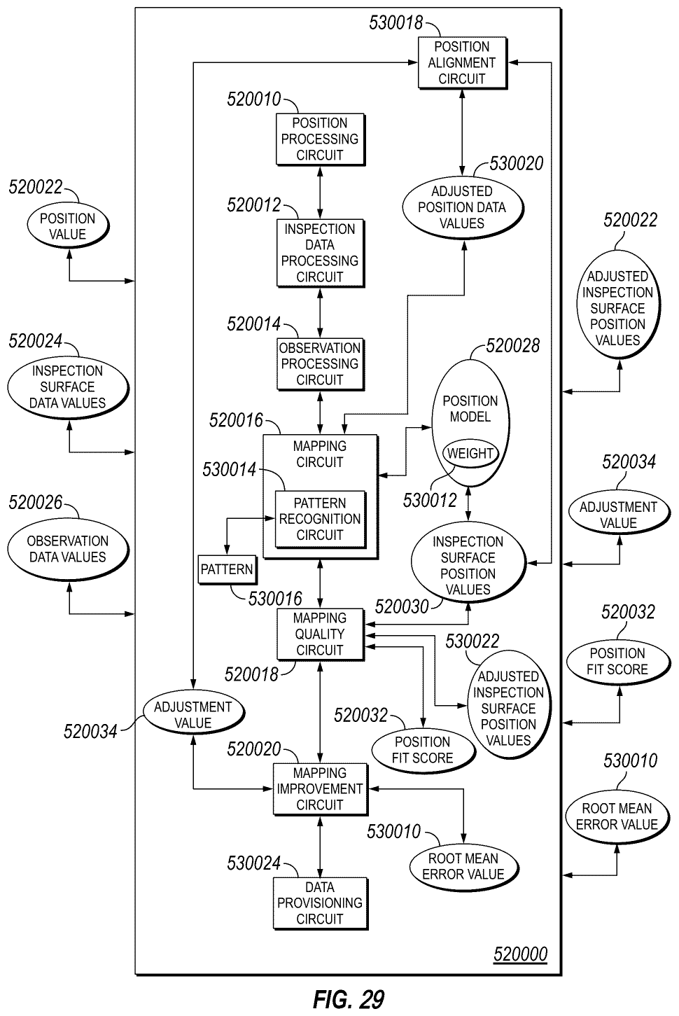

Turning to FIG. 29, in embodiments, the mapping improvement circuit 520020 is further structured to: determine a root mean square error value 530010 between the plurality of position data values 520022 and the observation data values 520026; and configure the adjustment value 520026 based at least in part on the root mean square error value 530010. The mapping improvement circuit 520020 may be further structured to configure the adjustment value 520034 to reduce the root mean square error value 530010. The mapping improvement circuit 520020 may be further structured to configure the adjustment value 520034 to adjust a weight 530012 of the position model 520028. In embodiments, the weight 530012 may correspond to the plurality of position data values 520022. In embodiments, the values of the weights 530012 may be based at least in part on confidences associated with sensors and/or other sources of position data, e.g., the more confident/reliable a position data source, the higher the associated weight assigned to the corresponding position data.

In embodiments, the observation data values 520026 may correspond to a position of a feature, e.g., 500054 and/or 50056 (FIG. 26) of the inspection surface 500014 (FIG. 26). In embodiments, the observation data values 520026 may each correspond to a geometry of at least one of: the inspection surface 500014 (FIG. 26); or a structure, e.g., 500054 and/or 50056 (FIG. 26), that includes the inspection surface 500014 (FIG. 26). Non-limiting examples of such geometries include corners, gradients, walls, etc. In embodiments, the observation data values 520026 may be based at least in part on temperature sensor data. For example, the location of an inspection robot may be determined based on the surrounding environmental and/or inspection surface temperature, e.g., an inspection robot inspecting a partially shaded roof of a storage tank may detect a pattern, e.g., a gradient, that corresponds to the shape of the inspection surface, e.g., one half of the tank in the sun may be warmer than the other half of the tank which may be shaded. In embodiments, the observation data values 520026 may be based at least in part on contact encoder data. In embodiments, the observation data values 520026 may be based at least in part on a direct distance value, e.g., light detection and ranging (LIDAR) data; laser range data; Sound Navigation Ranging (SONAR) data; and/or imaging data. In embodiments, the observation data values 520026 may be based at least in part on camera data. In embodiments, the observation data values 520026 may be based at least in part on prior inspection data corresponding to the inspection surface 500014 (FIG. 26).

In embodiments, the mapping circuit 520016 may include a pattern recognition circuit 530014 structured to identify a pattern 530016 in the inspection surface data values 520024. In such embodiments, the mapping circuit 520016 may be further structured to generate the inspection surface position values 520030 based at least in part on the pattern 530016. Non-limiting examples of patterns 530016 include known data signatures, trends, thresholds, and the like. The pattern 530016 may be based at least in part on the inspection surface data values 520024, e.g., a gradient of the inspection surface data values 520024.

The apparatus 520000 may include a position alignment circuit 530018 structured to adjust the plurality of position data values 520022 based at least in part on the inspection surface data values 520024 to generate adjusted position data values 530020. In such embodiments, the mapping circuit 520016 may be structured to adjust the inspection surface data values 520024 based at least in part on the adjusted plurality of position data values 530020 to generate adjusted inspection surface position values 530022.

The apparatus 520000 may include a data provisioning circuit 530024 structured to transmit the adjusted inspection surface position values 530022, the adjustment value(s) 520034, the position fit score 520032, and/or the root mean error value 530010. Such transmission may be to the control device/console 430046 (FIG. 19), the servers 430026 (FIG. 19), the workstation 430048 (FIG. 19) and/or any other computing device disclosed herein.

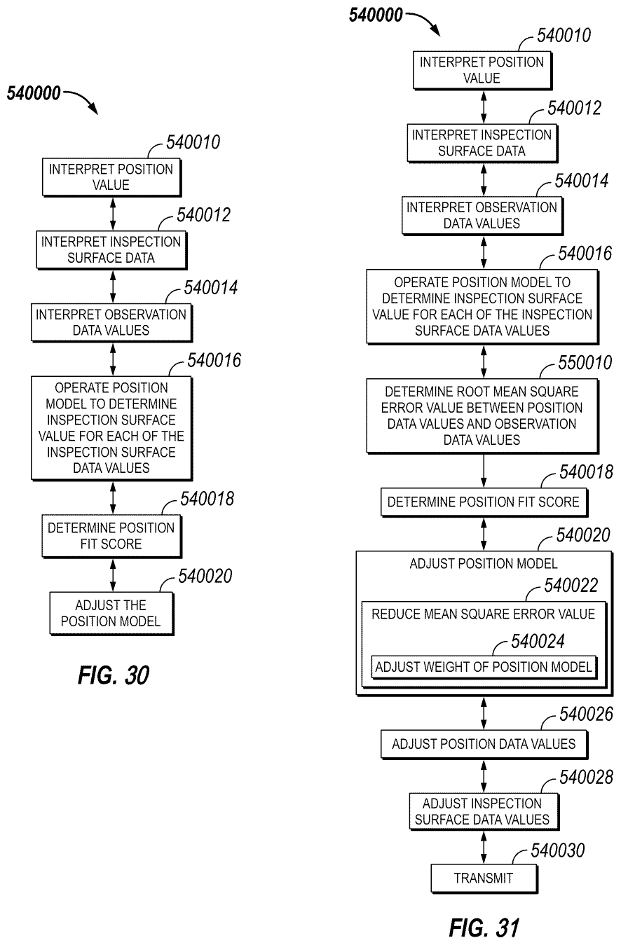

Illustrated in FIG. 30 is a method 540000 for localizing inspection surface data values using observation data values, in accordance with embodiments of the current disclosure. The method 540000 may be performed via apparatus 520000 (FIG. 28) and/or any other computing device disclosed herein. The method 540000 includes: interpreting 540010 a plurality of position data values 520022 (FIG. 28), interpreting 540012 inspection surface data values 520024 (FIG. 28); and/or interpreting 540014 observation data values 520026 (FIG. 28).

The method 540000 further includes: operating 540016 a position model 520028 (FIG. 28) to determine, in response to the plurality of position data values 520022, an inspection surface position value 520030 for each of the inspection surface data values 520024; determining 540018 a position fit score 520032 (FIG. 28) based at least in part on the observation data values 520026 (FIG. 28), and the inspection surface position values 520030 (FIG. 28); and/or adjusting 540020 the position model 520028 (FIG. 28) in response to the position fit score 520032 (FIG. 28).

As shown in FIG. 31, in embodiments, the method 540000 may further include: determining 550010 a root mean square error value 530010 (FIG. 29) between the plurality of position data values 520022 (FIG. 29) and the observation data values 520026 (FIG. 29); and adjusting 540020 the position model 520028 (FIG. 29) based at least in part on the root mean square error value 530010 (FIG. 29). In embodiments, adjusting 540020 the position model 520028 (FIG. 29) may include reducing 540022 the root mean square error value 530010 (FIG. 29). In embodiments, adjusting 540020 the position model 520028 (FIG. 29) in response to the position fit score 520032 (FIG. 29) may include adjusting 540024 a weight 530012 (FIG. 29) of the position model 520028 (FIG. 29). In embodiments, the weight 530012 (FIG. 29) corresponds to the plurality of position data values 520022 (FIG. 29).

In embodiment, the method 540000 may include adjusting 540026 the plurality of position data values 520022 (FIG. 29) to generate adjusted position data values 530020 (FIG. 29) based at least in part on the inspection surface data values 520024 (FIG. 29). The method 540000 may include adjusting 540028 the inspection surface data values 520024 (FIG. 29) based at least in part on the adjusted plurality of position data values 530020 (FIG. 29) to generate adjusted inspection surface position values 530022 (FIG. 29). The method 540000 may further include transmitting 540030 the adjusted inspection surface position values 530022 (FIG. 29), the adjustment value 520034 (FIG. 29), the position fit score 520032 (FIG. 29), and/or the root mean error value 530010 (FIG. 29).

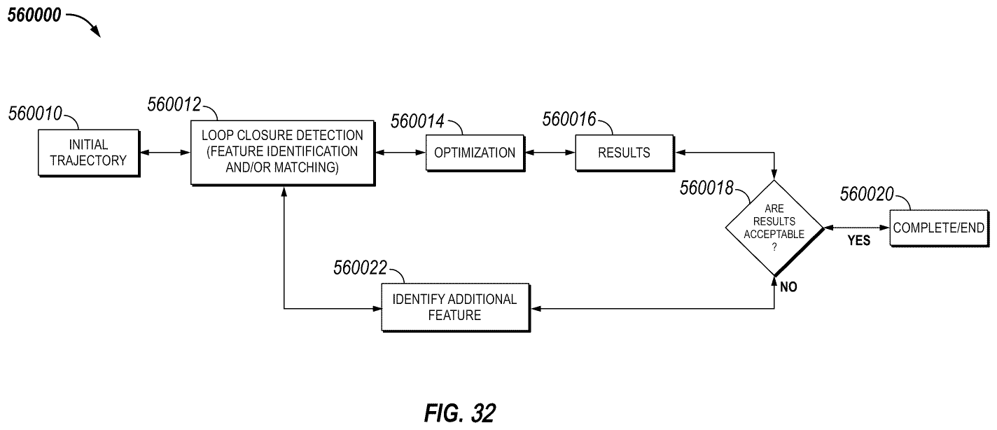

Referring to FIG. 32, embodiments of the current disclosure may use feature loop closure detection to condition trajectory data (and/or including position data) in a mapping of inspection surface data. An example operation to utilize feature loop closure detection includes determining an error value in response to a location determination about a feature, for example if a feature is a particular point on the surface (e.g., a bolt identified as a feature), then the error term would be based on movement of the bolt in the data. In a further example, determinations of the inspection position are based on a number of parameters, for example weighted contributions of different position sensors and/or position algorithms, resetting of dead reckoning offsets, correction for drift, or the like, where the stationary feature should continue to be in the same position, and the overall movement of the feature in the data is utilized as an error term (e.g., as the stationary feature did not move, so the movement is an artefact of the position determination) for the feature loop closure detection. In certain embodiments, any known position information may be utilized to generate the error term for the feature loop closure detection—for example based on the linearity of a known linear feature (e.g., a weld line, row of bolts, tank seam, etc.), and/or based on the known shape of a feature (e.g., the circularity of a known circular feature). In certain embodiments, other location based aspects may be utilized to generate the error term—for example adjusting the position determination such that WiFi signal strength to a known WiFi device (e.g., a router at a known position) matches the observed WiFi signal strength. In certain embodiments, more than one error value may be combined, for example in a weighted manner, to minimize an overall error index considering more than one feature for the feature loop closure detection.

In a non-limiting method 560000, initial trajectory data may be collected and/or interpreted (represented by box 560010). The trajectory data may include determined position data, e.g., encoder and/or IMU data, mapped to inspection surface data and/or feature data, e.g., data describing characteristics, e.g., sensed location and/or distance from the inspection robot, true location, size, shape, etc., of a feature. For example, an inspection robot may detect the presence/position/location of a feature as being at determined location F1 when the inspection robot is at determined position R1, and then detect the same feature as having a determined location of F2 when the inspection robot is at determined location R2. While F1 should equal F2, in theory, in reality, the inspection robot's position sensors, e.g., IMU and/or encoder, will experience drift, thus, F1 and F2 will, typically, vary from each other, e.g., the feature has a trajectory drift with respect to the trajectory data. As will be understood, the trajectory drift may occur over many determined positions ‘n’, e.g., F1-Fn and R1-Rn.

The method 560000 may include determining a feature, e.g., from the trajectory data (represented by box 560012), which is then applied to an optimization process (represented by box 560014) that seeks to constrain a trajectory drift of the feature by adjusting the determined position values of either the inspection surface data, the inspection robot, and/or the feature. The results, e.g., the modified trajectory data, may then be analyzed (either manually or automatically, e.g., without direct human involvement (as represented by box 560016) and then tested against an acceptability threshold (represented by box 560018). For example, the results may be condensed into an error value, e.g., a maximum variance and/or drift of the feature within the modified trajectory data which is tested against an allowable threshold, e.g., a maximum allowable trajectory drift. If the threshold is satisfied, then the method completes/ends (represented by box 560020). If the threshold is crossed/exceeded, an additional feature is identified (represented by blocks 560022 and 560012) and the optimization process (box 560014) and results (box 560016) sub-processes are performed again using the new feature and/or a combination of the new feature with the prior feature.

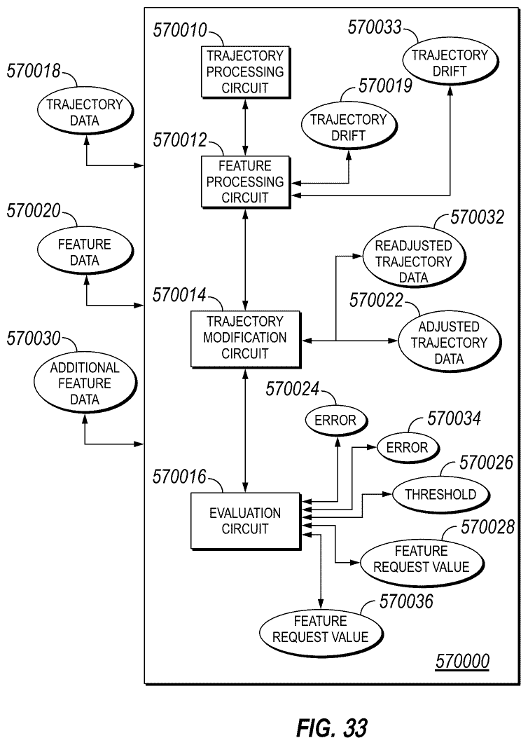

Illustrated in FIG. 33 is an apparatus 570000 for conditioning trajectory data using feature loop closure detection, in accordance with an embodiment of the current disclosure. The apparatus 570000 may form part of the controllers 430020 (FIG. 19), the servers 430026 (FIG. 19), the workstation 430048 (FIG. 19), the control device 430046 (FIG. 19), and/or any other computing device disclosed herein. The apparatus 570000 includes a trajectory processing circuit 570010, a feature processing circuit 570012, a trajectory modification circuit 570014, and an evaluation circuit 570016. The trajectory processing circuit 570010 is structured to interpret trajectory data 570018 generated by an inspection robot 500010 (FIG. 50) inspecting an inspection surface 500014 (FIG. 26). The feature processing circuit 570012 is structured to interpret feature data 570020 corresponding to a feature, e.g., a crack 500053 a raised wall 500054 (FIG. 26), a building 500058 (FIG. 26), etc., associated with the inspection surface 500014. The trajectory modification circuit 570014 is structured to adjust the trajectory data 570018, e.g., adjusted trajectory data 570022, to constrain a trajectory drift 570019 of the feature data 570020 with respect to the trajectory data 570018. The evaluation circuit 570016 is structured to: determine an error 570024 of the adjusted trajectory data 570022; and if the error 570024 of the adjusted trajectory data 570022 exceeds a threshold 570026, generate a feature request value 570028.

In response to the feature request value 570028: the feature processing circuit 570012 interprets additional feature data 570030 corresponding to an additional feature associated with the inspection surface 500014; the trajectory modification circuit 570014 readjusts the trajectory data, e.g., readjusted trajectory data 570032, to constrain a trajectory drift 570033 of the additional feature data 570030 with respect to the readjusted trajectory data 570032; and the evaluation circuit 570016 determines an error 570034 of the readjusted trajectory data 570032. If the error 570034 of the readjusted trajectory data 570032 exceeds the threshold 570026, the evaluation circuit 570016 generates another feature request value 570036, and the foregoing process repeats until the threshold 570026 is satisfied.

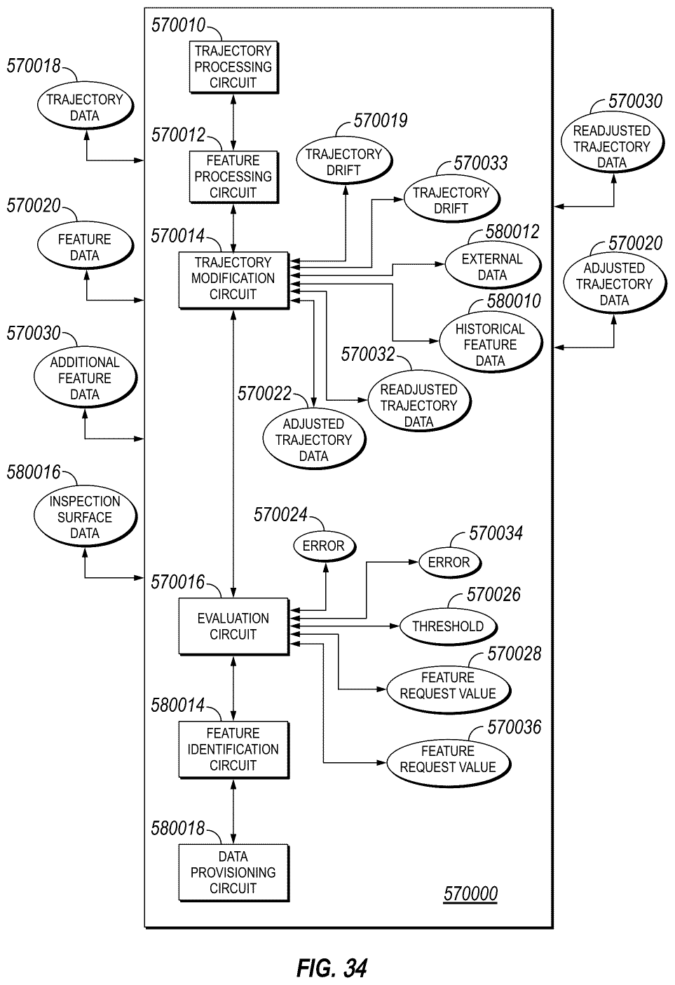

Turning to FIG. 34, in embodiments, the trajectory modification circuit 570014 adjusts the trajectory data 570018, adjusted trajectory data 570022, and/or readjusted trajectory data 570032 based at least in part on historical feature data 580010 and/or external data 580012.

The apparatus 570000 may include a feature identification circuit 580014 structured to interpret inspection surface data 580016 and, in response, generate the feature data 570020, and/or a data provisioning circuit 580018 structured to transmit the adjusted trajectory data 570020, the readjusted trajectory data 570030, and/or any further iterations thereof.

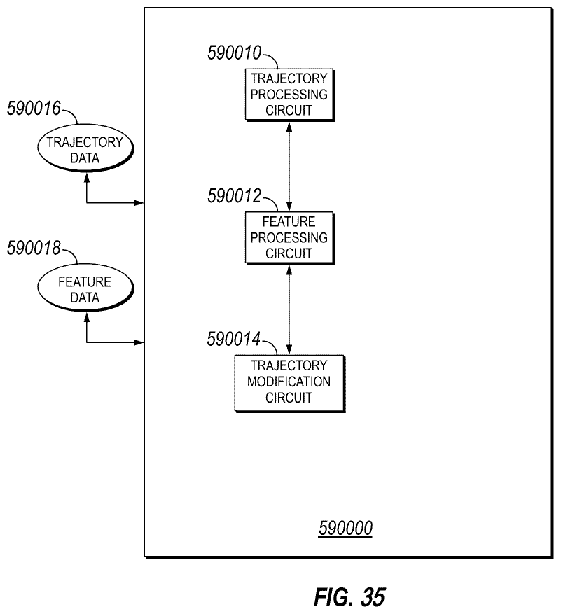

Illustrated in FIG. 35 is another apparatus 590000 for conditioning trajectory data using feature loop closure detection, in accordance with an embodiment of the current disclosure, includes a trajectory processing circuit 590010, a feature processing circuit 590012, and a trajectory modification circuit 590014. The trajectory processing circuit 590010 interprets trajectory data 590016 generated by an inspection robot 500010 (FIG. 26) inspecting an inspection surface 500014 (FIG. 26). The feature processing circuit 590012 interprets feature data 590018 corresponding to a feature, e.g., a crack 5000053 a raised wall 500054 (FIG. 26), a building 500058 (FIG. 26), etc., associated with the inspection surface 500014. The trajectory modification circuit 590014 adjusts the trajectory data 590016 via loop closure detection, as disclosed herein, to constrain a trajectory drift of the feature data 590018 to be within a threshold limit with respect to the trajectory data 590016.

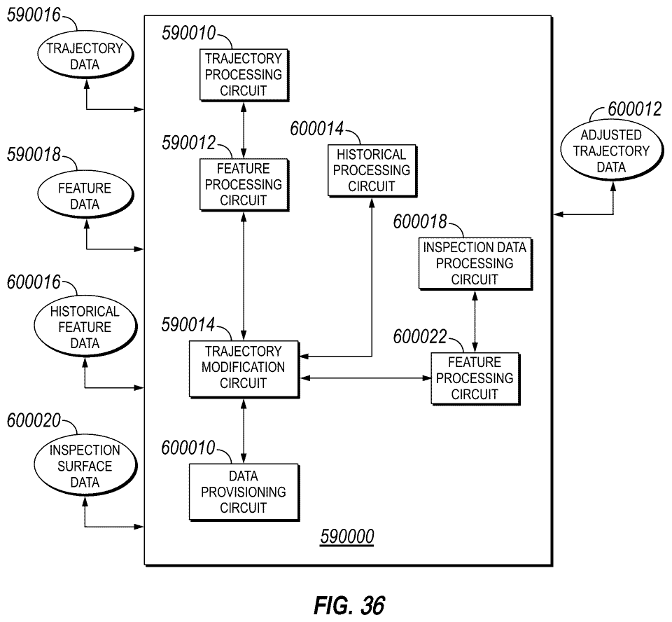

As shown in FIG. 36, in embodiments, the apparatus 590000 may include a data provisioning circuit 600010 structured to transmit the adjusted trajectory data 600012 and/or any other data generated by the apparatus 590000. The apparatus 590000 may include a historical data processing circuit 600014 that interprets historical feature data 600016 corresponding to the feature. In such embodiments, the trajectory modification circuit 5900014 adjusts the trajectory data 590016 based at least in part on the historical feature data 600016. The apparatus 590000 may include an inspection surface processing circuit 600018 that interprets inspection surface data 600020. The apparatus 590000 may include a feature identification circuit 600022 that interprets the inspection surface data 600020 and, in response, generates the feature data 590018.

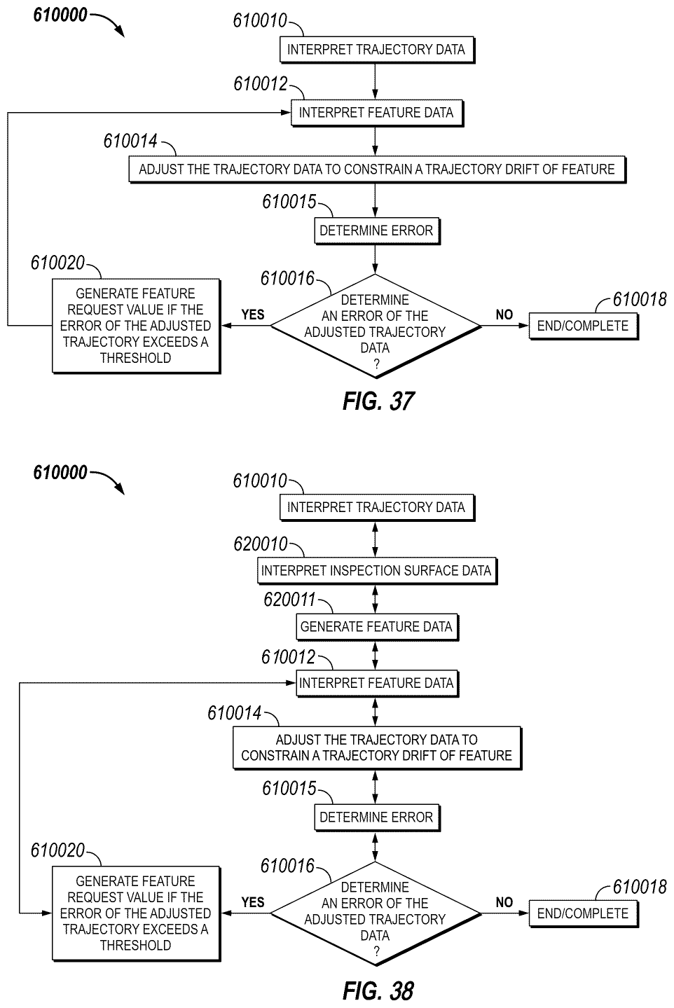

Referring to FIG. 37, a method 610000 for conditioning trajectory data using feature loop closure detection, in accordance with an embodiment of the current disclosure, is shown. The method 610000 may be performed via apparatus 570000 and/or any other computing device disclosed herein. The method 610000 includes interpreting 610010 trajectory data 570018 (FIG. 34) generated by an inspection robot 500010 (FIG. 26) inspecting an inspection surface 500014 (FIG. 26); interpreting 610012 feature data 570020 (FIG. 34) corresponding to a feature associated with the inspection surface 500014 (FIG. 26); and adjusting 610014 the trajectory data 570018 (FIG. 34) to constrain a trajectory drift 570019 (FIG. 34) of the feature data 570020 (FIG. 34) with respect to the trajectory data 570018 (FIG. 34).

The method 610000 further includes determining 6100015 an error 570024 (FIG. 34) of the adjusted trajectory data 570022 (FIG. 34), and determining 610016 whether the error 570024 exceeds a threshold 570026. If the error 570024 (FIG. 34) does not exceed the threshold 570026 (FIG. 34), then the method 610000 ends/completes 610018. If the error 570024 (FIG. 34) exceeds the threshold 570026 (FIG. 34), then a feature request value 570028 (FIG. 34) is generated 610020.

In response to the feature request value 570028 (FIG. 34), the method 610000 incudes: interpreting 610012 additional feature data 570030 (FIG. 34) corresponding to an additional feature associated with the inspection surface 500014 (FIG. 26); readjusting 610014 the trajectory data, e.g., adjusted trajectory data 570022 (FIG. 34) to constrain a trajectory drift 570033 (FIG. 34) of the additional feature data 570030 (FIG. 34) with respect to the trajectory data, e.g., adjusted trajectory data 570022 (FIG. 34); determining 610015 an error 570034 (FIG. 34) of the readjusted trajectory data 570032 (FIG. 34); and generating 610020 another feature request value 570036 (FIG. 34) if the error 570034 (FIG. 34) of the readjusted trajectory data 570032 (FIG. 34) exceeds the threshold 570026 (FIG. 34).

In embodiments, adjusting 610014 the trajectory data 570018 (FIG. 34) to constrain the trajectory drift 570019 (FIG. 34) of the feature data 570020 (FIG. 34) with respect to the trajectory data 570018 (FIG. 34) is based at least in part on historical data 580010 (FIG. 34) and/or external data 580012 (FIG. 34).

As shown in FIG. 38, in embodiments, the method 610000 includes interpreting 620010 inspection surface data 580016 (FIG. 34) and, in response, generating 620011 the feature data 570020 (FIG. 34).

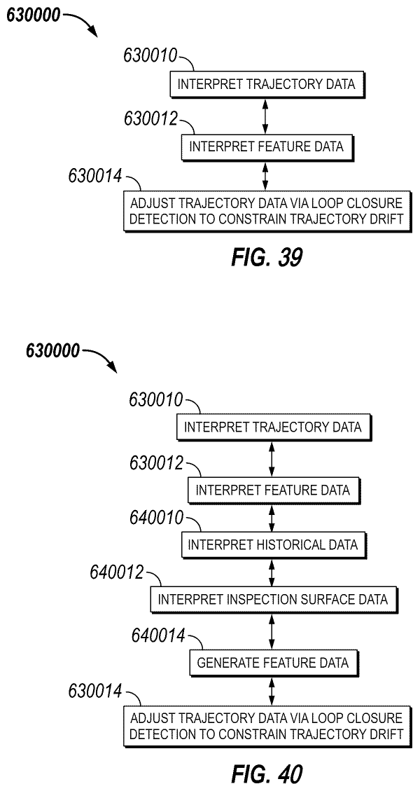

Referring to FIG. 39, another method 630000 for conditioning trajectory data using feature loop closure detection, in accordance with an embodiment of the current disclosure, is shown. The method 630000 may be performed via the apparatus 590000 and/or any other computing device disclosed herein. The method 630000 includes interpreting 630010 trajectory data 590016 (FIG. 36) generated by an inspection robot 500010 (FIG. 26) inspecting an inspection surface 500014 (FIG. 26); and interpreting 630012 feature data 590018 (FIG. 36) corresponding to a feature associated with the inspection surface 500014 (FIG. 26). The method 630000 further includes adjusting 630014 the trajectory data 590016 (FIG. 36), e.g., adjusted trajectory data 600012 (FIG. 36), via loop closure detection to constrain a trajectory drift of the feature data 590018 (FIG. 36) to within a threshold limit with respect to the trajectory data 590016 (FIG. 36).

As shown in FIG. 40, in embodiments, the method 630000 incudes interpreting 640010 historical feature data 600016 (FIG. 36) corresponding to the feature. In such embodiments, adjusting 630014 the trajectory data 590016 (FIG. 36) via loop closure detection is based at least in part on the historical feature data 600016 (FIG. 36). The method 630000 may include interpreting 640012 inspection surface data 600020 (FIG. 36); and in response, generating 640014 the feature data 590018 (FIG. 36).

Referring now to FIG. 41, an apparatus 650000 for inspection surface feature recognition/identification is shown in accordance with embodiments of the current disclosure. The apparatus 650000 may form part of the controller 430020, the servers 430026, the workstation 430048, the control device 430046, and/or any other computing device disclosed herein. As will be understood, embodiments of the current disclosure provide for the ability to consistently identify and/or recognize features and/or consistently read inspection surface data accurately across varying inspection surface conditions and/or environmental conditions. Non-limiting examples of inspection surface conditions (also referred to herein as surface conditions) include: changes in the presence, absence, and/or amount of a liquid, (e.g., wet vs. dry), dew, frost, sand, rust (and/or other types of corrosion), bubbling, dust, oil, coatings, paints, lubricants, damage, etc.; changes/transitions between differing materials (e.g., a transition from a rubber portion of an inspection surface to a metal portion of the inspection surface), etc.; changes in temperature; and/or the like. Non-limiting examples of environmental conditions include: changes in humidity (e.g., fog, rain); changes in temperature; changes in lighting conditions (e.g., dusk, night, dawn, day, etc.); and/or the like. For example, embodiments of the current disclosure may use machine learning model(s), e.g., neural networks, convolutional neural networks, and/or other deep-learning models, to analyze inspection surface data and/or observation data, as described herein, collected/generated under varying inspection surface conditions and/or environmental conditions and to consistently recognize features and/or adjust inspection surface data to improve the consistency in analyzing the inspection surface data. In other words, embodiments of the current disclosure use machine learning to smooth out and/or mitigate variances, e.g., noise, in observation data and/or inspection surface data.

Accordingly, the apparatus 650000 includes a feature processing circuit 650010, a surface condition processing circuit 650012, a surface condition compensation circuit 650014, a feature identification circuit 650016, and a feature provisioning circuit 650018. The feature processing circuit 650010 is structured to interpret a feature description 650020 corresponding to an inspection surface 430010 (FIG. 19). The surface condition processing circuit 650012 is structured to interpret surface condition data 650022. The surface condition compensation circuit 650014 is structured to determine, via a machine learning model 650024, a surface condition value 650026 based at least in part on the surface condition data 650022. The feature identification circuit 650016 is structured to identify a feature 650028 of the inspection surface 430010 (FIG. 19) based at least in part on the surface condition value 650026 and the feature description 650020. The feature provisioning circuit 650018 is structured to transmit an indication value 650030 corresponding to the identified feature 650028.

Non-limiting examples of feature description 650020 include data describing and/or otherwise characterizing a type, location, composition of a feature, e.g., a crack or other type of damage in an inspection surface, a seam, an opening, a hatch, a cover, a door, a flange, and/or other discernable structural feature in an inspection surface and/or any other type of feature disclosed herein. The feature description 650020 may be generated by an observation sensor, as disclosed herein, and/or form part of a mapping, e.g., 430038 (FIG. 19) as disclosed herein. For example, the feature description 650020 may include observation data values 650032. The feature description 650020 may include raw sensor data and/or tagged/labeled data, e.g., an XML or other similar type of mark-up file.

Non-limiting examples of observation data values 650032 include raw data and/or processed data from observational sensors, e.g., LIDAR readings, SONAR readings, GPS readings, optical camera data, acoustic data, temperature data, pressure data, and/or the like.

Non-limiting examples of the surface condition value 650026 include data indicating a status and/or other condition and/or property of the inspection surface, e.g.: the inspection surface has a layer of rust, dust, frost, water, corrosion, paint, lubricant, etc. that is X millimeters thick and/or covers a particular area of the inspection surface data in a mapping, e.g., 430038; the inspection surface has bubbling; etc. In embodiments, the surface condition value 650026 may be an adjusted value of inspection surface data, e.g., 430024 (FIG. 19). For example, the machine learning model 650024 may take the surface condition data 650022 as input and generate/output an adjustment for inspection surface data. In embodiments, the surface condition value 650026 may correspond to an environmental condition, e.g., a hot day vs. a cold day, rain vs clear skies or snow, etc. In embodiments, the surface condition value 650026 may correspond to a structural condition, e.g., a gradient of the inspection surface, a texture of the inspection surface, etc.

The feature identification circuit 650016 may include additional models used to identify the feature 650028 from the feature description 650020 using the surface condition value, and/or any inspection surface data (which may have been adjusted by the machine learning model 6500024 and/or the surface condition value 650026). For example, the feature identification circuit 650016 may use a convolutional neural network that takes in inspection surface data and adjusts the inspection surface data based at least in part on the surface condition value 650026, where the feature identification circuit either matches and/or uses a classification model, e.g., a neural network, to classify and/or otherwise identify features in the feature description.

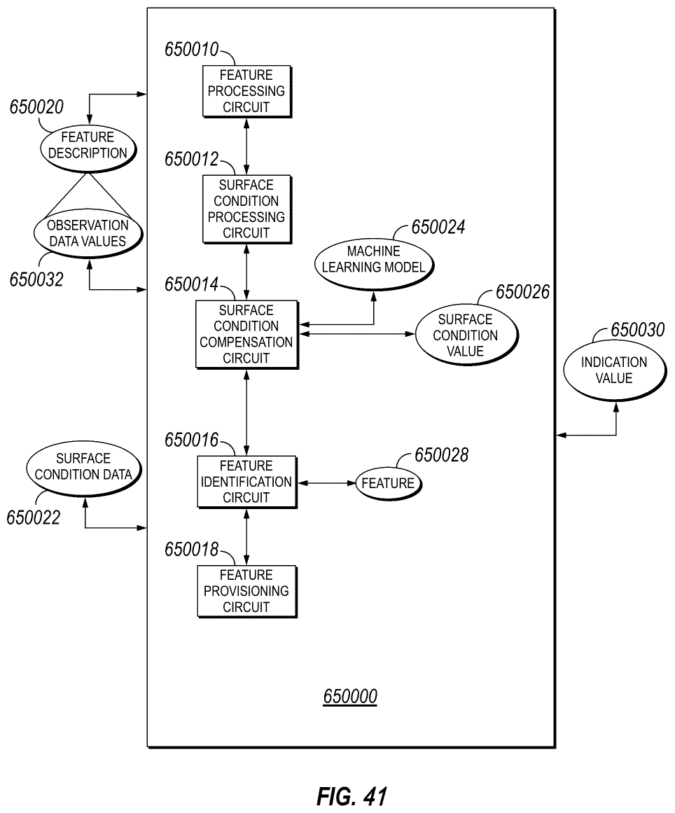

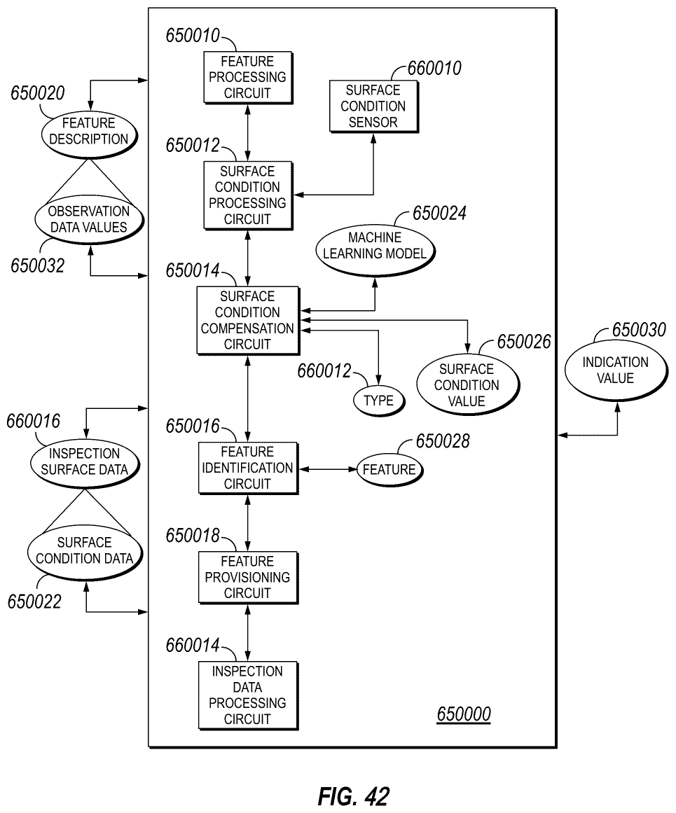

As shown in FIG. 42, in embodiments, the apparatus 650000 may include a surface condition sensor 660010 structured to generate the surface condition data 650022. The surface condition sensor 660010 may include: an optical camera; an infrared camera; an ultrasound transducer; a laser; a temperature sensor; a pressure sensor; a humidity sensor; and/or any other type of sensor suitable for detecting and/or measuring properties of an inspection surface.

In embodiments, the machine learning model 650024 may be structured to identify a type 660012 (or likely type) of the feature 650028 based at least in part on the feature description 650020. In such embodiments, the feature identification circuit 650016 identifies the feature 650028 based at least in part on the type 660012 of the feature. For example, the machine learning model 650024 may determine that a feature likely has a type 660012 of a crack which, in turn, may be used to weight one or more models used by the feature identification circuit 650016 to identify the feature 650028. Non-limiting examples of the type 660012 include: a seem; a joint; a door; a hatch; a stair; and/or any other type of feature disclosed herein.

In embodiments, the machine learning model 650024 may be trained on immediate inspection surface changes, e.g., sharp transitions between different materials of an inspection surface; the presence of absence of liquid, frost, and/or other material that can appear and/or disappear in a relatively short period of time, e.g., less than an hour, day, week, month, and/or year, e.g., the average time between inspection for a particular inspection surface where the feature may be present in one inspection but not in the immediately proceeding inspection or the immediately subsequent inspection.

In embodiments, the machine learning model 650024 may be trained on longitudinal inspection surface changes.

In embodiments, the apparatus 650000 may include an inspection data processing circuit 660014 structured to interpret inspection surface data 660016 that may include the surface condition data 650022. Non-limiting examples of inspection surface data 660016 include raw sensor data from sensors 430022 (FIG. 19), processed data from sensors 430022 (FIG. 19), and/or any other type of data gathered/generated from an inspection surface, e.g., 430010 (FIG. 19). In embodiments, the inspection surface data 660016 may be included in a mapping 430038 (FIG. 19) as disclosed herein.

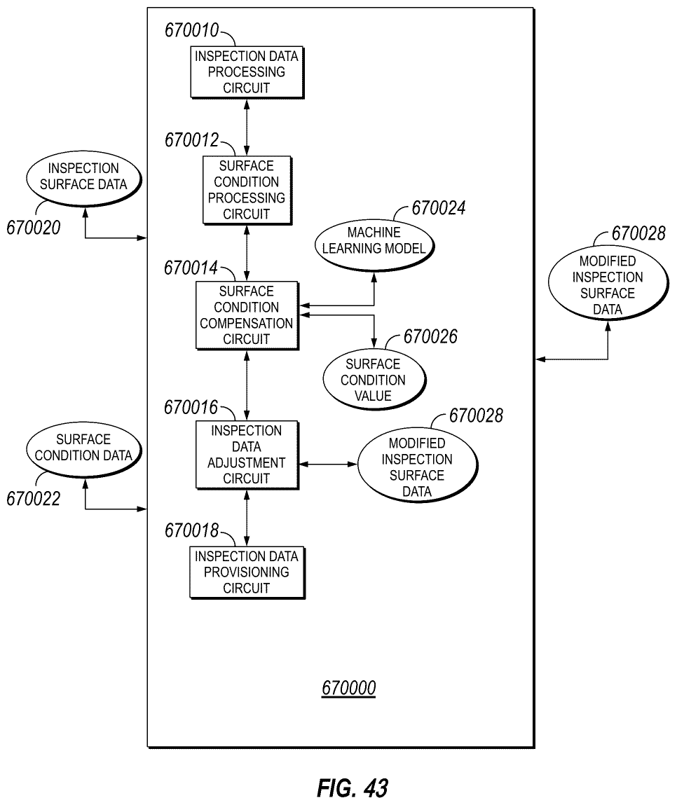

Referring to FIG. 43, an apparatus 670000 for conditioning and/or modifying inspection surface data based at least in part on surface condition data includes: an inspection data processing circuit 670010, a surface condition processing circuit 670012, a surface condition compensation circuit 670014, an inspection data adjustment circuit 670016, and an inspection data provisioning circuit 670018. The inspection data processing circuit 670010 is structured to interpret inspection surface data 670020 corresponding to an inspection surface, e.g., 430010 (FIG. 19). The surface condition processing circuit 670012 is structured to interpret inspection surface condition data 670022 corresponding to the inspection surface. The surface condition compensation circuit 670014 is structured to determine, via a machine learning model 670024, a surface condition value 670026 based at least in part on the surface condition data 670022. The inspection data adjustment circuit 670016 is structured to modify and/adjust the inspection surface data 670020 based at least in part on the inspection surface condition value 670026. The inspection data provisioning circuit 670018 is structured to transit the modified inspection surface data 670028.

In embodiments, the surface condition value 670026 may be an adjustment determined by the machine learning model 670024 to modify the inspection surface data to compensate and/or mitigate the effect of varying conditions on the inspection surface data 670020. For example, in embodiments, the surface condition value 670026 may be a numerical value, and/or a parameterized value, that adjusts inspection surface data 670020 based on a detected amount of rust, dust, snow, frost, liquid, and/or other condition of an inspection surface.

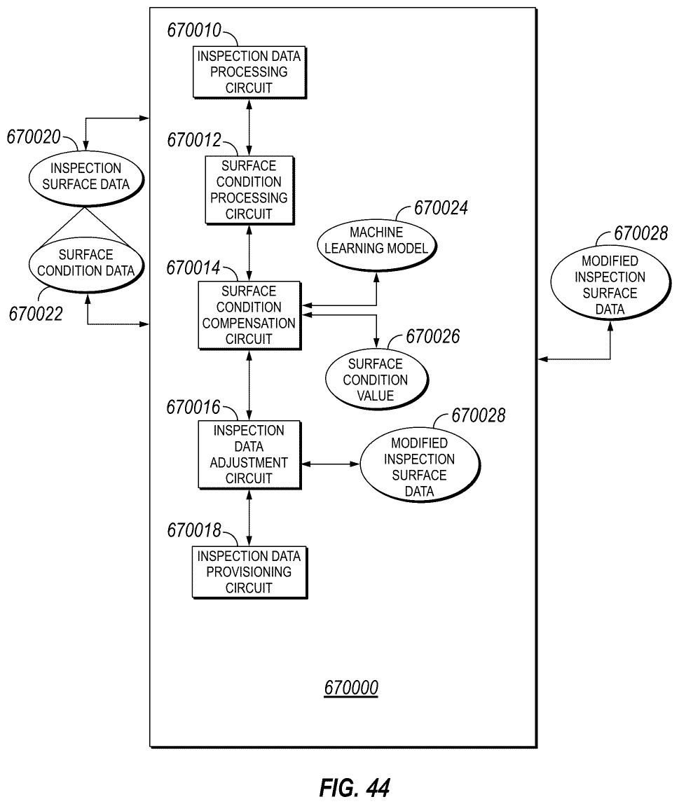

As shown in FIG. 44, in embodiments the inspection surface data 670020 includes the surface condition data 670022 and/or the inspection surface condition data 670022 is generated from the inspection surface data 670020. In embodiments, the surface condition data 670022 includes and/or is based at least in part on one or more of: optical camera data; infrared camera data; ultrasound transducer data; laser data; temperature sensor data; pressure senso data; humidity sensor data; and/or any other type of surface condition sensor and/or observational sensor disclosed herein.

In embodiments, the machine learning model 670024 may be trained on immediate inspection surface changes, as disclosed herein, and/or trained on longitudinal inspection surface changes.

In embodiments, the surface condition value 670026 corresponds to an environmental condition and/or a structural condition, as disclosed herein.

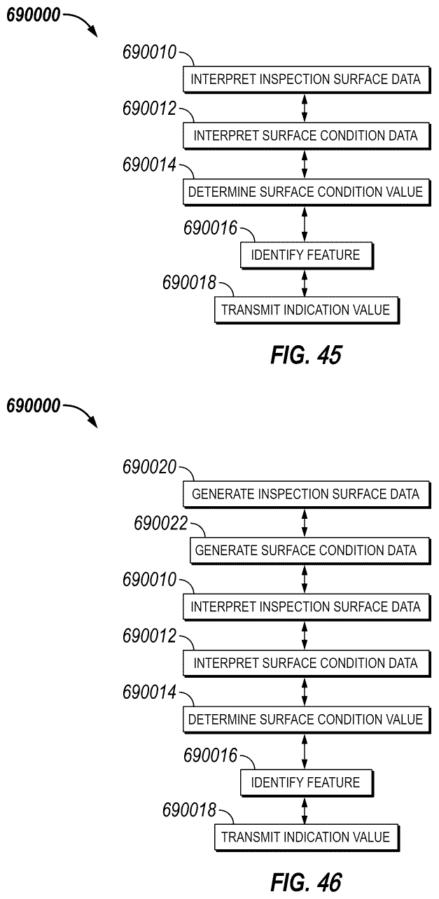

Illustrated in FIG. 45 is a method 690000 for inspection surface feature recognition/identification, in accordance with embodiments of the current disclosure. The method 690000 may be performed via apparatus 650000 (FIG. 42) and/or any other computing device disclosed herein. The method 690000 includes: interpreting 690010 inspection surface data 660016 (FIG. 42) corresponding to an inspection surface 430010 (FIG. 19); interpreting 690012 surface condition data 650022 (FIG. 42) corresponding to the inspection surface 430010 (FIG. 19); and determining 690014, based at least in part on a machine learning model 650024 (FIG. 42), a surface condition value 650026 (FIG. 42) based at least in part on the surface condition data 650022 (FIG. 42). The method 690000 further includes identifying 690016 a feature 650028 of the inspection surface 430010 (FIG. 19) based at least in part on the surface condition value 650026 and the feature 650028. The method 690000 may further include transmitting 690018 an indication value 650030 (FIG. 42) corresponding to the identified feature 650028 (FIG. 42).

Turning to FIG. 46, embodiments of the method 690000 include generating 690020 the inspection surface data 660016 (FIG. 42) via scanning the inspection surface 430010 (FIG. 19) with an inspection robot 430012 (FIG. 19). The method 690000 may further include generating 690022 the surface condition data 650022 (FIG. 42) via scanning the inspection surface 430010 (FIG. 19) with the inspection robot 430012 (FIG. 19).

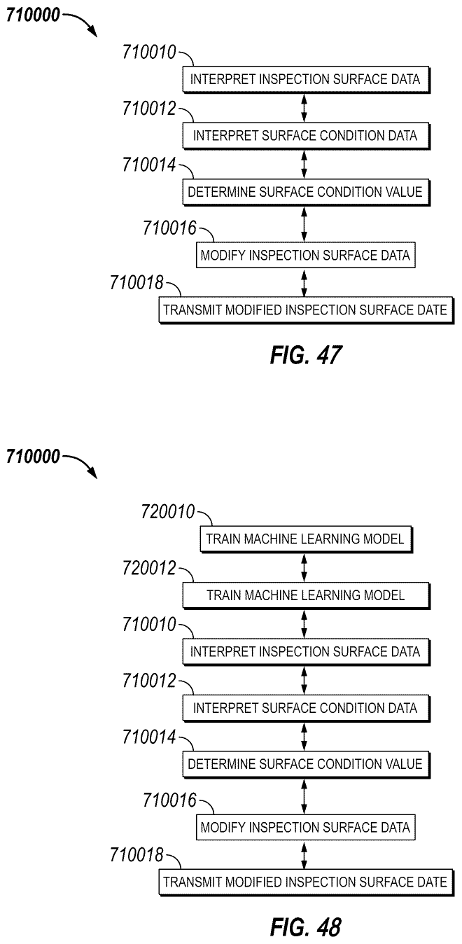

FIG. 47 illustrates a method 710000 for conditioning and/or modifying inspection surface data based at least in part on surface condition data, in accordance with embodiments of the current disclosure. The method 710000 may be performed via apparatus 670000 (FIG. 44) and/or any other computing device disclosed herein. The method 710000 includes: interpreting 710010 inspection surface data 670020 (FIG. 44) corresponding to an inspection surface 430010 (FIG. 19); interpreting 710012 surface condition data 670022 (FIG. 44) corresponding to the inspection surface 430010 (FIG. 19); and determining 710014 based at least in part on a machine learning model 670024 (FIG. 44), a surface condition value 670026 (FIG. 44) based at least in part on the surface condition data 670022 (FIG. 44). The method 710000 may further include modifying 710016 the inspection surface data 670020 (FIG. 44) based at least in part on the surface condition value 670026 (FIG. 44); and transmitting 710018 the modified inspection surface data 670028.

As shown in FIG. 48, embodiments of the method 710000 include: training 720010 the machine learning model 670024 (FIG. 44) on immediate inspection surface changes, as disclosed herein; and/or training 720012 the machine learning model 670024 (FIG. 44) on longitudinal inspection surface changes.

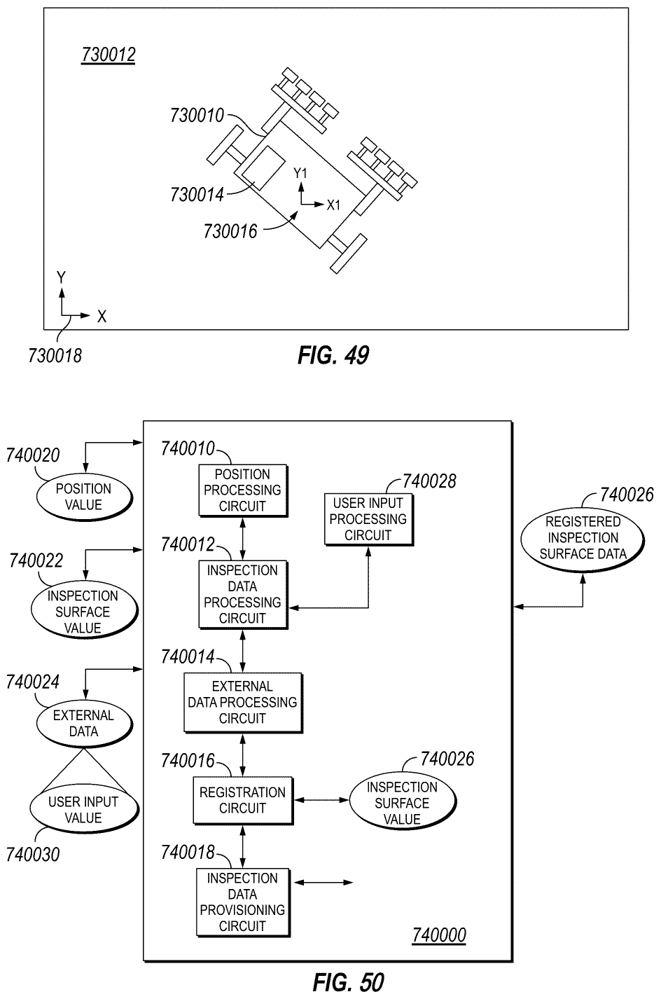

FIG. 49 illustrates an embodiment of the current disclosure for registering inspection surface data, e.g., 430024 (FIG. 19), generated by an inspection robot 730010 inspecting an inspection surface 730012, using and/or otherwise based on external data 430042 (FIG. 19). Non-limiting examples of external data 430042 include: GPS coordinates; a position zeroing command; user input values; a drawing, model, and/or description of a feature of the inspection surface and/or of an external feature, e.g., a building, where the feature is an anchor point (as disclosed elsewhere herein), etc.; a position value; a data corresponding to a region of the inspection surface; user feedback, e.g., a quality rating of a previous scan by an inspection robot; environmental data, e.g., temperature, pressure, humidity, and/or the like; surface condition data, e.g., corrosion, bubbling, rust, dust, smooth, clean, material composition, etc.; and/or the like, to include any type of data that can be entered by a user, e.g., 430044 (FIG. 19). A non-limiting example of a position zeroing command includes a command that sets the determined position of an inspection robot back to an initial condition, e.g., back to a center of a determined origin from which the inspection robot's positioning model uses to generate determined positions in relation to an inspection surface. For example, a position zeroing command may re-initialize a IMU and/or encoder.

As explained herein, external data, e.g., 430042, may be provided to the robot's controller 430020 (FIG. 19), e.g., through an onboard interface 730014 and/or through a network connection, e.g., WiFi, Bluetooth, physical cable, e.g., 430032 (FIG. 19), and/or any other manner of communicating with the controller 430020. Non-limiting examples of the onboard interface 730014 include keyboards, touch screens, physical ports, e.g., USB, RJ45, SD memory slots, and/or the like. For example, in embodiments, a user 430044 (FIG. 19) may use a control device 430046 (FIG. 19) to send the external data 430042 (FIG. 19) to the controller 430020 (FIG. 19) over a network, e.g., 430028 (FIG. 19).

As described herein, in embodiments, the external data 430042 (FIG. 19) may be used by the controller(s) 430020 (FIG. 19) to adjust determined positioning data, sensors (e.g., IMU and/or encoder), and/or models. For example, the external data 430042 (FIG. 19) may be a baseline coordinate in reference to the inspection surface 730012 that provides for the inspection robot 730010 to determine and/or align its coordinate system (represented by determined origin 730016) with a true coordinate system (represented by true origin 730018) of the inspection surface 730012. For example, in embodiments, the inspection robot 730010 may be paced at a starting location S on the inspection surface having true coordinates S on true origin 730018, where S is known to a high degree of precession and/or accuracy, e.g., S may be a pre-determined location to start an inspection run with an inspection robot. The external data 430042 (FIG. 19) may inform the inspection robot's position modeling system (disclosed elsewhere herein) that the inspection robot 730010 it is at S.

As another example, external data 430042 may be provided to the inspection robot 730010 while it is crossing a location P during an inspection where, like the starting location S, has true coordinates on true origin 730018 known to a high degree of precession and/or accuracy. The inspection robot's internal position modelling system may use such data to adjust its determined positioning data and/or positioning model during the inspection.

FIG. 50 depicts an apparatus 740000 for registering inspection surface data using external data, in accordance with embodiments of the current disclosure. The apparatus 740000 may form part of the inspection robot's controller 4030020 (FIG. 19), the servers 430026 (FIG. 19), the workstation 430048 (FIG. 19), the control device 430046 (FIG. 19), and/or any other computing device disclosed herein. The apparatus 740000 includes a position processing circuit 740010, an inspection data processing circuit 740012, an external data processing circuit 740014, a registration circuit 740016, and an inspection data provisioning circuit 740018. The position processing circuit 740010 is structured to interpret a position value 740020, and the inspection data processing circuit 740012 is structured to interpret inspection surface data 740022 corresponding to an inspection surface, e.g., 730012 (FIG. 49). The external data processing circuit 740014 is structured to interpret external data 740022, the registration circuit 740016 is structured to register the inspection surface data 740022 to the inspection surface 730012 (FIG. 49) based at least in part on the position value 740020 and the external data 740022, and the inspection data provisioning circuit 740018 is structured to transmit the registered inspection surface data 740026, e.g., to external devices such as servers 430026 (FIG. 19), workstation 430048 (FIG. 19), control device 430046 (FIG. 19), and/or any other type of computing device external to (e.g., not forming a physical part of and/or not physically integrated with) the apparatus 740000. The external data 740024 may correspond to a selected region of the inspection surface, a user feedback value, e.g., a quality rating of a previous scan by the inspection robot 730010 (FIG. 49) of the inspection surface 730012 or a different inspection surface. In embodiments, registration of the inspection surface data may include selecting/determining a region of the inspection surface 730012 in response to the external data.

As further shown in FIG. 50, the apparatus 740000 may include a user input processing circuit 740028 structured to determine a user input value 740030 from the external data 740024, wherein the registration circuit 740016 is further structured to register the inspection surface data 740022 to the inspection surface 730012 (FIG. 49) based at least in part on the user input value 740030. The user input value 740030 may correspond to a drawing of a structure, e.g., a building floor plan, comprising the inspection surface 730012 (FIG. 49), a position of a feature with respect to the inspection surface 730012 (FIG. 49); a position of the inspection robot, 730010 (FIG. 49) with respect to the inspection surface 730012 (FIG. 49); a global positioning coordinate for at least a portion and/or region (as disclosed herein) of the inspection surface 730012 (FIG. 49); and/or the like. The user input value 740030 may correspond to a condition of the inspection surface 730012 (FIG. 49), e.g., wet, dry, dusty, corroded, icy, and/or the like.

Shown in FIG. 51 is a method 750000 for registering inspection surface data 430024 (FIG. 19) using external data 740024 (FIG. 50), in accordance with embodiments of the current disclosure. The method 750000 may be performed via apparatus 740000 and/or any other computing device disclosed herein. The method includes interpreting 750010 a position value 740020 (FIG. 50); interpreting 750012 inspection surface data 740022 (FIG. 50) corresponding to an inspection surface 730012 (FIG. 49); interpreting 750014 external data 740024 (FIG. 50); registering 750016 the inspection surface data 430024 (FIG. 19) to the inspection surface 730012 (FIG. 49) based at least in part on the position value 740020 (FIG. 50) and the external data 740024 (FIG. 50); and transmitting 750018 the registered inspection surface data 740026 (FIG. 50).

As further shown in FIG. 51, the method 750000 may include electronically communicating 750020 with the external device, e.g., 430046 (FIG. 19) that generates the external data 740024 (FIG. 50). The method 750000 may include determining 750022 a user input value 740030 (FIG. 49) from the external data 740024 (FIG. 49). In such embodiments, registering 750016 the inspection surface data 740022 (FIG. 50) may be based at least in part on the user input value 740030 (FIG. 49). The method 750000 may further include displaying 750024 the registered inspection surface data 740026 on an electronic display, e.g., a display mounted to, integrated with, and/or otherwise forming a part of the inspection robot 730010 (FIG. 49), the workstation's 430048 (FIG. 19) monitor, the control device's 430046 (FIG. 19) monitor, and/or an electronic display in communication with any of the computing devices disclosed herein.

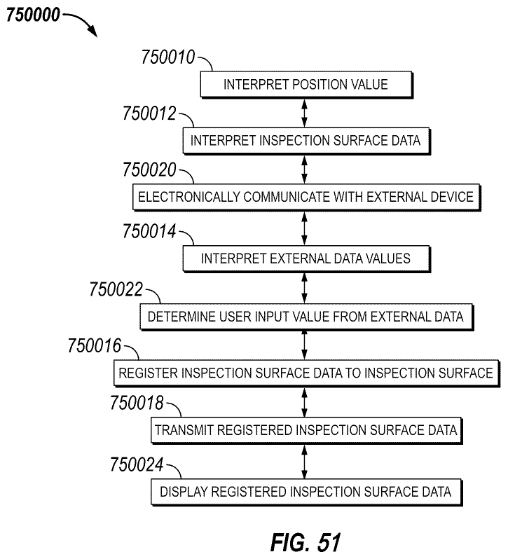

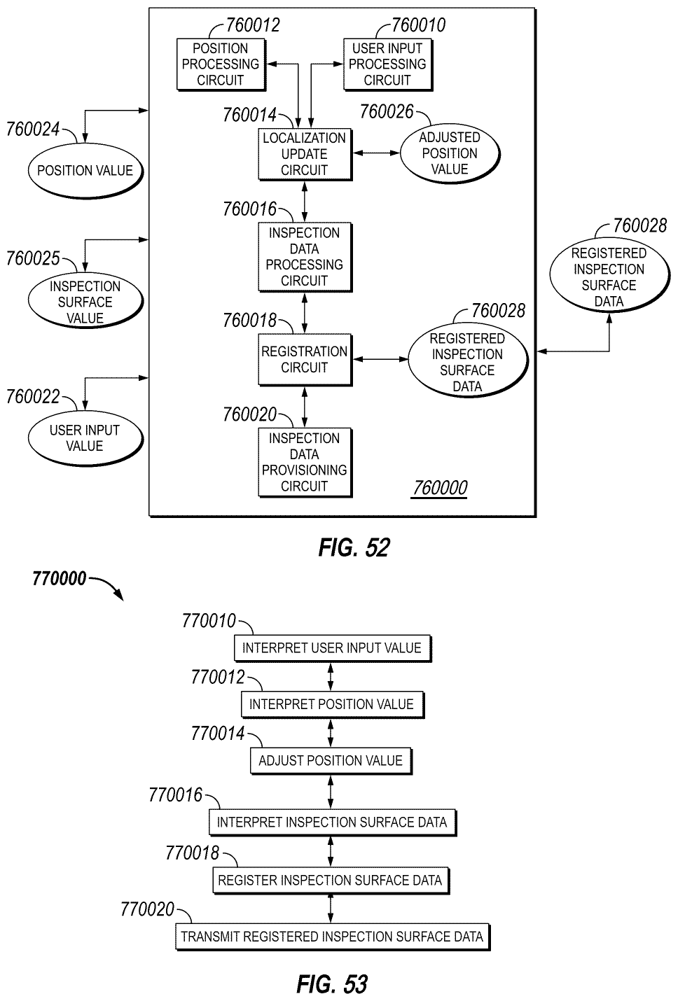

FIG. 52 depicts an apparatus 760000 for adjusting a position value of an inspection robot, in accordance with embodiments of the current disclosure. The apparatus 760000 may form part of the inspection robot's controller 430020 (FIG. 19), the servers 430026 (FIG. 19), the workstation 430048 (FIG. 19), the control device 430046 (FIG. 19), and/or any other computing device disclosed herein. The apparatus 760000 includes: a user input processing circuit 760010, a position processing circuit 760012, a localization update circuit 760014, an inspection data processing circuit 760016, a registration circuit 760018, and an inspection data provisioning circuit 760020. The user input processing circuit 760010 is structured to interpret a user input value 760022, the position processing circuit 760012 is structured to interpret a position value 760024; and the localization update circuit 760014 is structured to adjust the position value 760024 in response to the user input value 760022. The inspection data processing circuit 760016 is structured to interpret inspection surface data 760025 corresponding to an inspection surface, e.g., 730012 (FIG. 49); the registration circuit 760018 is structured to register the inspection surface data 760025 to the inspection surface 730012 (FIG. 49) based at least in part on the adjusted position value 760026; and the inspection data provisioning circuit 760020 is structured to transmit the registered inspection surface data 760028.

In embodiments, the user input vale 760022 may correspond to an inspection surface position value, e.g., a pre-defined location such locations S or P as disclosed herein. The pre-defined location may correspond to a coordinate system, e.g., a true origin 730018 (FIG. 49) or a determined origin 730016 (FIG. 49), that overlays the inspection surface 730012 (FIG. 49).

FIG. 53 depicts a method 770000 for adjusting a position value of an inspection robot, in accordance with embodiments of the current disclosure. The method 770000 may be performed by apparatus 760000 and/or any other computing device disclosed herein. The method 770000 include interpreting 770010 a user input value 760022 (FIG. 52), interpreting 770012 a position value 760024 (FIG. 52), and adjusting 770014 the position value 760024 (FIG. 52) in response to the user input value 760022 (FIG. 52). The method 770000 further includes interpreting 770016 inspection surface data 760025 (FIG. 52), registering 770018 the inspection surface data 760025 (FIG. 52), and transmitting 770020 the registered inspection surface data 760028 (FIG. 52).

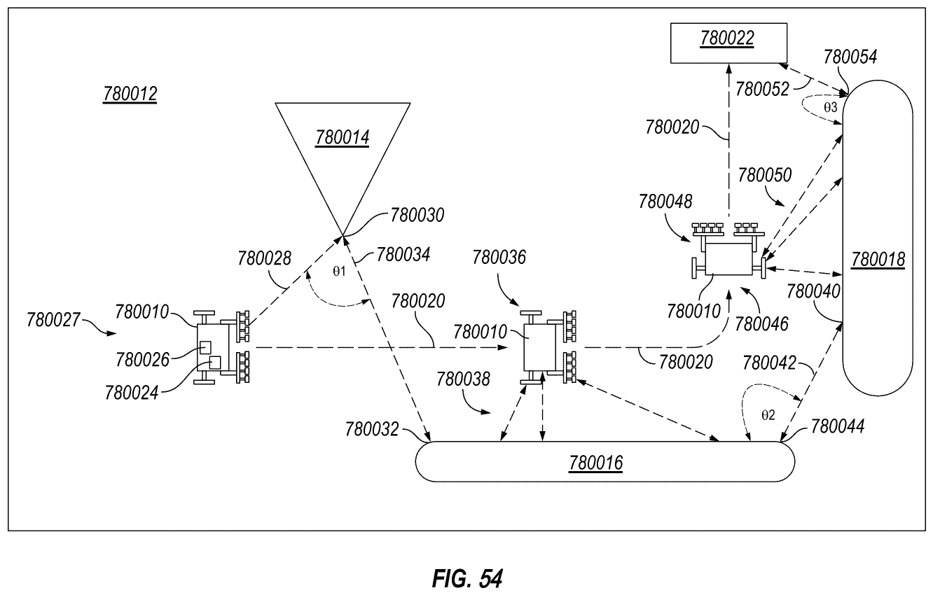

Referring now to FIG. 54, an inspection robot 780010 inspecting an inspection surface 780012 may utilize one or more features 780014, 780016, 780018 to generate and/or confirm guidance data for navigating the inspection surface 780012. Navigating may include generating and following an inspection path 780020 to achieve a goal, e.g., maximum coverage of the inspection surface 780012 and/or coverage of a selected region 780022 of the inspection surface 780012. The inspection robot 780010 may have one or more position sensors 780024 and/or observation sensors 780026, as disclosed herein, that feed sensory data to a positioning and/or navigation model operating on the inspection robot 780010, the servers 430026 (FIG. 19), workstation 430048 (FIG. 19), control device 430046 (FIG. 19) and/or any other computing device disclosed herein. The observation sensors 780026 may detect/identify and/or track the features 780014, 780016, and/or 780018 as the inspection robot 780010 moves along the inspection surface 780012, where the navigation model may periodically (or continuously) determine and/or update the location/position of the inspection robot 780010 on the inspection surface 780012 in relation to features that can be observed from the inspection robot's 780010 current position.

For example, the inspection robot 780010 may start an inspection run at a first location 780027 with the objective of inspecting region 780022 and/or have historical inspection data that defines/describes the features 780014, 780016, 780018. As will be understood, the historical inspection data may have been provided to the inspection robot 780010 by a user 430044 (FIG. 19) via control device 430046 (FIG. 19), by the servers 430026 (FIG. 19), the workstation 430048 (FIG. 19), and/or any other computing device disclosed herein. The historical inspection data may have been generated by the inspection robot 780010 and/or another inspection robot and/or inspection device during a prior inspection of the inspection surface 780012 and/or during a prior portion of a same inspection run during which the historical data is used to navigate the inspection surface 780012. The historical inspection data may include inspection data previously acquired by the same inspection robot during the same inspection run, inspection data acquired by the same and/or a different inspection robot from prior inspection runs, and/or other sources of inspection data, e.g., manual inspections. Historical inspection data may include raw and/or processed sensor readings. Processed sensor readings may the result of manipulating/adjusting/conditioning raw sensor data to be in a form that is more easily readable by a human and/or computer model. Processed sensor readings may include labels and/or have the underlying sensor data grouped into data structures based on time, location, sensor type, etc. Processed sensor readings may be a converted form of raw sensor data, e.g., milliamps to another unit, e.g., distance.

At location 780027, the inspection robot 780010 may be able to observe, via observation sensors 780026, feature 780014 where features 780016 and 780018 may be out of view of the observation sensors 780026. The historical data may include information that provides for the inspection robot 780010 to determine a spatial/locational relationship between the features 780014, 780016, 780018, the inspection surface 780012, and/or the selected/target region 780022, e.g., the historical data may provide a map of the inspection surface 780012 and/or features and/or include data from which the inspection robot 780010 can generate such a map.

For example, the inspection robot 780010 may be able to discern that it is a distance 780028 from a point 780030 of feature 780014, and have knowledge (from the historical inspection data) that point 780032 of feature 780016 is a distance 780034 from point 780030 at an angle of θ₁. The inspection robot 780010 may then generate and/or adjust a portion of path 780020 and/or confirm that it is correcting following path 780020 with the intent of moving along path 780020 until it is able to identify feature 780016. As will be understood, in embodiments, the inspection robot 780010 may track/monitor its position with respect to feature 780014 in order to confirm it is correctly following path 780020 and/or that the current trajectory of path 780020 will (or has a high probability of) brining the inspection robot 780010 within observation distance of feature 780016, e.g., point 780036.

Upon reaching point 780032, the inspection robot 780010 may begin tracking its distance and/or position with respect to feature 780016 via the observation sensors 780026 as represented by dashed arrows 780038. The historical data may provide for the inspection robot 780010 to determine that a point 780040 of feature 780018 (which may be out of view of the inspection robot 780010) is at a distance 780042 from a point 780044 of feature 780016 and an angle of θ₂. Using this knowledge, the inspection robot 780010 may either adjust path 780020 and/or continue to follow it, to include making a turn 780046, until feature 780018 becomes observable, via the observation sensors 780026. At point 780048, the inspection robot 780010 track its position with respect to feature 780018, as represented by dashed arrows 780050, with the knowledge (from the historical data) that the target region is at a distance 780052 from point 780054 (of feature 780018) at an angle of θ₃. The inspection robot 780010 may then continue to update and/or follow the path 780020 until it reaches the target region 780022.

As will be appreciated, the inspection robot 780010 may use its positioning model and/or dead reckoning techniques to navigate between features 780014, 780016, 780018 when no features 780014, 780016, 780018 are within view of the observation sensors 780026. For example, the inspection robot 780010 may strongly rely on an IMU and/or encoder to “cross” the observation gaps between the features 780014, 780016, 780018.

As will be understood, embodiments of the inspection robot 780010 may navigate, as disclosed herein, using features forming part of the inspection surface 780012, e.g., hatches, flanges, stairwells, doorways, etc.; features apart from the inspection surface 780012, e.g., buildings in proximity to the inspection surface 780012, the sun, the moon, stars, and/or any other discernable features.

In embodiments, the inspection robot 780010 may also use the feature navigation approach, as disclosed herein, to perform vertical and/or horizontal progression along the inspection surface 780012. Vertical progression of the inspection robot 780010 along the inspection surface 780012 may include moving the inspection robot 780010 in vertical paths up and down a vertical inspection surface, e.g., the sidewall of a storage tank, while moving the inspection robot forward/horizontally once per vertical pass, e.g., painting a fence or wall.

Horizontal progression of the inspection robot 780010 along the inspection surface 780012 may include moving the inspection robot 780010 in horizontal paths back and forth a horizontal inspection surface, e.g., the top wall of a storage tank, while moving the inspection robot forward once per horizontal pass, e.g., mopping floor.

Embodiments of the inspection robot 780010 may also utilize an IMU and/or a gravity vector, as disclosed elsewhere herein, to perform vertical and/or horizontal progression and/or true vertical and/or true horizontal progression along the inspection surface 780012. For example, a selected angle, e.g., 30° above a horizontal, and/or any arbitrary trajectory based on the inspection surface′ 780012 geometry and/or positioning are contemplated by the current disclosure. Embodiments of the current disclosure may also use feature loop closure detection, as disclosed elsewhere herein, to navigate between features, e.g., 780014, 780016, and/or 780018, and/or to generate and/or follow a path 780020 to achieve an objective/goal. Embodiments of the current disclosure may also provide for operator guidance feedback, e.g., guiding line(s), haptic feedback, etc.

Embodiments of the current disclosure may generate the inspection path 780020 based on the results of prior inspection runs. For example, embodiments of the current disclosure may analyze prior inspection surface data to determine any missing regions, regions that are due for a reinspection, regions that have indications of past damage, and/or regions having indications of previous repairs that may need verification/certification of completion. Embodiments of the current disclosure may also determine if a particular type of inspection is needed for a given region, e.g., such as in the case of comparing two regions together and/or for providing data to a wear model (e.g., the modeling of structure and/or surface fatigue). Embodiments of the current disclosure may also recommend a particular type of inspection and/or inspection path based on analyzing prior inspection data and/or based on external data, e.g., user inputs.

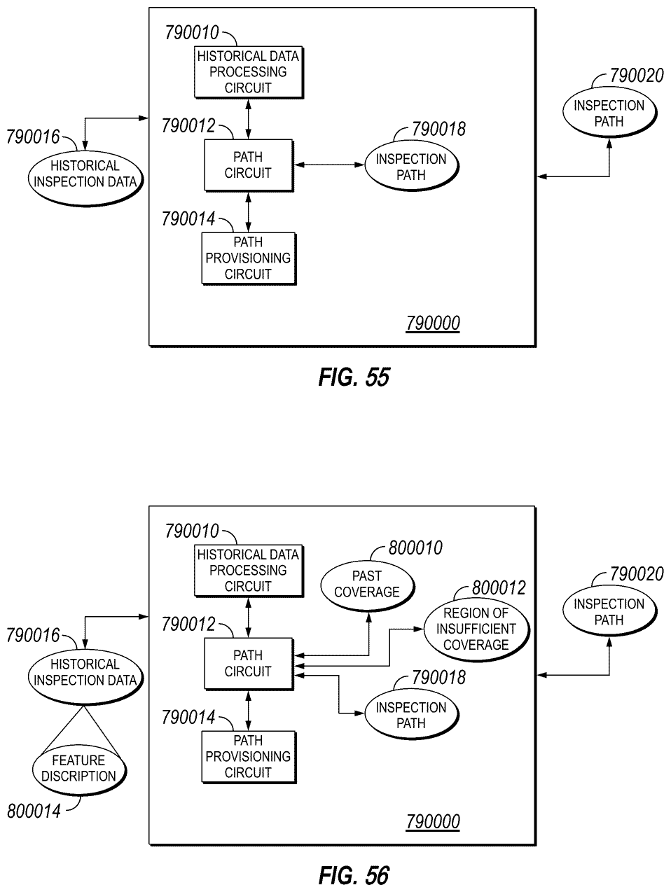

FIG. 55 depicts an apparatus 790000 for generating a path 780020 (FIG. 54) for an inspection robot 780010 (FIG. 54) for inspecting an inspection surface 780012 (FIG. 54) in accordance with embodiments of the current disclosure. The apparatus 790000 may form part of the inspection robot's controller 430020 (FIG. 19), the servers 430026 (FIG. 19), the control device 430046 (FIG. 19), the workstation 430048 (FIG. 19), and/or any other computing device disclosed herein. The apparatus 790000 includes a historical data processing circuit 790010, a path circuit 790012, and a path provisioning circuit 790014. The historical data processing circuit 790010 is structured to interpret historical inspection data 790016 corresponding to a previous inspection of the inspection surface 780012 (FIG. 54). Non-limiting examples of historical inspection data 790016 include: raw and/or processed inspection data from a prior inspection by the same and/or a different inspection robot; raw and/or processed observation data acquired by the same and/or different robot, and/or other sources, e.g., data collected by devices other than an inspection robot, e.g., a human surveyor, a drone, and/or the like; raw and/or processed data; and/or any other type of data that may be relevant to planning and/or performing an inspection of the inspection surface. The path circuit 790014 is structured to generate an inspection path 780020 (FIG. 54) based at least in part on the historical inspection data 790016. The path 780020 may be a series of coordinates, headings and/or any other type of data that can be used to direct the movement of the inspection robot 780010 along the inspection surface 780012. The path provisioning circuit 790014 is structured to transmit the inspection path 790020. In embodiments, the path circuit 790014 may generate the entire path at once and then update it as needed. In embodiments, the path circuit 790014 may generate portions of the path as needed, e.g., on the fly as the inspection robot 780010 encounters and/or detects the features, e.g., 780014, 780016, 78008.

As shown in FIG. 56, in embodiments, the path circuit 790012 may be further structured to: analyze the historical inspection data 790016 to determine a past coverage 800010 of the inspection surface 780012 (FIG. 54); determine a region of insufficient coverage 800012 (corresponding to region 780022 in FIG. 54) of the inspection surface 780012 (FIG. 54) based at least in part on the past coverage 800010; and configure the inspection path 790018 to capture, via an inspection robot 780010 (FIG. 54), the region of insufficient coverage 800012. In embodiments, the region of insufficient coverage 800012 may correspond to no coverage and/or partial missing coverage, e.g., the historical inspection data 790016 indicates that a region was not previously inspected. In embodiments, the region of insufficient coverage 800012 corresponds to a region identified for high-fidelity inspection, as disclosed elsewhere herein.

As also shown in FIG. 56, the historical inspection data 790016 may include a feature description 800014 corresponding to two or more features, e.g., 780014, 780016, 780018 (FIG. 54) of the inspection surface 780012 (FIG. 54), where the path circuit 790012 may be further structured to generate the inspection path 790020 further based at least in part on the feature description 800014. For example, the inspection path 780020 may be structured to run along the two or more features of the inspection surface, e.g., 780014, 780016, 780018 (FIG. 54) as shown in FIG. 54.

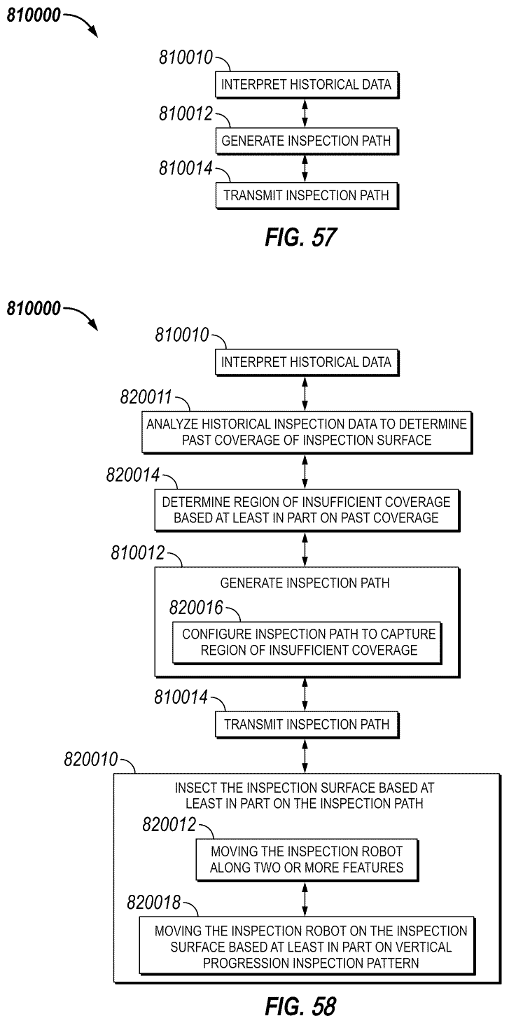

FIG. 57 depicts method 810000 for generating an inspection path 780020 (FIG. 54) for an inspection robot 780010 (FIG. 54) to inspect an inspection surface 780012 (FIG. 54). The method 810000 may be performed via apparatus 790000 and/or any other computing device disclosed herein. The method 810000 includes interpreting 810010 historical inspection data 790016 (FIG. 55) corresponding to the inspection surface 780012 (FIG. 54), generating 810012 an inspection path 790018 (FIG. 55) based at least in part on the historical inspection data 790016 (FIG. 55), and transmitting 810014 the inspection path 790018 (FIG. 55).

Turning to FIG. 58, embodiments of the method 810000 may include inspecting 820010 the inspection surface 780012 (FIG. 54) via the inspection robot 780010 (FIG. 54) based at least in part on the inspection path 790018 (FIG. 55). In embodiments, the historical inspection data 790016 (FIG. 56) may include a feature description 800014 (FIG. 56) corresponding to two or more features, e.g., 780014, 780016, 780018 (FIG. 54), of the inspection surface 780012 (FIG. 54) where, in such embodiments, generating 810012 the inspection path 790018 (FIG. 56) based at least in part on the historical inspection data 790016 (FIG. 56) may be further based at least in part on the feature description 800014 (FIG. 56).

In embodiments, inspecting 820010 the inspection surface 780012 (FIG. 54) based at least in part on the inspection path 790020 (FIG. 56) may include moving 820012 the inspection robot 780010 (FIG. 54) along the two or more features e.g., 780014, 780016, 780018 (FIG. 54).

The method 810000 may also include: analyzing 820011 the historical inspection data 790016 (FIG. 56) to determine a past coverage 800010 of the inspection surface 780012 (FIG. 54); determining 820014 a region of insufficient coverage 800012 (FIG. 56) of the inspection surface 780012 (FIG. 54) based at least in part on the past coverage 800010 (FIG. 56); and configuring 820016 the inspection path 790018 (FIG. 56) to capture the region of insufficient coverage 800012 (FIG. 56). In embodiments, the region of insufficient coverage 800012 may correspond to no coverage and/or to a region identified for high-fidelity inspection/capture.

In embodiments, the historical inspection data 790016 (FIG. 56) corresponds to a horizontal progression inspection pattern, the inspection path 790018 (FIG. 56) corresponds to a vertical progression inspection pattern. In such embodiments, inspecting the inspection surface 780012 (FIG. 54) via the inspection robot 780010 (FIG. 54) based at least in part on the inspection path 790020 (FIG. 56) includes moving 820018 the inspection robot 780010 on the inspection surface 780012 based at least in part on the vertical progression inspection pattern.

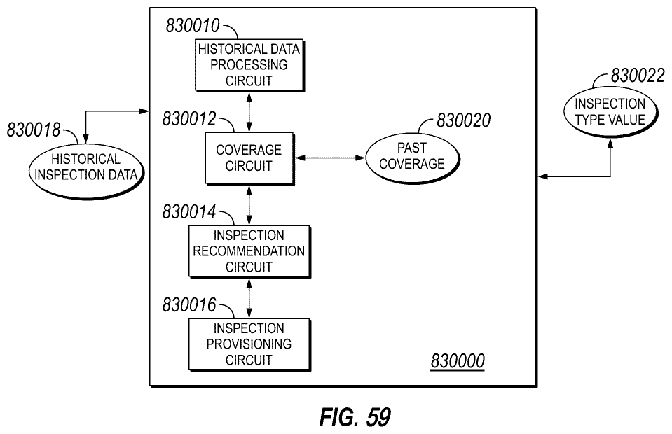

Referring now to FIG. 59, an apparatus 830000 for determining a type of inspection for an inspection surface 780012 (FIG. 54), in accordance with embodiments of the current disclosure, is shown. The apparatus 830000 may form part of the inspection robot's controller 430020 (FIG. 19), the servers 430026 (FIG. 19), the control device 430046 (FIG. 19), the workstation 430048 (FIG. 19), and/or any other computing device disclosed herein. The apparatus 830000 includes: a historical data processing circuit 830010, a coverage circuit 830012, an inspection recommendation circuit 830014, and an inspection provisioning circuit 830016. The historical data processing circuit 830010 is structured to interpret historical inspection data 830018 corresponding to a previous inspection of the inspection surface 780012 (FIG. 54).

The coverage circuit 830012 is structured to analyze the historical inspection data 830018 to determine a past coverage 830020 of the inspection surface 780012 (FIG. 54). As will be understood, in embodiments, the coverage circuit 830012 may be integrated with a path circuit, such as the circuit 790012 shown in FIG. 56). The inspection recommendation circuit 830014 is structured to determine an inspection type value 830022 based at least in part on the past coverage 830020 of the inspection surface 780012 (FIG. 54). Non-limiting examples of inspection types include ultrasound, laser, optical camera, high fidelity, vertical progression inspection pattern; a horizontal progression inspection pattern; a feature-tracking inspection pattern, a cleanup inspection, a repair inspection; an initial inspection, and/or any other type of inspection disclosed herein. The inspection provisioning circuit 830016 is structured to transmit the inspection type value 830022.

In embodiments, the inspection recommendation circuit 830014 may be further structured to determine a plurality of inspection type values that includes the inspection type value 830022, where the inspection provisioning circuit 830016 may be further structured to transmit the plurality of inspection type values.

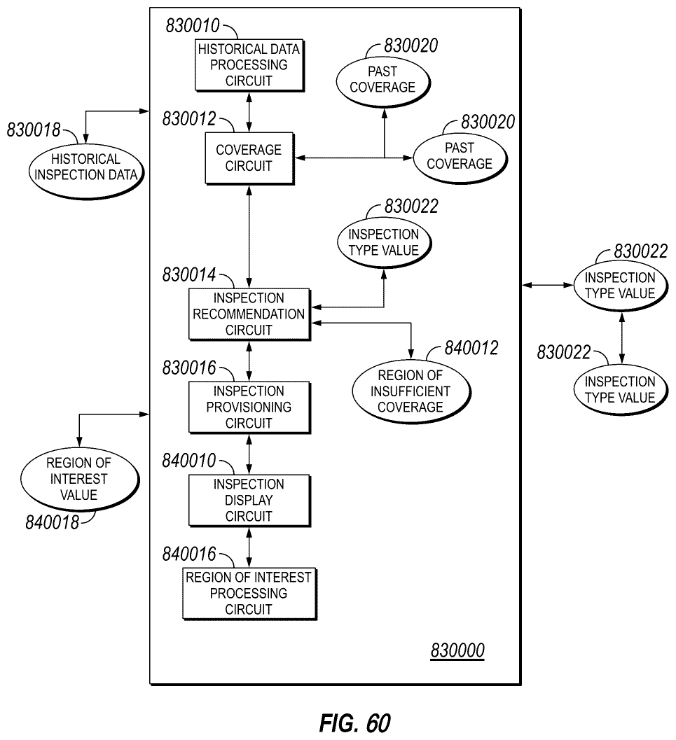

As illustrated in FIG. 60, the apparatus 830000 may include an inspection display circuit 840010 structured to display the plurality of inspection type values on an electronic display, e.g., control device 430046 (FIG. 19), workstation 430048 (FIG. 19), and/or any other type of electronic display, such as a cell phone, table, or the like.

In embodiments, the inspection recommendation circuit 830014 may be further structured to determine a region of insufficient coverage 840012, e.g., region 780022 (FIG. 54). In such embodiments, the inspection type value 830022 may correspond to an inspection type that covers the region of insufficient coverage 840012. The region of insufficient coverage 840012 may correspond to no coverage and/or to a region identified for high-fidelity capture.

The apparatus 830000 may include a region of interest processing circuit 840016 structured to interpret a region of interest value 840018 corresponding to a region, e.g. 780022 (FIG. 54), of the inspection surface 780012 (FIG. 54). In such embodiments, the inspection type value 830022 corresponds to an inspection type that covers the region 840012. The region of interest value 840018 may be based at least in part on a user input.

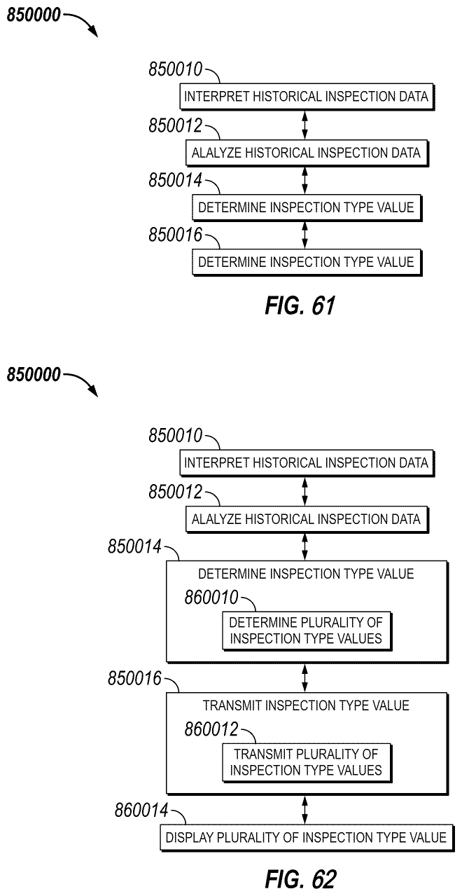

Shown in FIG. 61 is a method 850000 for determining a type of inspection for an inspection surface 780012 (FIG. 54), in accordance with embodiments of the current disclosure. The method 850000 may be performed by the apparatus 830000 and/or any other computing device disclosed herein. The method 850000 includes interpreting 850010 historical inspection data 830018 (FIG. 60) corresponding to a previous inspection of the inspection surface 780012 (FIG. 54); analyzing 850012 the historical inspection data 830018 (FIG. 60) to determine a past coverage 830020 (FIG. 60) of the inspection surface 780012 (FIG. 54); and determining 850014, based at least in part on the past coverage 830020 (FIG. 60) of the inspection surface 780012 (FIG. 54), an inspection type value 830022 (FIG. 60). The method 850000 may further include transmitting 850016 the inspection type value 830022 (FIG. 60).

FIG. 62 depicts additional embodiments of the method 850000. For example, determining 850014 the inspection type value 830022 may include determining 860010 a plurality of inspection type values that includes the inspection type value 830022 (FIG. 60); and transmitting 850016 the inspection type value 830022 (FIG. 60) may include transmitting 860012 the plurality of inspection type values. The method 850000 may include displaying 860014 the plurality of inspection type values on an electronic display.

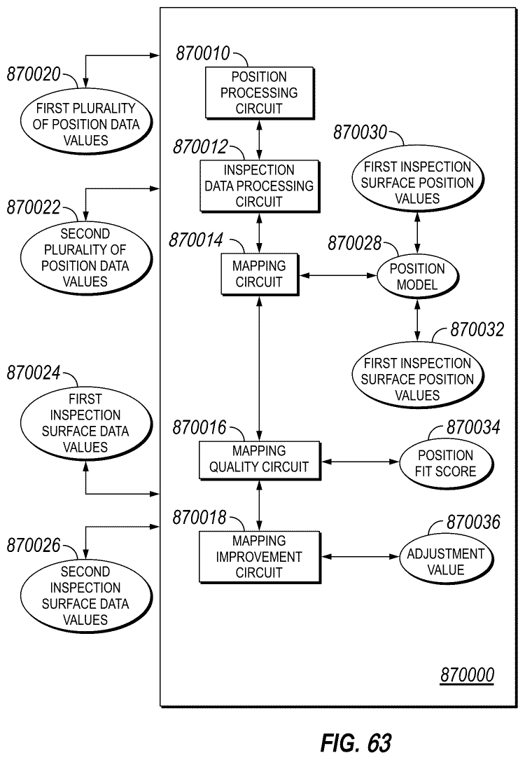

Referring now to FIG. 63, embodiments of the current disclosure provide for the use of multiple inspection runs to improve the mapping of inspection surface data to an inspection surface and/or to improve bulk data optimization for the inspection surface data, as disclosed herein with respect to FIGS. 26 and 27. For example, analysis of inspection surface data for multiple inspection runs may be used to determine adjustments to position data that more accurately and/or precisely align/map the inspection surface data to the true positions of the inspection surface, than when only a single run's worth of inspection surface data is used. The adjustments may be used to improve the mapping of successive inspection runs and/or prior inspection runs via post-processing, e.g., data learned/generated from each new inspection run may be used to refine the position adjustments for old inspection runs. In embodiments, the adjustments to position data may be based at least in part on predicted, expected, and/or observed changes in an inspection surface, and/or the encompassing structure.

Accordingly, FIG. 63 illustrates an apparatus 870000 for registering and/or mapping inspection surface data to an inspection surface, in accordance with embodiments of the current disclosure. The apparatus 870000 may form a part of and/or otherwise be integrated with the controller 430020 (FIG. 19), the servers 430026 (FIG. 19), the workstation 430048 (FIG. 19), the control device 430046 (FIG. 19) and/or any other computing device disclosed herein. The apparatus 870000 includes a position processing circuit, an inspection data processing circuit 870012, a mapping circuit 870014, a mapping quality circuit 870016, and a mapping improvement circuit 870018. The position processing circuit 870010 is structured to interpret: a first plurality of position data values 870020 corresponding to a first inspection run of a first inspection surface, e.g., 102 (FIG. 1), and a second plurality of position data values 870022 corresponding to a second inspection run of a second inspection surface. The inspection data processing circuit 870012 is structured to interpret: first inspection surface data values 870024 corresponding to the first inspection surface, and second inspection surface data values 870026 corresponding to the second inspection surface. The mapping circuit 870014 is structured to operate a position model 870028 to determine: in response to the first plurality of position data values 870020, a first inspection surface position value 870030 for each of the first inspection surface data values 870024; and in response to the second plurality of position data values 870022, a second inspection surface position value 870032 for each of the second inspection surface data values 870026. The mapping quality circuit 870016 is structured to determine a position fit score 870034 based at least in part on the first 870030 and the second 870032 inspection surface position values. The mapping improvement circuit 870018 is structured to generate an adjustment value 870036 configured to adjust the position model 870028 in response to the position fit score 870034.

The first inspection surface and the second inspection surface may be the same inspection surface or different/distinct inspection surfaces. The first inspection surface and the second inspection surface may be of the same structure, e.g., the top and bottom walls of a storage tank; and/or of different/distinct structures, e.g., the sidewalls of different storage tanks. The first 870020 and the second 870022 plurality of position data values may have been generated by the same or different inspection robots. The first 870024 and the second 870026 inspection surface data values may have been generated by the same or different inspection robots.

In embodiments, at least two of the following may be generated by distinct inspection robots: the first plurality of position data values 870020; the second plurality of position data values 870022; the first inspection surface data values 870024; or the second inspection surface data values 870026.

As will be understood, embodiments of the current disclosure may use multiple position models 870028, e.g., different position models may be used for different inspection surfaces, inspection runs, different inspection robots, and/or the like.

The adjustment 870036 may be a scalar, a function, an adjustments of weights, the inclusion or exclusion of submodules, e.g.: swapping environmental models such as replacing a rain submodule with a snow submodule; swapping material models such as replacing a aluminum surface submodule with a steel submodule; adding an inspection surface data feature detection submodule (a submodule that detects features within inspection surface data); and/or the like.

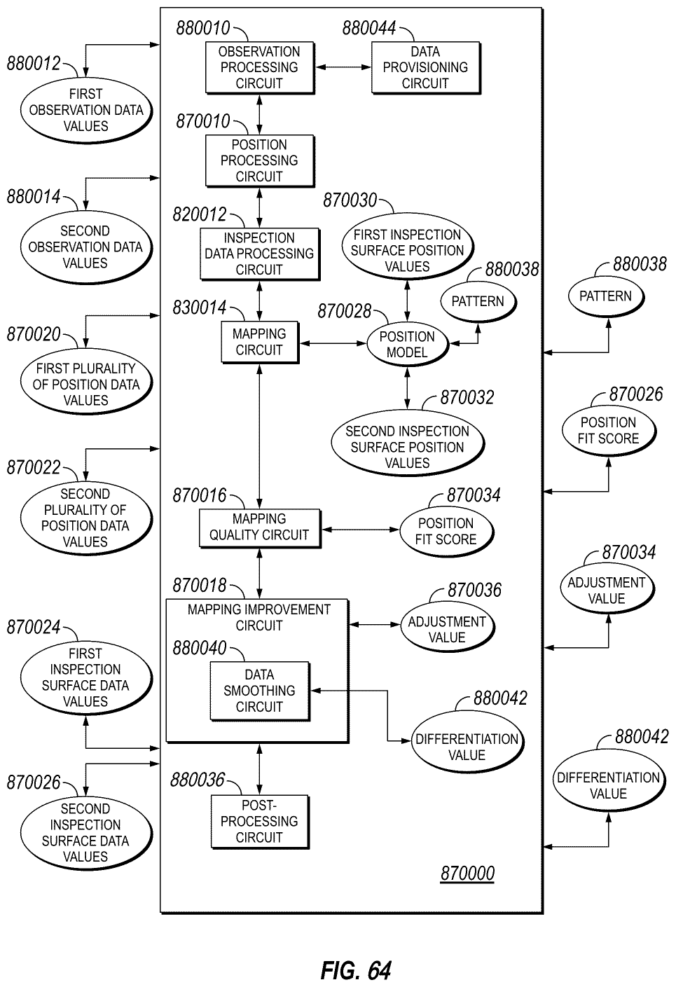

As shown in FIG. 64, the apparatus 870000 may include an observation processing circuit 880010 structured to interpret: first observation data values 880012 corresponding to the first inspection surface, and/or second observation data values 880014 corresponding to the second inspection surface. In such embodiments, the mapping quality circuit 870016 may be further structured to determine the position fit score 870034 further based at least in part on the first 880012 and/or the second 880014 observation data values. The observation data values 880012 and/or 880014 may include feature descriptions (as disclosed elsewhere herein) and/or any other type of observation data (as disclosed elsewhere herein). For example, the observation data values 880012 and/or 880014 may include positional data for features, indications of the types of features, weather and/or environmental data, and/or the like.

The apparatus 870000 may include a post-processing circuit 880036 structured to adjust the first inspection surface position value 870030 for each of the first inspection surface data values 870024 based at least in part on the adjusted position model 870028. The adjustment may be based on a scalar, a function, and/or any other type of positional adjustment.

In embodiments, the mapping improvement circuit 870018 is further structured to configure the adjustment value 870036 to adjust a weight of the position model 870028. For example, in embodiments, observation data corresponding to the position of a highly discernable feature, e.g., a known hatch, may be given a high weight than IMU and/or encoder data within the position model 870028. In embodiments, the position model 870028 may be structured to identify a pattern 880038 in at least one of the first 870024 and/or the second 870026 inspection surface data values. In such embodiments, the mapping circuit 870014 is further structured to determine at least one of the first 870030 and/or the second 870032 inspection surface position values further based at least in part on the identified pattern 880038. Non-limiting examples of patterns may be signatures in raw and/or processes sensor data corresponding to known features, e.g., a crack, a seem, a change in thickness, a change in material, and/or the like. In embodiments, the mapping improvement circuit 870018 may be further structured to configure the adjustment value 870036 to change the pattern 880038 to be identified by the position model 870028. Non-limiting examples of such changes include: changing from a pattern that identifies cracks to a pattern that identifies changes in material or vice-versa, changing from a pattern that identifies seems to a pattern than identifies cracks or vice-versa, changes between any other types of patterns corresponding to features, and/or combinations thereof.

In embodiments, mapping improvement circuit 870018 may be further structured to configure the adjustment value 870036 to add, remove and/or move a feature to/from/within the position model 870028.

The apparatus 870000 may include an observation processing circuit structured to interpret: first observation data values 880012 corresponding to the first inspection surface, and second observation values 880014 corresponding to the second inspection surface. In such embodiments, the mapping quality circuit 870016 may be further structured to determine the position fit score 870034 further based at least in part on the first 880012 and the second 880014 observation data values. The first 880012 and the second 880014 observation values may be generated by the same and/or different/distinct inspection robots.

Embodiments of the mapping improvement circuit 870018 may include a data smoothing circuit 880040 structured to determine a differentiation value 880042 between the first inspection surface and the second inspection surface based at least in part on: the first 870020 and the second 870022 plurality of position data values; the first 870024 and the second 870026 inspection surface data values; and/or the first 880012 and/or the second 880014 observation data values. The mapping improvement circuit 870018 may be structured to configure the adjustment value 870036 to adjust the position model 870028 based at least in part on the differentiation value 880042.

In embodiments, the apparatus 870000 may include a data provisioning circuit 880044 structured to transmit the pattern 880038, the position fit score 870026, the adjustment value 870036, the differentiation value 880042, and/or any other data generated and/or handled by the apparatus 870000.

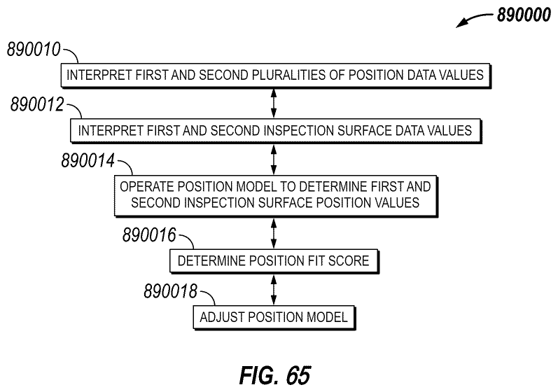

Illustrated in FIG. 65 is a method 890000 for registering and/or mapping inspection surface data to an inspection surface, in accordance with embodiments of the current disclosure. The method 890000 may be performed via apparatus 870000 and/or any other computing device disclosed herein. The method 890000 includes interpreting 890010 a first plurality of position data values 870020 (FIG. 64) corresponding to a first inspection run of a first inspection surface, and a second plurality of position data values 870022 (FIG. 64) corresponding to a second inspection run of a second inspection surface. The method 890000 further includes interpreting 890012 first inspection surface data values 870024 (FIG. 64) corresponding to the first inspection surface, and second inspection surface data values 870026 (FIG. 64) corresponding to the second inspection surface. The method 890000 further includes determining 890014, via operating a position model 870028 (FIG. 64), in response to the first plurality of position data values 870020 (FIG. 64), a first inspection surface position value 870030 (FIG. 64) for each of the first inspection surface data values 870024 (FIG. 64), and in response to the second plurality of position data values 870022 (FIG. 64), a second inspection surface position value 870032 (FIG. 64) for each of the second inspection surface data values 870026 (FIG. 64). The method 890000 further includes determining 890016 a position fit score 870034 (FIG. 64) based at least in part on the first 870020 (FIG. 64) and the second inspection surface position values 870032 (FIG. 64), and adjusting 890018 the position model 870028 (FIG. 64) in response to the position fit score 870034 (FIG. 64).

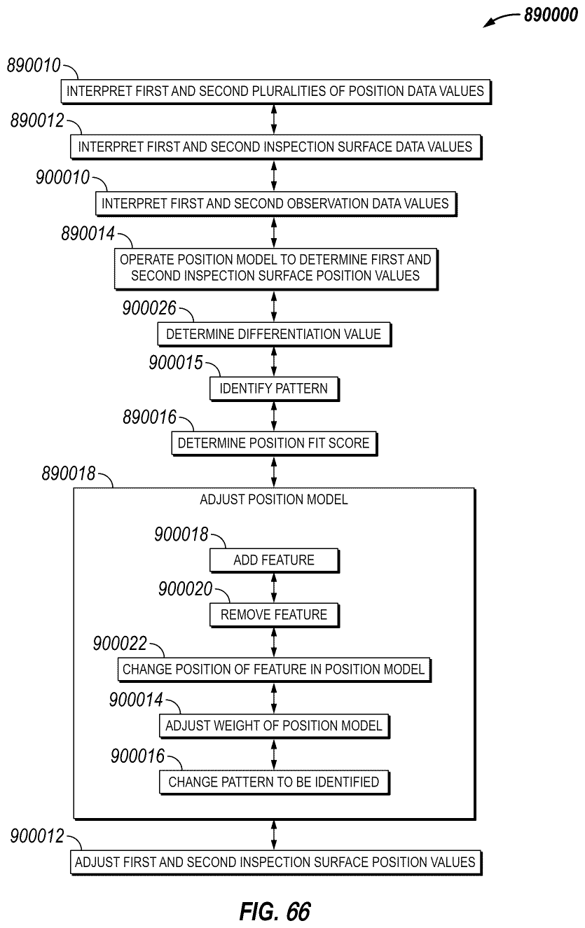

As shown in FIG. 66, the method 890000 may include: interpreting 900010 first observation data values 880012 (FIG. 64) corresponding to the first inspection surface, and second observation data values 880014 corresponding to the second inspection surface. In such embodiments, determining 890016 the position fit score 870034 (FIG. 64) is further based at least in part on the first 880012 (FIG. 64) and the second 880014 (FIG. 64) observation data values. The method 890000 may include adjusting 900012 the first inspection surface position value 870030 (FIG. 64) for each of the first inspection surface data values 870024 (FIG. 64) based at least in part on the adjusted position model 870028 (FIG. 64).

In embodiments, adjusting 890018 the position model 870028 (FIG. 64) in response to the position fit score 870034 (FIG. 64) includes adjusting 900014 a weight of the position model 870028 (FIG. 64). The method 890000 may include identifying 900015 a pattern 880038 (FIG. 64) in the first 870024 and/or the second 870026 inspection surface data values. In such embodiments, determining 890014 the first 870030 and/or the second 870032 inspection surface position values via the mapping circuit 870014 operating the position model 870028 is further based at least in part on the identified pattern 880038. In embodiments, adjusting 890018 the position model 870028 (FIG. 64) in response to the position fit score 870034 (FIG. 64) includes: changing 900016 the pattern 880038 (FIG. 64) to be identified by the position model 870028 (FIG. 64); adding 900018 a feature to the position model 870028 (FIG. 64); removing 900020 a feature from the position model 870028 (FIG. 64); or moving 900022 a position of a feature in the position model 870028 (FIG. 64).

In such embodiments, determining 890016 the position fit score may be based at least in part on the first 880012 and/or the second observation data values 880014.

The method 890000 may include determining 900026 a differentiation value 880042 (FIG. 64) between the first inspection surface and the second inspection surface based at least in part on the first 870020 (FIG. 64) and/or the second 870022 (FIG. 64) plurality of position data values; and/or the first 870024 and/or the second 870026 inspection surface data values. In such embodiments, adjusting 890018 the position model 870028 (FIG. 64) in response to the position fit score 870034 (FIG. 64) may be based on the differentiation value 880042. In embodiments, determining 900026 the differentiation value 880042 between the first inspection surface and the second inspection surface may be based on the first 880012 and/or the second observation values 880014.

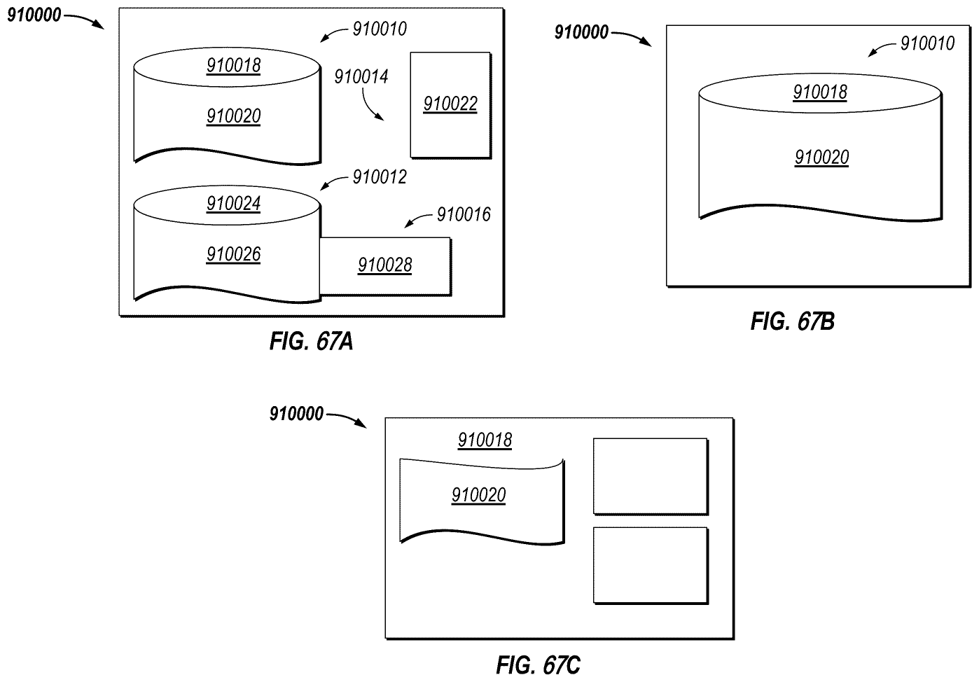

Referring now to FIGS. 27 and 67A-C, embodiments of the current disclosure provide for a graphical user interface 910000 for viewing structures, inspection surfaces, inspection surface data, and/or planning an inspection, in accordance with embodiments of the current disclosure. The GUI 910000 may, in response to a user selected: structure, inspection surface, location, and/or the like, retrieve data blocks, e.g., 5000024, 500026, 500028 (FIG. 27), etc., from an inspection database, e.g., servers 430026 (FIG. 19) and/or a separate database in communication with servers 430026 (FIG. 19), corresponding to structures, e.g., 9100010, 910012, 910014, 910016. The retrieved data blocks may include inspection surface data 500012 and/or structure and/or feature descriptions 500049. Non-limiting examples of structure descriptions include data defining one or more inspection surfaces 910018, 910020, 910022, 910024, 910026, 910028 forming one or more structures 910010, 910012, 910014, 910016, and/or data describing features of the structure, e.g., doorways, hatches, stairwells, known cracks, coloring, materials, and/or any other type of feature disclosed herein. The GUI 910000 may analyze the retrieved data blocks and display graphical images of and/or corresponding to any structures 910010, 910012, 910014, 910016 and/or inspection surfaces 910018, 910020, 910022, 910024, 910026, 910028; and/or display inspection surface data, past, current, and/or planned inspection runs, and/or the like.

A user may select a location L via the GUI 910000 where the GUI and/or processors implementing and/or providing services to the GUI 910000 query the inspection database for inspection surface data and/or other data (e.g.: location details such as the site owner, the number of structures, the number of inspection surfaces, environmental conditions, inspection process notes particular to the location, etc.), and then generate and display graphical representations of the structures 910010, 910012, 910014, 910016 and/or inspection surfaces 910018, 910020, 910022, 910024, 910026, 910028 corresponding to the retrieved inspection surface data. For example, data blocks 500024, 500028, and 500034 may include inspection surface data corresponding to structure 910010, where data block 500024 may include inspection surface data for inspection surface 910018 and data blocks 500028 and 500024 include inspection surface data for inspection surface 910020. Similarly, data blocks 500036, 500038, and 500040 may include inspection surface data for structure 910012, where data blocks 500036, 500038, and 500040 respectively include inspection surface data for inspection surfaces 910024, 910026, and 910028.

In embodiments, the GUI 910000 may display symbols, use color codes, and/or other mechanisms to convey the status of the structures 910010, 910012, 910014, 910016 and/or inspection surfaces 910018, 910020, 910022, 910024, 910026, 910028 with respect to the following: structural integrity, recency of last inspection run, existing inspection coverage, and/or the like. For example, the GUI 910000 may display structures having good structural integrity, e.g., very little damage, as green, where structures having moderate to severe structural damage may be displayed in orange or red. Similarly, the GUI 910000 may display structures having recent inspections data in green and structures with stale and/or old inspection surface data in orange or red. In embodiments, regions of structures 910010, 910012, 910014, 910016 and/or inspection surfaces 910018, 910020, 910022, 910024, 910026, 910028 having high resolution and/or high-fidelity may be shown in green (or another color) where regions of lower resolution and/or fidelity may be shown in red (or another color). Other forms of displaying the foregoing differentiations are contemplated, such as on-screen text and/or symbols, sounds, haptic feedback, and/or the like.

In embodiments, the GUI 910000 my provide for a user to select a structure, e.g., 910020, where the GUI 910000 provides a zoomed-in view (FIG. 67B) of the structure 910010. The GUI 910000 may further provide for the user to select an inspection surface, e.g., 910020, where the GUI 910000 provides a zoomed-in view (FIG. 67C) of the inspection surface 910020. In embodiments, the view of the inspection surface (FIG. 67C) may depict raw and/or processed inspection surface data for the inspection surface on the graphical representation of the inspection surface. In embodiments, the GUI 910000 may retrieve high level data, e.g., the number and/or configuration of structures 910010, 910012, 910014 at a location L from the inspection database, where the GUI 910000 displays the structures without retrieving all of the inspection surface data corresponding to the structures 910010, 910012, 910014. In such embodiments, the GUI 910000 may retrieve inspection surface data as needed and/or as demanded by a user. For example, in embodiments, the GUI 910000 may not retrieve raw inspection surface data for an inspection surface, e.g., 910020 until the GUI 910000 is in a zoomed-in view of the inspection surface 9100020 (FIG. 67C) and/or the user otherwise requests to see the inspection surface data for a selected inspection surface and/or corresponding structure.

Embodiments of the GUI 910000 may also provide for the viewing of inspection data 500012 (FIG. 27) for a selected inspection surface 910020 (FIG. 67C) corresponding to different inspection runs of the inspection surface 910020. For example, zooming-in or zooming-out of an inspection surface may successively display inspection data from different runs, where the inspection surface data displayed at a given zoom-level satisfies resolution requirements for the zoom-level. For example, inspection surface data from an older inspection run gathered at a lower resolution might be displayed at a low zoom-level (father away from) for an inspection surface than inspection surface data from a more recent inspection run gathered at a higher resolution and displayed at a higher zoom-level (closer to) the inspection surface. In embodiments, the GUI 910000 may stitch together inspection surface data generated by the same inspection robot at different times, different inspection runs and/or generated by different inspection robots. Such stitching of inspection surface data, disclosed elsewhere herein, may stitch the inspection data from different inspection surfaces together to depict a feature formed by the inspection surfaces.

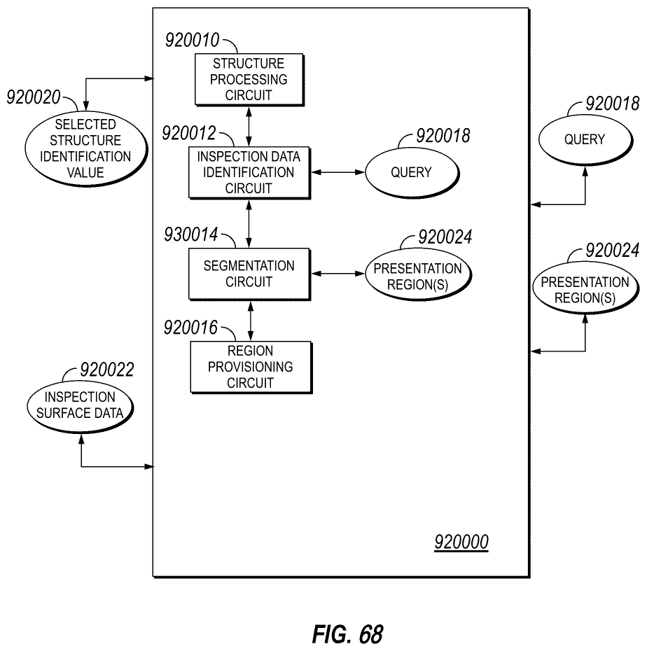

Accordingly, FIG. 68 depicts an apparatus 920000 for displaying inspection surface data, in accordance with embodiments of the current disclosure. The apparatus 920000 may form part of the controller 430020 (FIG. 19), the servers 430026, the workstation 430048, and/or any other computing device disclosed herein. Embodiments of the apparatus 920000 may implement one or more features of the GUI 910000 (FIGS. 67A-C), as disclosed herein. The apparatus 920000 includes a structure processing circuit 920010, an inspection data identification circuit 920012, a segmentation circuit 920014, and a region provisioning circuit 920016. The structure processing circuit 920010 is structured to interpret a selected structure identification value 920018 corresponding to a structure, e.g., 910010 (FIG. 67A). The inspection data identification circuit 920012 is structured to query 920020 an inspection database, e.g., 430026 (FIG. 19), for inspection surface data 920022 for the structure 910010 (FIG. 67A) in response to the selected structure identification value 920020. The segmentation circuit 920014 is structured to generate one or more presentation regions 920024 of the structure 910010 (FIG. 67A) in response to the inspection surface data 920022, and the region provisioning circuit 920016 is structured to transmit the one or more presentation regions 920024.

The presentation regions may 920024 include: graphical and/or textual depictions of structures, features, and/or inspection surfaces; graphical and/or textual depictions of raw and/or processed inspection surface data corresponding to the structures, features and/or inspection surfaces; graphical and/or textual depictions of observation data corresponding to the structures, features, and/or inspection surfaces; and/or graphical and/or textual depictions of other data corresponding to a location, e.g., owning entity name, location name, etc. The presentation regions 920024 may include descriptions of the relationships between features and their corresponding inspection surfaces, e.g., the location, orientation, size, etc., of the inspection surfaces forming a structure.

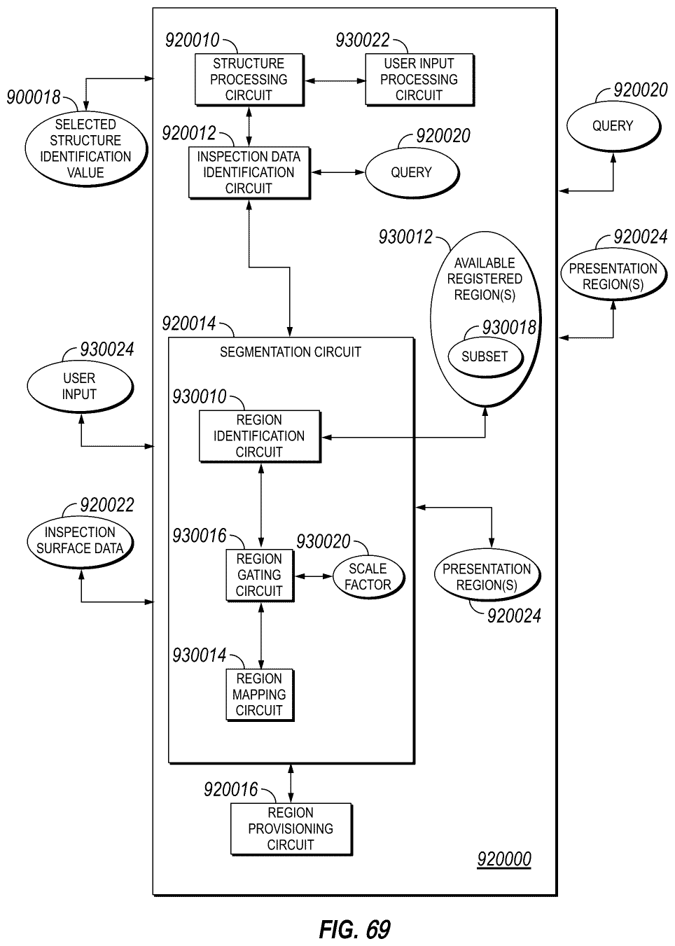

As shown in FIG. 69, the segmentation circuit 920014 may include a region identification circuit 930010 structured to identify one or more available registered regions 930012 of the structure, e.g., inspection surfaces 910018 and 910020 (FIG. 67A), based at least in part on the inspection surface data 920022. The segmentation circuit 920014 may be further structured to generate the one or more presentation regions 920024 based at least in part on the one or more available registered regions 930012. In embodiments, the segmentation circuit 920014 may be structured to generate the one or more presentation regions 920024 via stitching together two or more available registered regions 930012. In embodiments, the segmentation circuit 920014 includes a region mapping circuit 930014 structured to map the one or more available registered regions 930012 to the one or more presentation regions 920024.

In embodiments, the segmentation circuit 920014 includes a region gating circuit 930016 structured to determine a subset 930018 of the one or more available registered regions 930012. In such embodiments, the region mapping circuit 930014 may be structured to map the subset 930018 of the one or more available registered regions 930012 to the one or more presentation regions 920024. The region gating circuit 930016 may be structured to determine the subset 930018 of the one or more available registered regions 930012 based at least in part on a scale factor 930020 that may correspond to: a viewing scale of a structure; a selected origin; a selected coordinate system; and/or a view of a structure.

The apparatus 920000 may include a user input processing circuit 930022 structured to interpret a user input 930024 and, in response to the interpreted user input 930024, determine the scale factor 930020.

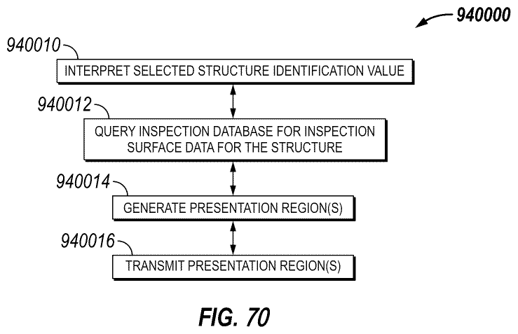

FIG. 70 depicts a method 940000 for displaying inspection surface data, in accordance with embodiments of the current disclosure. The method 940000 may be performed via apparatus 920000 and/or any other computing device disclosed herein. The method 940000 includes: interpreting 940010 a selected structure identification value 920018 corresponding to a structure, e.g., 910010 (FIG. 67A); and querying 940012 an inspection database, e.g., servers 430026 (FIG. 19), for inspection surface data 920022 (FIG. 69) for the structure 910010 in response to the selected structure identification value 920018 (FIG. 69). The method 940000 further includes generating 940014 one or more presentation regions 920024 (FIG. 69) of the structure 910010 (FIG. 67A) in response to the inspection surface data 920022. The method 940000 may further include transmitting 940016 the one or more presentation regions 920024, e.g., for display on an electronic device such as control device 430046 (FIG. 19) and workstation 430048 (FIG. 19).

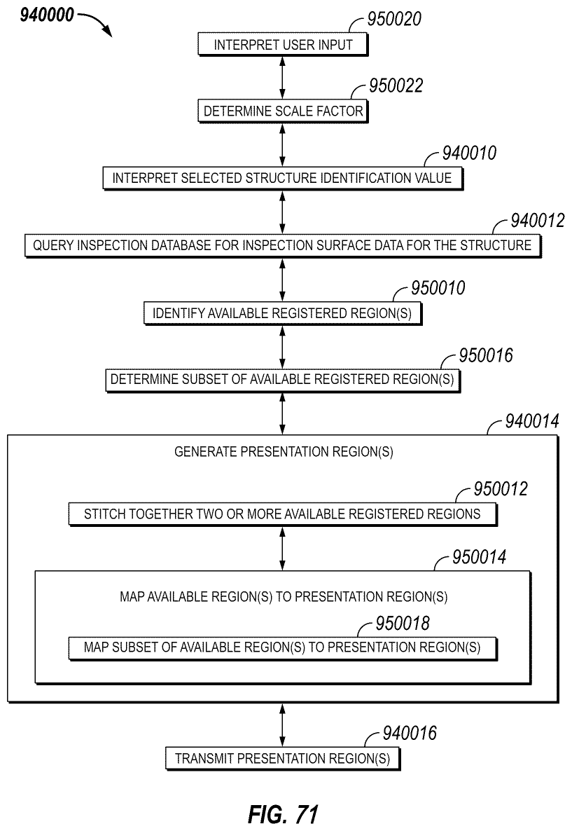

As shown in FIG. 71, embodiments of the method 940000 may include identifying 950010 one or more available registered regions 930012 (FIG. 69) of the structure 910010 (FIG. 67A) based at least in part on the inspection surface data 920022 (FIG. 69). In such embodiments, generating 940014 the one or more presentation regions 920024 (FIG. 69) of the structure 910010 (FIG. 67A) in response to the inspection surface data 920022 (FIG. 69) is based at least in part on the one or more available registered regions 930012 (FIG. 69). In embodiments, generating 940014 the one or more presentation regions 920024 of the structure 910010 (FIG. 67A) in response to the inspection surface data 920022 (FIG. 69) includes stitching 950012 together two or more available registered regions.

The method 940000 may include mapping 950014 one or more available regions 930012 (FIG. 69) to the one or more presentation regions 920024 (FIG. 69); determining 950016 a subset 930018 (FIG. 69) of the one or more available registered regions 930012 (FIG. 69); and/or mapping 950018 the subset 930018 (FIG. 69) of the one or more available registered regions 930012 (FIG. 69) to the one or more presentation regions 920024 (FIG. 69).

In embodiments, determining 950016 the subset 930018 (FIG. 69) of the one or more available registered regions 930012 (FIG. 69) is based at least in part on a scale factor 930020 (FIG. 69).

The method 940000 may include interpreting 950020 a user input 930024 (FIG. 69), and/or determining 950022 the scale factor 930020 (FIG. 69) in response to the user input 930024 (FIG. 69).

The methods, apparatuses, and systems described herein, such as the apparatus 920000 (FIG. 68) and/or method 940000 (FIG. 70) for displaying surface data, may be deployed in part or in whole through a machine, (e.g., inspection robot controller(s) 430020 (FIG. 19), the servers 430026 (FIG. 19), workstation 430048 (FIG. 19), and/or control device 430046 (FIG. 19)) having a computer, computing device, processor, circuit, and/or server that executes computer readable instructions, program codes, instructions, and/or includes hardware configured to functionally execute one or more operations of the methods and systems disclosed herein. The terms computer, computing device, processor, circuit, and/or server, as utilized herein, should be understood broadly.

Any one or more of the terms computer, computing device, processor, circuit, and/or server include a computer of any type, capable to access instructions stored in communication thereto such as upon a non-transient computer readable medium, whereupon the computer performs operations of systems or methods described herein upon executing the instructions. In certain embodiments, such instructions themselves comprise a computer, computing device, processor, circuit, and/or server, e.g., servers 430026 (FIG. 19). Additionally or alternatively, a computer, computing device, processor, circuit, and/or server may be a separate hardware device, one or more computing resources distributed across hardware devices, and/or may include such aspects as logical circuits, embedded circuits, sensors, actuators, input and/or output devices, network and/or communication resources, memory resources of any type, processing resources of any type, and/or hardware devices configured to be responsive to determined conditions to functionally execute one or more operations of systems and methods herein.

Network and/or communication resources include, without limitation, local area network (e.g., 430028 (FIG. 19)), wide area network (e.g., 430030 (FIG. 19)), wireless, internet, or any other known communication resources and protocols. Example and non-limiting hardware, computers, computing devices, processors, circuits, and/or servers include, without limitation, a general-purpose computer, a server, an embedded computer, a mobile device, a virtual machine, and/or an emulated version of one or more of these. Example and non-limiting hardware, computers, computing devices, processors, circuits, and/or servers may be physical, logical, or virtual. A computer, computing device, processor, circuit, and/or server may be: a distributed resource, e.g., servers 430026 (FIG. 19), included as an aspect of several devices; and/or included as an interoperable set of resources to perform described functions of the computer, computing device, processor, circuit, and/or server, such that the distributed resources function together to perform the operations of the computer, computing device, processor, circuit, and/or server. In certain embodiments, each computer, computing device, processor, circuit, and/or server may be on separate hardware, and/or one or more hardware devices may include aspects of more than one computer, computing device, processor, circuit, and/or server, for example as separately executable instructions stored on the hardware device, and/or as logically partitioned aspects of a set of executable instructions, with some aspects of the hardware device comprising a part of a first computer, computing device, processor, circuit, and/or server, and some aspects of the hardware device comprising a part of a second computer, computing device, processor, circuit, and/or server.

A computer, computing device, processor, circuit, and/or server may be part of a server, e.g., servers 430026 (FIG. 19), client, network infrastructure, mobile computing platform, stationary computing platform, or other computing platform. A processor may be any kind of computational or processing device capable of executing program instructions, codes, binary instructions and the like. The processor may be or include a signal processor, digital processor, embedded processor, microprocessor, or any variant such as a co-processor (math co-processor, graphic co-processor, communication co-processor and the like) and the like that may directly or indirectly facilitate execution of program code or program instructions stored thereon. In addition, the processor may enable execution of multiple programs, threads, and codes. The threads may be executed simultaneously to enhance the performance of the processor and to facilitate simultaneous operations of the application. By way of implementation, methods, program codes, program instructions and the like described herein may be implemented in one or more threads. The thread may spawn other threads that may have assigned priorities associated with them; the processor may execute these threads based on priority or any other order based on instructions provided in the program code. The processor may include memory that stores methods, codes, instructions, and programs as described herein and elsewhere. The processor may access a storage medium through an interface that may store methods, codes, and instructions as described herein and elsewhere. The storage medium associated with the processor for storing methods, programs, codes, program instructions or other type of instructions capable of being executed by the computing or processing device may include but may not be limited to one or more of a CD-ROM, DVD, memory, hard disk, flash drive, RAM, ROM, cache, and the like.

A processor may include one or more cores that may enhance speed and performance of a multiprocessor. In embodiments, the process may be a dual core processor, quad core processors, other chip-level multiprocessor and the like that combine two or more independent cores (called a die).

The methods, apparatuses, and systems described herein, such as apparatus 520000 (FIG. 28) and method 540000 (FIG. 30), may be deployed in part or in whole through a machine that executes computer readable instructions on a server, e.g., 430026 (FIG. 19), client, firewall, gateway, hub, router, or other such computer and/or networking hardware. The computer readable instructions may be associated with a server that may include a file server, print server, domain server, internet server, intranet server and other variants such as secondary server, host server, distributed server, and the like. The server may include one or more of memories, processors, computer readable transitory and/or non-transitory media, storage media, ports (physical and virtual), communication devices, and interfaces capable of accessing other servers, clients, machines, and devices through a wired or a wireless medium, and the like. The methods, programs, or codes as described herein and elsewhere may be executed by the server. In addition, other devices required for execution of methods as described in this application may be considered as a part of the infrastructure associated with the server.

The server, e.g., 430026 (FIG. 19) may provide an interface to other devices including, without limitation, clients, other servers, printers, database servers, print servers, file servers, communication servers, distributed servers, and the like. Additionally, this coupling and/or connection may facilitate remote execution of instructions across the network. The networking of some or all of these devices may facilitate parallel processing of program code, instructions, and/or programs at one or more locations without deviating from the scope of the disclosure. In addition, all the devices attached to the server through an interface may include at least one storage medium capable of storing methods, program code, instructions, and/or programs. A central repository may provide program instructions to be executed on different devices. In this implementation, the remote repository may act as a storage medium for methods, program code, instructions, and/or programs.

The methods, program code, instructions, and/or programs may be associated with a client that may include a file client, print client, domain client, internet client, intranet client and other variants such as secondary client, host client, distributed client, and the like. For example, in embodiments, the inspection robot 430012 may be a client of the server(s) 430026 (FIG. 19) and/or the control device 430046 (FIG. 19) may be a client of the inspection robot 430012 (FIG. 19). The client may include one or more of memories, processors, computer readable transitory and/or non-transitory media, storage media, ports (physical and virtual), communication devices, and interfaces capable of accessing other clients, servers, machines, and devices through a wired or a wireless medium, and the like. The methods, program code, instructions, and/or programs as described herein and elsewhere may be executed by the client. In addition, other devices utilized for execution of methods as described in this application may be considered as a part of the infrastructure associated with the client.

The client may provide an interface to other devices including, without limitation, servers, other clients, printers, database servers, print servers, file servers, communication servers, distributed servers, and the like. Additionally, this coupling and/or connection may facilitate remote execution of methods, program code, instructions, and/or programs across the network. The networking of some or all of these devices may facilitate parallel processing of methods, program code, instructions, and/or programs at one or more locations without deviating from the scope of the disclosure. In addition, all the devices attached to the client through an interface may include at least one storage medium capable of storing methods, program code, instructions, and/or programs. A central repository may provide program instructions to be executed on different devices. In this implementation, the remote repository may act as a storage medium for methods, program code, instructions, and/or programs.

The methods and systems described herein may be deployed in part or in whole through network infrastructures. The network infrastructure may include elements such as computing devices, servers, routers, hubs, firewalls, clients, personal computers, communication devices, routing devices and other active and passive devices, modules, and/or components as known in the art. The computing and/or non-computing device(s) associated with the network infrastructure may include, apart from other components, a storage medium such as flash memory, buffer, stack, RAM, ROM, and the like. The methods, program code, instructions, and/or programs described herein and elsewhere may be executed by one or more of the network infrastructural elements.

The methods, program code, instructions, and/or programs described herein and elsewhere may be implemented on a cellular network having multiple cells. The cellular network may either be frequency division multiple access (FDMA) network or code division multiple access (CDMA) network. The cellular network may include mobile devices, cell sites, base stations, repeaters, antennas, towers, and the like.

The methods, program code, instructions, and/or programs described herein and elsewhere may be implemented on or through mobile devices. The mobile devices may include navigation devices, cell phones, mobile phones, mobile personal digital assistants, laptops, palmtops, netbooks, pagers, electronic books readers, music players, and the like. These mobile devices may include, apart from other components, a storage medium such as a flash memory, buffer, RAM, ROM and one or more computing devices. The computing devices associated with mobile devices may be enabled to execute methods, program code, instructions, and/or programs stored thereon. Alternatively, the mobile devices may be configured to execute instructions in collaboration with other devices. The mobile devices may communicate with base stations interfaced with servers and configured to execute methods, program code, instructions, and/or programs. The mobile devices may communicate on a peer-to-peer network, mesh network, or other communications network. The methods, program code, instructions, and/or programs may be stored on the storage medium associated with the server and executed by a computing device embedded within the server. The base station may include a computing device and a storage medium. The storage device may store methods, program code, instructions, and/or programs executed by the computing devices associated with the base station.

The methods, program code, instructions, and/or programs may be stored and/or accessed on machine readable transitory and/or non-transitory media that may include: computer components, devices, and recording media that retain digital data used for computing for some interval of time; semiconductor storage known as random access memory (RAM); mass storage typically for more permanent storage, such as optical discs, forms of magnetic storage like hard disks, tapes, drums, cards and other types; processor registers, cache memory, volatile memory, non-volatile memory; optical storage such as CD, DVD; removable media such as flash memory (e.g., USB sticks or keys), floppy disks, magnetic tape, paper tape, punch cards, standalone RAM disks, Zip drives, removable mass storage, off-line, and the like; other computer memory such as dynamic memory, static memory, read/write storage, mutable storage, read only, random access, sequential access, location addressable, file addressable, content addressable, network attached storage, storage area network, bar codes, magnetic ink, and the like.

Certain operations described herein include interpreting, receiving, and/or determining one or more values, parameters, inputs, data, or other information. Operations including interpreting, receiving, and/or determining any value parameter, input, data, and/or other information include, without limitation: receiving data via a user input; receiving data over a network of any type; reading a data value from a memory location in communication with the receiving device; utilizing a default value as a received data value; estimating, calculating, or deriving a data value based on other information available to the receiving device; and/or updating any of these in response to a later received data value. In certain embodiments, a data value may be received by a first operation, and later updated by a second operation, as part of the receiving a data value. For example, when communications are down, intermittent, or interrupted, a first operation to interpret, receive, and/or determine a data value may be performed, and when communications are restored an updated operation to interpret, receive, and/or determine the data value may be performed.

Certain logical groupings of operations herein, for example methods or procedures of the current disclosure, are provided to illustrate aspects of the present disclosure. Operations described herein are schematically described and/or depicted, and operations may be combined, divided, re-ordered, added, or removed in a manner consistent with the disclosure herein. It is understood that the context of an operational description may require an ordering for one or more operations, and/or an order for one or more operations may be explicitly disclosed, but the order of operations should be understood broadly, where any equivalent grouping of operations to provide an equivalent outcome of operations is specifically contemplated herein. For example, if a value is used in one operational step, the determining of the value may be required before that operational step in certain contexts (e.g. where the time delay of data for an operation to achieve a certain effect is important), but may not be required before that operation step in other contexts (e.g. where usage of the value from a previous execution cycle of the operations would be sufficient for those purposes). Accordingly, in certain embodiments an order of operations and grouping of operations as described is explicitly contemplated herein, and in certain embodiments re-ordering, subdivision, and/or different grouping of operations is explicitly contemplated herein.

The methods and systems described herein may transform physical and/or or intangible items from one state to another. The methods and systems described herein may also transform data representing physical and/or intangible items from one state to another.

The elements described and depicted herein, including in flow charts, block diagrams, and/or operational descriptions, depict and/or describe specific example arrangements of elements for purposes of illustration. However, the depicted and/or described elements, the functions thereof, and/or arrangements of these, may be implemented on machines, such as through computer executable transitory and/or non-transitory media having a processor capable of executing program instructions stored thereon, and/or as logical circuits or hardware arrangements. Example arrangements of programming instructions include at least: monolithic structure of instructions; standalone modules of instructions for elements or portions thereof; and/or as modules of instructions that employ external routines, code, services, and so forth; and/or any combination of these, and all such implementations are contemplated to be within the scope of embodiments of the present disclosure Examples of such machines include, without limitation, personal digital assistants, laptops, personal computers, mobile phones, other handheld computing devices, medical equipment, wired or wireless communication devices, transducers, chips, calculators, satellites, tablet PCs, electronic books, gadgets, electronic devices, devices having artificial intelligence, computing devices, networking equipment, servers, routers and the like. Furthermore, the elements described and/or depicted herein, and/or any other logical components, may be implemented on a machine capable of executing program instructions. Thus, while the foregoing flow charts, block diagrams, and/or operational descriptions set forth functional aspects of the disclosed systems, any arrangement of program instructions implementing these functional aspects are contemplated herein. Similarly, it will be appreciated that the various steps identified and described above may be varied, and that the order of steps may be adapted to particular applications of the techniques disclosed herein. Additionally, any steps or operations may be divided and/or combined in any manner providing similar functionality to the described operations. All such variations and modifications are contemplated in the present disclosure. The methods and/or processes described above, and steps thereof, may be implemented in hardware, program code, instructions, and/or programs or any combination of hardware and methods, program code, instructions, and/or programs suitable for a particular application. Example hardware includes a dedicated computing device or specific computing device, a particular aspect or component of a specific computing device, and/or an arrangement of hardware components and/or logical circuits to perform one or more of the operations of a method and/or system. The processes may be implemented in one or more microprocessors, microcontrollers, embedded microcontrollers, programmable digital signal processors or other programmable device, along with internal and/or external memory. The processes may also, or instead, be embodied in an application specific integrated circuit, a programmable gate array, programmable array logic, or any other device or combination of devices that may be configured to process electronic signals. It will further be appreciated that one or more of the processes may be realized as a computer executable code capable of being executed on a machine readable medium.

The computer executable code may be created using a structured programming language such as C, an object oriented programming language such as C++, or any other high-level or low-level programming language (including assembly languages, hardware description languages, and database programming languages and technologies) that may be stored, compiled or interpreted to run on one of the above devices, as well as heterogeneous combinations of processors, processor architectures, or combinations of different hardware and computer readable instructions, or any other machine capable of executing program instructions.

Thus, in one aspect, each method described above and combinations thereof may be embodied in computer executable code that, when executing on one or more computing devices, performs the steps thereof. In another aspect, the methods may be embodied in systems that perform the steps thereof, and may be distributed across devices in a number of ways, or all of the functionality may be integrated into a dedicated, standalone device or other hardware. In another aspect, the means for performing the steps associated with the processes described above may include any of the hardware and/or computer readable instructions described above. All such permutations and combinations are contemplated in embodiments of the present disclosure.

While the disclosure has been disclosed in connection with the preferred embodiments shown and described in detail, various modifications and improvements thereon will become readily apparent to those skilled in the art. Accordingly, the spirit and scope of the present disclosure is not to be limited by the foregoing examples, but is to be understood in the broadest sense allowable by law.

The use of the terms “a” and “an” and “the” and similar referents in the context of describing the disclosure (especially in the context of the following claims) is to be construed to cover both the singular and the plural, unless otherwise indicated herein or clearly contradicted by context. The terms “comprising,” “having,” “including,” and “containing” are to be construed as open-ended terms (e.g., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the disclosure and does not pose a limitation on the scope of the disclosure unless otherwise claimed. The term “set” may include a set with a single member. No language in the specification should be construed as indicating any non-claimed element as essential to the practice of the disclosure.

While the foregoing written description enables one of ordinary skill to make and use what is considered presently to be the best mode thereof, those of ordinary skill will understand and appreciate the existence of variations, combinations, and equivalents of the specific embodiment, method, and examples herein. The disclosure should therefore not be limited by the above-described embodiment, method, and examples, but by all embodiments and methods within the scope and spirit of the disclosure.

1. A system comprising:
an inspection robot comprising:
a body;
an arm coupled to the body;
a payload coupled to the arm; and
an inspection surface sensor disposed in the payload for inspecting an inspection surface and structured to generate inspection surface data; and
one or more processors structured to:
interpret a position value;
interpret the inspection surface data;
interpret a feature description corresponding to a feature related to the inspection surface; and
generate a high-fidelity region of the inspection surface based at least in part on the position value, the inspection surface data, and the feature description.

2. The system of claim 1, wherein the one or more processors are further structured to:
analyze the feature description to identify the feature; and
responsive to identifying the feature, determine that the feature is as an anchor point;
wherein generation of the high-fidelity region is based at least in part on the anchor point.

3. The system of claim 2, wherein the one or more processors are further structured to:
stitch, based at least in part on the anchor point, the high-fidelity region to another region of a structure that comprises the inspection surface.

4. The system of claim 1, wherein the one or more processors are further structured to:
transmit the high-fidelity region.

5. The system of claim 1, wherein:
the one or more processors are further structured to generate a plurality of high-fidelity regions, that includes the high-fidelity region;
interpret a user action;
in response to interpreting the user action, select one of the plurality of high-fidelity regions; and
transmit the selected one of the plurality of high-fidelity regions.

6. The system of claim 5, wherein the user action corresponds to a type of analysis of a structure that comprises the inspection surface.

7. The system of claim 1, wherein:
the one or more processors are further structured to generate a plurality of high-fidelity regions, that includes the high-fidelity region; and
display a list of identifiers corresponding to the plurality of high-fidelity regions.

8. The system of claim 1, wherein the one or more processors are further structured to display the high-fidelity region.

9. The system of claim 1, wherein the inspection robot further comprises:
a position sensor that generates the position value.

10. The system of claim 9, wherein the inspection robot further comprises:
a position sensor structured to generate the position value.

11. The system of claim 10, wherein the position sensor comprises an inertial measurement unit (IMU).

12. The system of claim 1, wherein the feature comprises at least one of:
a structural feature;
a surface feature; or
a virtual feature.

13. The system of claim 12, wherein the structural feature comprises at least one of:
a component of a structure comprising the inspection surface; or
a component of a structure external to a structure comprising the inspection surface.

14. The system of claim 13, wherein the structure comprising the inspection surface comprises at least one of:
a tank;
one or more stairs;
a drain;
a pipe;
a hull;
a window;
an antenna;
a tower; or
a building.

15. The system of claim 12, wherein the surface feature comprises at least one of:
a weld line;
a joint;
a hatch;
a panel; or
a type of damage.

16. An apparatus comprising:
a position processing circuit structured to interpret a position value;
an inspection data processing circuit structured to interpret inspection surface data;
a feature processing circuit structured to interpret a feature description corresponding to a feature related to an inspection surface; and
a map generation circuit structured to generate a high-fidelity region of the inspection surface based at least in part on the position value, the inspection surface data, and the feature description.

17. The apparatus of claim 16 further comprising:
an anchor generation circuit structured to:
analyze the feature description to identify the feature; and
responsive to identifying the feature, determine that the feature is as an anchor point;
wherein the map generation circuit is further structured to generate the high-fidelity region based at least in part on the anchor point.

18. The apparatus of claim 17, further comprising:
a stitch circuit structured to stitch, based at least in part on the anchor point, the high-fidelity region to another region of a structure that comprises the inspection surface.

19. The apparatus of claim 16 further comprising:
a position sensor structured to generate the position value.

20. The apparatus of claim 19, wherein the position sensor comprises an inertial measurement unit (IMU).

21. The apparatus of claim 16, wherein the feature comprise at least one of:
a structural feature;
a surface feature; or
a virtual feature.

22. The apparatus of claim 21, wherein the structural feature comprises at least one of:
a component of a structure comprising the inspection surface; or
a component of a structure external to a structure comprising the inspection surface.

23. A method for generating a high-fidelity region for an inspection surface, the method comprising:
interpreting, via a position processing circuit, a position value;
interpreting, via an inspection data processing circuit, inspection surface data;
interpreting, via a feature processing circuit, a feature description corresponding to a feature related to the inspection surface; and
generating, via a map generation circuit, a high-fidelity region of the inspection surface based at least in part on the position value, the inspection surface data, and the feature description.

24. The method of claim 23 further comprising:
analyzing, via an anchor generation circuit, the feature description; and
responsive to analyzing the feature description, generating, via the anchor generation circuit, an anchor point;
wherein generating the high-fidelity region is based at least in part on the anchor point.

25. The method of claim 24 further comprising:
stitching, via a stitch circuit and based at least in part on the anchor point, the high-fidelity region to another region of a structure that comprises the inspection surface.

26. The method of claim 23 further comprising:
generating, via a position sensor, the position value.

27. A non-transitory computer-readable medium storing instructions that when loaded into at least one processor cause the at least one processor to:
interpret a position value;
interpret inspection surface data;
interpret a feature description corresponding to a feature related to an inspection surface; and
generate a high-fidelity region of the inspection surface based at least in part on the position value, the inspection surface data, and the feature description.

28. The non-transitory computer-readable medium of claim 27, wherein the stored instructions further cause the at least one processor to:
analyze the feature description; and
responsive to analyzing the feature description, generate an anchor point;
wherein generating the high-fidelity region is based at least on art on the anchor point.

29. The non-transitory computer-readable medium of claim 28, wherein the stored instructions further cause the at least one processor to:
stitch the high-fidelity region to another region of a structure that comprises the inspection surface.

30-228. (canceled)
